(19) United States
(12) Patent Application Publication
(10) Pub. No.: US 2011/0047224 A1
(43) Pub. Date: Feb. 24, 2011

(54) Apparatus and method for processing and/or for providing education information and/or education related information

(76) Inventor: Seymour Ian Fox, Palm Beach Gardens, FL (US)

Correspondence Address: SEYMOUR IAN FOX, 394 ISLE COURT, PALM BEACH GARDENS, FL, 33418, US

(21) Appl. No.: 12/804,971

(22) Filed: Aug. 3, 2010

Related U.S. Application Data
(60) Provisional application No. 61/274,838, filed on Aug. 21, 2009.

(51) Int. Cl. G06F 15/16

(52) U.S. Cl. 709/206; 709/217

(57) ABSTRACT

A computer-implemented method, including processing, with a processor, a request by a person or entity to access, obtain, change, alter, or modify, an individual's or student's education record or file which contains education information or education related information personal to the individual or student or educator or administrator, generating a message containing information regarding the person or entity and/or identification information regarding the person or entity, and containing an actual change, alteration, or modification, sought to be made or made to the individual's or student's education record or file, and transmitting the message to a communication device of the individual or student or educator or administrator during, concurrently with, at a same time as, or prior to a completion of, an accessing, obtaining, changing, altering, or modifying, of the individual's or student's education record or file or a processing of the request.

### FIELD OF THE INVENTION

The present invention pertains to an apparatus and a method for processing and/or for providing education information and/or education related information and, in particular, to an apparatus and a method for processing and/or for providing education information and/or education related information for a variety of education and education related applications.

### BACKGROUND OF THE INVENTION

Each year, tens of millions of individuals seek or need the assistance of education institutions, academic professionals, and affiliated instructional education programs to receive primary, secondary, graduate, or post-graduate education. In order to perform proper assessments, facilitate and manage the education process, administrate enrollment, facilitate funding, create academic lessons, and procure educational resources, the very many educational institutions, educational professionals or instructional education provider or education materials provider or education tools provider or education computer-enabled tools providers typically rely on services and information which is obtained from students, guardians, previous educators, and/or education facility and/or educational institution staff members, and standardized tests. The need to have accurate and/or up-to-date data and/or information, in providing a valuable education, and/or education related services, cannot be emphasized enough.

Stories constantly emerge about students receiving the inferior academic instruction, graduating with sub-par credentials, misguided educational paths resulting in an underperforming workforce and thus national economy and scientific community. Having the wrong or inaccurate assessments, outdated information, improper instruction, antiquated resources, inefficient cost structures, limited access to the latest academic tools, and administration tools, as well as the quality of data available for basing guidance, receiving instruction, or education, ultimately fails to optimally prepare individuals and students for occupations or higher education and is a systematic failing that can be improved through innovation.

By example, a recent study produced by the American Federation of Teachers (AFT), one of the world's largest teacher unions, found that many U.S. school districts actively practice social promotion, regardless of it being in contradiction to public academic offerings and laws. Social promotion is the practice of promoting students from one grade to the next regardless of academic achievement. The cause is that many school systems are overwhelmed by increasing numbers of ill-prepared students. This practice might potentially impact several hundred thousand students per year. There is no doubt that many of these academic failures are the result of poor information management concerning the students' progress, inaccurate and/or erroneous information, and/or the lack of availability of correct and/or up-to-date information.

According to the National Center for Education Statistics of U.S. Department of Education Institute of Education Sciences, total public school enrollment is projected to set new enrollment records each year from 2009 through 2018, reaching an estimated high of 53.9 million students in 2018. According to projections, 38.2 million will be enrolled in prekindergarten through grade 8 and 15.8 million in grades 9-12 in 2018. With these increased levels of enrollment and the current failings of processes and systems for providing and processing education and/or education related information the problem, if left unaddressed, is surely to worsen.

The United States relies heavily on immigration for attracting skilled workers and their families from around the world. Between 1979 and 2007, the number of school-age children (children ages 5-17) who spoke a language other than English at home increased from 3.8 to 10.8 million or from 9 to 20 percent of the population in this age range. Of the school-age children who spoke a language other than English at home and who spoke English with difficulty, 75 percent (or 2.1 million) spoke Spanish. This added element of cultural and language complexity reinforces the importance to have new and innovative means to provide and process education and/or education related information.

Also, since the enactment of the Individuals with Disabilities Education Act (IDEA) in 1975, the number and percentage of children and youth receiving special education services increased nearly every year until 2004-05. In 1976-77, some 3.7 million children and youth (or about 5 percent) were served under IDEA. By 2006-07, some 6.7 million (or about 9 percent) were receiving services. The percentage receiving special education services for a specific learning disability, the most prevalent disability type among school-age children, was 3 percentage points higher in 2006-07 than in 1976-77 (5 vs. 2 percent). To ensure that the academic potential of the students served by the IDEA program is fully realized even more service or resourceful attention needs to be paid to the management of their educational service or resources and this further validates the need for improved means to provide and process education and/or education related information.

Furthermore, distance education is becoming a more common element within an individual's academic service or resources. Distance education is defined as a formal education process in which the students and instructor are not in the same place, where instruction may involve communication through the use of video, audio, or computer technologies, or by correspondence. Distance education includes courses and programs that were formally designated as online, hybrid/blended online and in-instructor. Currently, sixty-five percent of the institutions reported college-level credit-granting distance education courses. This added element of geographic and technical complexity reinforces the importance to have new and innovative means to provide and process education and/or education related information.

The United States public and private school systems will employ about four million teachers in 2009. They will work across a community of 14,200 public school districts containing about 97,000 public schools, including about 4,000 charter schools, and an additional 35,000 private schools. Current expenditures for public elementary and secondary schools were about $519 billion for the 2008-09 school year. The national average current expenditure per student is around $10,418. Approximately 18.3 million students will attend the nation's 2-year and 4-year colleges and universities, and college enrollment is expected to continue increasing, reaching a projected 20.4 million in fall 2016. For the 2006-07 academic year, annual prices for undergraduate instruction, room, and board were estimated to be $11,034 at public institutions and $28,384 at private institutions. During the 2008-09 school year, 714,000 associate's degrees; 1,585,000 bachelor's degrees; 647,000 master's degrees; 91,000 first-professional degrees; and 55,800 doctoral degrees are expected to be awarded. With such a large community of stakeholders and at such a steep cost to the country, the financing of assuring the efficiency and efficacy of this educational system through improved means to provide and process education and/or education related information is clear.

Even further, one does not need to look far into the academic world to see that access to education materials, qualified recommendations for educational instruction, effective management of records and data, institution application processes, test administration, financial support, financial aid management and the like are managed with great inconsistency and to a wide degree off efficiency and effectiveness. The result is that many students miss important opportunities that can not only have a positive impact on them as individuals, but on the country and the world.

Another problem lies with the fact that the main source of student information, academic histories, testing histories, upon which administrators or academic education provider or education materials provider or education tools provider or education computer-enabled tools providers may base their assessments and/or academic decisions, and/or instruction, are the students themselves who usually supply this information on questionnaires or forms just prior to seeing the education decision maker or education provider or education materials provider or education tools provider or education computer-enabled tools provider and/or during a preliminary interview with the education provider or education materials provider or education tools provider or education computer-enabled tools provider. In this regard, information obtained from these questionnaires or forms, as well as from these preliminary interviews with the decision makers, administrators, or education provider or education materials provider or education tools provider or education computer-enabled tools providers, may not necessarily result in sufficient, comprehensive, and/or accurate, information being obtained regarding the student. Further, there is no guarantee that the same information will be provided, in a uniform manner, to a next or different set of education decision makers, education provider or education materials provider or education tools provider or education computer-enabled tools providers, and/or administrators. As a result, student information may not be uniformly distributed and/or be available to key parties at the point of enrollment decision, academic lesson and/or otherwise.

Another problem which exists in the current education system is that educators or other education provider or education materials provider or education tools provider or education computer-enabled tools providers do not always have the latest information and/or research material available to them prior to, and/or during, the analysis and/or academic lesson process.

It is also no secret that education costs are rising at ever-increasing rates and that academic financing entities, including federal, state, and local governments, and individual entities and individuals and other education payers expend great resources in processing and reconciling academic instruction requests and/or requests for education services and/or financing. Typically, these financing and/or financing requests take place in a paper-based environment.

Furthermore, fraudulent academic financial requests and/or requests which cannot be verified pose another major problem for education payers and institutions awarding grants and loans. These problems only serve to add to the growing costs of education, lost education opportunities, delayed academic lessons, and a general dissatisfaction with the current education system.

Another problem lies in making up-to-date education, training materials, syllabi, curricula, and study plans conveniently available to education provider or education materials provider or education tools provider or education computer-enabled tools providers in order to allow education provider or education materials provider or education tools provider or education computer-enabled tools providers to remain current with state-of-the-art information, tools, content, data, and training techniques.

Other problems lie in maintaining student education records or files private, in safeguarding student education records or files, in providing notification to students and other individuals when others have accessed, obtained, and/or made changes to their respective education records or files, and in enabling students and individuals to restrict and/or limit access to their education records or files.

The list of problems with the current education system goes on and on. In view of the above, there is a great need for an apparatus and a method for providing education information and/or education related information to the various education provider or education materials provider or education tools provider or education computer-enabled tools providers, payers, students, third party individuals, and/or financing brokers, agents and/or other intermediaries, which overcomes the shortcomings of the prior art.

### SUMMARY OF THE INVENTION

The present invention provides an apparatus and methods for providing education information and/or education related information which overcomes the shortcomings of the prior art.

The present invention is directed to an apparatus and a method for processing and/or for providing education information and/or education related information and, in particular, to an apparatus and a method for processing and/or for providing education information and/or education related information for a variety of education and education related applications.

The apparatus and method of the present invention facilitates the creation and management of a comprehensive education processing system which can manage student and administrator records, education products and education services providers, and education computing applications providers, and education technical solutions providers and other education provider or education materials provider or education tools provider or education computer-enabled tools provider records, education financing and/or payer records, and thereby provide an apparatus, system and methods for providing a variety and a multitude of education information processing applications, processes and services.

The present invention facilitates improved education quality, efficient information collection, processing and dissemination, efficient analysis, effective instruction management, cost efficiency, cost containment, as well as many other financing and advantages as will be described herein. The apparatus and method of the present invention also facilitates the distribution and management of education financing, educational instruction, education management, as well as requests processing related thereto.

The present invention also provides an apparatus and a method for providing a comprehensive processing system which incorporates data and/or information from any combination and/or all of the participants in the education field, including students, education provider or education materials provider or education tools provider or education computer-enabled tools providers, payers or academic financing entities and individual entities and individuals, and/or brokers, agents and/or other intermediaries who act on behalf of any of the above-identified persons or entities.

The apparatus of the present invention includes a central processing computer or central processing computer system which can be a network or server computer. The apparatus also includes an education provider or education materials provider or education tools provider or education computer-enabled tools provider communication device or computer which is associated with an education provider or education materials provider or education tools provider or education computer-enabled tools provider such as an education professional, an educational institution, a provider of educational instruction, and/or any other education provider or education materials provider or education tools provider or education computer-enabled tools provider of services described herein. The education provider or education materials provider or education tools provider or education computer-enabled tools provider computer(s) can communicate with, and operate in conjunction with, the central processing computer and/or any of the other computers and/or computer systems or communication devices described herein.

The apparatus can also include an education payer communication device or computer which is associated with an education payer such as an education financially responsible party and/or education financing guarantor and/or education financing government entity and/or education financing non-government entity or financial record keeping party, financing company, academic institution, a provider of educational instruction, and/or any other payer of education services and products described herein. The education payer computer(s) can communicate with, and operate in conjunction with, the central processing computer and/or any of the other computers and/or computer systems or communication devices described herein.

The apparatus can also include a student or individual user communication device or computer which is associated with an education student such as a student, user, or administrator who seeks or who is provided with education and/or related services, products and/or related information. The student computer(s) can communicate with, and operate in conjunction with, the central processing computer and/or any of the other computers and/or computer systems described herein.

The apparatus can also include an intermediary communication device or computer which is associated with an intermediary, a broker, an agent, and/or any other individual and/or entity, that can utilize the present invention in order to act for and/or on behalf of any other individual, party, or entity, described herein. The intermediary computer(s) can communicate with, and operate in conjunction with, the central processing computer and any of the other computers and/or computer systems described herein.

Each of the central processing computer(s), the education provider or education materials provider or education tools provider or education computer-enabled tools provider computer(s), the payer computer(s), the student computer(s), and/or the intermediary computer(s), can transmit information to, as well as receive information from, any of the computers described herein. In this regard, each of the computers can communicate with, process information from, and/or share data and/or information with, each other and/or any other computer or computers described herein and/or utilized in conjunction with the present invention. In this manner, data and/or information transfer between any of the computers can take place in a bi-directional manner.

The central processing computer(s), the education provider or education materials provider or education tools provider or education computer-enabled tools provider computer(s), the payer computers(s), the student computer(s), and the intermediary computer(s), can communicate with one another, and/or be linked to one another, over a communication network, a telecommunication network, a telephone network, a line-connected network, and/or a wireless communication network.

The present invention can be utilized on, or over, the Internet and/or the World Wide Web and/or on, or over, any other communication network or system, including, but not limited to, a communication network or system, a telecommunication network or system, a telephone communication network or system, a cellular communication network or system, a wireless communication network or system, a wireless Internet network or system, a wireless World Wide Web network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

The apparatus and method of the present invention can utilize electronic commerce technologies and security methods, techniques and technologies, in any and/or all of the instances of data and/or information processing, and/or data and/or information transmission described herein.

Each of the central processing computer(s), as well as each of the computers or communication devices associated with each of the herein-described users, students, education provider or education materials provider or education tools provider or education computer-enabled tools providers, payers, and/or intermediaries, can include a central processing unit or CPU, a random access memory device(s) (RAM), a read only memory device(s), and a user input device. Each of the central processing computer(s), as well as each of the computers or communication devices associated with each of the herein-described users, students, education provider or education materials provider or education tools provider or education computer-enabled tools providers, payers, and/or intermediaries, can also include a display device, a transmitter(s), a receiver, a database(s), and an output device. The database(s) can contain any and/or all of the data and or information which is needed to perform the various processing methods, services, functions and/or operations, described herein.

The apparatus and method of the present invention can be utilized in numerous preferred embodiments in order to provide a vast array of education and education related services for any one or more of the various parties described herein. Any student, user, education provider or education materials provider or education tools provider or education computer-enabled tools provider, payer, and/or intermediary, may utilize the present invention in the same, similar and/or analogous manner.

The present invention can be utilized for a number of applications, including, but not limited to, determining and/or ascertaining an education or education related or education analysis, verifying and/or checking an analysis or academic lesson, or performing a self-analysis. The present invention can be utilized by any of the parties described herein.

The present invention can perform an analysis from data and/or information which can be entered by a user or education provider or education materials provider or education tools provider or education computer-enabled tools provider, from data and/or information which can be obtained from education or education related or education devices, machines, and/or equipment, and/or from data and/or information which can be entered by a user or education provider or education materials provider or education tools provider or education computer-enabled tools provider in conjunction with, or along with, data and/or information which can be obtained from education or education related or education devices, machines, and/or equipment.

The present invention can be utilized to create and maintain comprehensive student databases which can be accessed via a network environment and/or otherwise, to perform education and/or education related assessments, to provide education and/or education related expected assessments, to provide education and/or education related academic lesson plans or programs, syllabi, curricula, and/or to provide education and/or education related academic lesson progress reports and/or evaluations.

The present invention can also be utilized in order to provide training and continuing education services for education and/or education related professionals, to provide education, education related, and/or instructional information, to provide information about education and/or education related student, education provider or education materials provider or education tools provider or education computer-enabled tools providers, payers, and/or intermediaries, to provide scheduling management services for education provider or education materials provider or education tools provider or education computer-enabled tools providers, to provide notification services for students, education provider or education materials provider or education tools provider or education computer-enabled tools providers, payers and/or intermediaries, and/or any other parties described herein, and/or to locate education provider or education materials provider or education tools provider or education computer-enabled tools providers, payers and/or intermediaries.

The present invention can also be utilized in order to provide education and/or education related request processing services, requests submissions, request processing, request status checking, and request reconciliation, request fraud prevention, academic lesson evaluation, education and/or education financing academic financing generation, management and administration, education provider or education materials provider or education tools provider or education computer-enabled tools provider, payer and/or intermediary evaluation, tutorial and/or academic lesson interactivity, academic lesson, instruction and/or education program availability and/or notification services, student, education provider or education materials provider or education tools provider or education computer-enabled tools provider, payer, intermediary and/or third party, notification services. The present invention can also be utilized as a clearinghouse for facilitating the offering, selling, buying, trading, and/or other commerce and/or transactions, involving education and/or education related services, products and/or goods.

The various computers and/or communication devices can be utilized to transmit and/or to receive transmissions, information, messages, and/or notification messages and/or signals, to and/or between, the respective parties associated with the respective computers and/or communication devices. The transmission of information, messages, and/or notification messages and/or signals can be effected via any one or more of e-mail messages, telephone messages, beeper or pager messages, physical mail delivery, electronic data transmission, and/or can be made via any other suitable and/or appropriate communication method and/or technique.

The present invention can be utilized in order to perform an analysis of an academic need and/or requirement, requirement and/or other condition. The present invention can also be utilized to ensure that a proper academic lesson and/or instruction is performed for the student, and/or to ensure that a subsequent academic lesson and/or academic lessons are performed as recommended. The present invention can also be utilized in order to prevent education or education related and/or instructional mistakes, mishaps and/or other instances when improper academic lesson could occur.

The present invention can also be utilized to allow a subsequent service or resource education provider or education materials provider or education tools provider or education computer-enabled tools provider to re-evaluate a student's condition and/or records and to seek additional assistance for the student, and/or to perform a separate and independent assessment and/or analysis of the student.

The present invention can also be utilized in order to access a student's or an administrator's record(s) and input information concerning the academic lesson and/or instruction to be performed. Thereafter, the present invention can provide notification to an education professional that the academic lesson and/or instruction may be a recommended academic lesson or instruction or a non-recommended academic lesson and/or instruction.

Any and/or all processing described herein can be performed in conjunction with data and/or information related to test scores, standardized test scores, class test scores, school test scores, federal test scores, state test scores, municipal test scores, district test scores, rankings, international rankings, national rankings, state rankings, municipal rankings, district rankings, reports, government reports, federal government reports, state reports, municipal reports, international reports, international agency reports, grading, grades, graduation rates, dropout rates, holdback rates, leave back rates, suspension rates, discipline rates, discipline hearing rates, graduation figures, dropout figures, holdback figures, leave back figures, suspension figures, discipline figures, discipline hearing figures, district size, school size, department size, class size, curriculum, syllabus, homework requirements, advanced placement courses offered, college level coursework offered, online courses offered, class structure, demographic composition, sociographic composition, teacher-pupil ratio, school ratings, national school ratings, state school ratings, municipal school ratings, district school ratings, community school ratings, school type, school educational focus, magnet schools, educational disciplines, electives, elective coursework offered, education focus, district academic standards, school academic standards, school-wide performance metrics, school performance data, state academic standards, state academic data, federal academic standards, federal academic data, pay, compensation, pay scales for educators, community demographic information, community sociographic information, administrative resources, administrative data, administrative ratios, administrative roles, administrative responsibilities, lesson plans, lesson planning, lesson uniformity, syllabus uniformity, curriculum uniformity, education data related alerts, education data related notifications, education data related information restrictions, education information processing related alerts, education information processing related notifications, education information processing related restrictions, administrator schedule data, teacher schedule data, student schedule data, teacher training, teacher mentoring, student tutoring, school security data, detention data, disciplinary data, parent teacher association data, athletic program data, athletic requirements, attendance data, administrator attendance, teacher attendance, student attendance, payroll data, eligibility data, student eligibility data, teacher eligibility data, student eligibility data, transportation data, bus data, bussing data, districting data, meal data, meal program data, nutrition data, teacher certifications, teacher coursework, teacher degrees, teacher demographics, teacher sociographics and/or psychographics, administrator certifications, administrator coursework, administrator degrees, administrator demographics, administrator sociographics and/or psychographics, student demographics, student sociographics and/or psychographics, student disability data, student disability rates, class structure, education philosophies, education methodologies, reading performance data, reading levels, math performance data, math levels, grades, grading, administrator language proficiency, teacher language proficiency, student language proficiency, language courses offered, transfer data, transfer rate information, funding related needs, funding related requirements, funding related requests, funding related decisions, funding related data, educational mandates, educational requirements, institution history, institution achievement, institution awards, administrator history, administrator achievement, administrator awards, teacher history, teacher achievement, teacher awards, student history, student achievement, and student awards.

Any and/or all processing described herein can be performed in conjunction with a student's education or education related history, family history, personal conditions information, and/or with any other information deemed important and/or essential in an individual's education assessments and/or academic lessons.

The present invention can also be utilized to perform academic lesson evaluations and/or academic lesson monitoring so as to allow for an evaluation and/or a monitoring of academic lesson and/or for providing training for education provider or education materials provider or education tools provider or education computer-enabled tools providers and/or professionals. The present invention can also be utilized in order to allow payer and/or academic financing entities and individual entities and individuals to evaluate academic lessons, academic lesson plans, syllabi, curricula, academic lesson progress, and/or any other evaluations and/or verifications for education requests processing.

The present invention can provide academic lesson evaluation and/or monitoring for education payers which can be utilized for performing requests processing, education provider or education materials provider or education tools provider or education computer-enabled tools provider evaluations, student evaluations, and/or any other useful and/or desired purpose.

The present invention can also be utilized to create and maintain a comprehensive student education database which can be accessed by any education provider or education materials provider or education tools provider or education computer-enabled tools provider, payer, intermediary, and/or other party or user, in order to access the student's education files and/or records. The comprehensive database can provide a data and/or information source which can be accessed by any education provider or education materials provider or education tools provider or education computer-enabled tools provider, from anywhere in the world, and at any time, in order to obtain information about a student in his, her, or its service or resource. Payers can also utilize the comprehensive database in order to ascertain payment eligibility, the existence of special considerations and/or to obtain any other useful information.

The present invention can also be utilized in order to find and/or to locate education provider or education materials provider or education tools provider or education computer-enabled tools providers and/or payers of, and for, respectively, various education academic lessons, education services and/or education goods or products and/or education related goods or products. The present invention can also be utilized to find a payer or financing company for providing desired education financing and/or for paying for certain academic lessons and/or instructions.

The present invention can also be utilized to find and/or locate supplies, instructional supplies, educational materials, educational content, and/or any other goods, products, and/or supplies, etc. The present invention can also be utilized by intermediaries, such as financing brokers, who need to find certain academic financing entities and individual entities and individuals and/or payers who meet the needs of certain students and/or administrators, and/or other individuals and/or third parties.

The present invention can also be programmed to provide notification of the availability of an education provider or education materials provider or education tools provider or education computer-enabled tools provider, the emergence of a student in need of a certain service or resource, the availability of a payer or an financing company to offer an academic financing or a certain academic financing, the availability of an education facility to provide certain service or resource, the availability of certain supplies, an educational resource, supply, information, material, content, and/or data, an expiration of an financing academic financing (i.e. education financing, educational instruction, education management, etc.,) and/or the occurrence of any event which may be of interest to any of the students, users, education provider or education materials provider or education tools provider or education computer-enabled tools providers, payers, and/or intermediaries, described herein.

The present invention can also be utilized to schedule appointments with any of the students, education provider or education materials provider or education tools provider or education computer-enabled tools providers, payers, and/or intermediaries, described herein.

The present invention can be utilized by intermediaries, such as, but not limited to brokers, financing brokers, agents, and others, in order to service their respective administrators. The present invention can be utilized to prepare offers of enrollment, to compare available academic offerings, to generate and/or underwrite academic offerings, and to service academic financing requests. In this, manner, the present invention can provide a platform for allowing a broker to provide improved services to his or her administrators while also providing for a more paperless working relationship.

The present invention can also be utilized to process education requests. The present invention can allow any of the students, education provider or education materials provider or education tools provider or education computer-enabled tools providers, payers, users, and/or intermediaries, to file requests with the respective party electronically and/or otherwise. The present invention can provide for the processing, tracking and reconciliation, of any and/or all education requests and/or education related requests.

The present invention can also be utilized to notify any party described herein, as well as any third parties, regarding any event, happening, occurrence, and/or any aspect of any request submission and/or processing activities.

The present invention can also provide for automatic request submission via the central processing computer once a final analysis and academic lesson has been recommended by an education provider or education materials provider or education tools provider or education computer-enabled tools provider and/or upon the occurrence of an examination and/or the administration of an academic lesson.

The present invention can also be utilized, in the manner described above in connection with requesting education financing, education management financing, and/or educational instruction financing.

The present invention can also be utilized to administer and/or maintain financial accounts for, and/or on behalf of, any of the students, users, education provider or education materials provider or education tools provider or education computer-enabled tools providers, payers, and/or intermediaries, described herein. The present invention can maintain detailed records of any and/or all of such transfers and/or transactions and provide periodic account statements to the respective parties maintaining accounts with the present invention.

The apparatus and method of the present invention can also utilize electronic signatures and/or process electronic signatures and/or electronic signature information which can correspond to any of the herein-described parties in performing any of the herein-described processing routines and/or functions.

The apparatus and method of the present can also be utilized as an education training simulator for any of the education provider or education materials provider or education tools provider or education computer-enabled tools providers, education provider or education materials provider or education tools provider or education computer-enabled tools providers, education professionals, and/or other education provider or education materials provider or education tools provider or education computer-enabled tools providers described herein. The present invention can also be utilized by any user and/or individual wishing to learn about a certain education field or topic. Data and/or information collected and/or stored by the apparatus, which relates to evaluations and/or conditions, as well as responses to academic lessons, can be utilized in order to present realistic and confidential training scenarios.

The apparatus and method of the present invention can also be utilized in order to maintain student education records or files private, to safeguard student education records or files, to provide notification to students and other individuals when others have accessed, obtained, and/or made changes to their respective education records or files, and/or to enable students and individuals to restrict and/or limit access to their education records or files.

The present invention can also provide for the security and/or the confidentiality of any and/or all of the data and/or information stored by, and/or processed by, same. Identification cards can also be utilized so as to store pertinent information for any of the respective parties so as to provide the respective party with access to various data and/or information and/or any processing functionality which can be provided by the present invention.

The present invention can also utilize intelligent agents, software agents, and/or mobile agents, which agents can be programmed to act for, and/or on behalf of, any of the parties described herein. The intelligent agent(s) can act on behalf of the respective party in various related interactions and/or other activities which are described as being performed herein and/or which may be incidental and/or related thereto. Therefore, the present invention also provides an agent-based apparatus and method for providing education information and/or education related information.

The apparatus of the present invention can also be programmed to be self-activating and/or activated automatically. The apparatus of the present invention can also be programmed in order to automatically generate and/or transmit any of the e-mails, electronic message transmissions, electronic notification transmissions, and/or any of the communications, described herein, between any of the parties which utilize the present invention.

The data and/or information, described as being stored in the various databases utilized by the respective computers and/or communication devices can be continuously updated so as to store the latest values for the data and/or information and can be stored and be made available for future processing routines.

Any and/or all of the data and/or information described herein as being stored in any of the various databases, can be linked via relational database techniques and/or via any appropriate database management techniques. The data and/or information can be updated via inputs from any of the computers and/or communication devices described herein, and/or external computers or communication devices, in real-time, and/or via dynamically linked database management techniques. The data and/or information which is stored in the various databases can be linked via any suitable data linking techniques such as, for example, dynamically linked lists (DLLs), linked lists, and object links embedded (OLE's).

Accordingly, it is an object of the present invention to provide an apparatus and a method for processing and/or for providing education information and/or education related information.

It is another object of the present invention to provide an apparatus and a method for processing and/or for providing education information and/or education related information, in a network environment.

It is still another object of the present invention to provide an apparatus and a method for processing and/or for providing education information and/or education related information, which can be utilized in a number of education and/or education related applications.

It is yet another object of the present invention to provide an apparatus and a method for processing and/or for providing education information and/or education related information, which provides and/or facilitates the creation and management of a comprehensive education processing system.

It is another object of the present invention to provide an apparatus and a method for performing education assessments.

It is still another object of the present invention to provide an apparatus and method for performing an education analysis from data and/or information which can be entered by a user or education provider or education materials provider or education tools provider or education computer-enabled tools provider.

It is yet another object of the present invention to provide an apparatus and method for performing an education analysis from data and/or information which can be obtained from education or education related or education devices, machines, and/or equipment.

It is another object of the present invention to provide an apparatus and method for performing an education analysis from data and/or information which can be entered by a user or education provider or education materials provider or education tools provider or education computer-enabled tools provider in conjunction with, or along with, data and/or information which can be obtained from education or education related or education devices, machines, and/or equipment.

It is still another object of the present invention to provide an apparatus and a method for performing education assessments, in a network environment.

It is yet another object of the present invention to provide an apparatus and a method for prescribing education academic lessons.

It is another object of the present invention to provide an apparatus and a method for prescribing education academic lessons, in a network environment.

It is still another object of the present invention to provide an apparatus and a method for providing education information which can incorporate data and/or information from any combination and/or all of the participants in the education field, including students, users, education provider or education materials provider or education tools provider or education computer-enabled tools providers, payers or academic financing entities and individual entities and individuals, and/or brokers, agents and/or other intermediaries who act on behalf of any of the above-identified persons or entities.

It is another object of the present invention to provide an apparatus and a method for providing education information which can be utilized by an education professional to verify and/or to check an analysis.

It is another object of the present invention to provide an apparatus and a method for providing education information which can be utilized by an individual to perform a self-analysis.

It is still another object of the present invention to provide an apparatus and a method for providing education information which can be utilized to create and/or to maintain a comprehensive student database which can be accessed to perform any one or more of education and/or education related assessments, to provide education and/or education related expected assessments, to provide education and/or education related academic lesson plans or programs, and/or to provide education and/or education related academic lesson progress reports and/or evaluations.

It is another object of the present invention to provide an apparatus and a method for providing education information which can be utilized as an education training simulator.

It is another object of the present invention to provide an apparatus and a method for providing education training.

It is another object of the present invention to provide an apparatus and a method for providing education information which can be utilized to provide scheduling management services for education provider or education materials provider or education tools provider or education computer-enabled tools providers, payers, education provider or education materials provider or education tools provider or education computer-enabled tools providers, users, and/or intermediaries.

It is another object of the present invention to provide an apparatus and a method for providing education information which can be utilized to provide notification services for students, education provider or education materials provider or education tools provider or education computer-enabled tools providers, payers, users, and/or intermediaries.

It is another object of the present invention to provide an apparatus and a method for providing education information which can be utilized to locate education provider or education materials provider or education tools provider or education computer-enabled tools providers, payers, students, users, and/or intermediaries.

It is still another object of the present invention to provide an apparatus and a method for providing education information which can be utilized to provide education request processing services.

It is yet another object of the present invention to provide an apparatus and a method for providing education information which can be utilized to provide education request processing services, including any one or more of requests submissions, request processing, request status checking, request reconciliation, and/or request fraud prevention.

It is another object of the present invention to provide an apparatus and a method for providing education information which can be utilized to provide education academic lesson evaluation.

It is still another object of the present invention to provide an apparatus and a method for providing education information which can be utilized to provide education financing academic financing generation, academic financing management, and/or academic financing administration.

It is yet another object of the present invention to provide an apparatus and a method for providing education information which can be utilized to provide education provider or education materials provider or education tools provider or education computer-enabled tools provider, payer, and/or intermediary evaluation.

It is another object of the present invention to provide an apparatus and a method for providing education information which can be utilized to provide information regarding tutorial and/or academic lesson interactivity, and/or academic lesson, instruction, and/or education program availability.

It is another object of the present invention to provide an apparatus which can be utilized as a clearinghouse for facilitating the offering, selling, buying, trading, and/or other commerce and/or transactions, involving education and/or education related services, products and/or goods.

It is still another object of the present invention to provide an apparatus and a method for providing education information which can be utilized to ensure that a proper academic lesson(s) or instruction(s) is recommended for a student and/or that a proper academic lesson and/or instruction is administered to, or performed for, a student.

It is another object of the present invention to provide an apparatus and a method for providing education information which can be utilized to access a student's or an administrator's record(s) and/or to obtain information concerning an academic lesson and/or an instruction to be performed.

It is still another object of the present invention to provide an apparatus and a method for providing education information which can be utilized to provide education assessments in conjunction with a student's education or education related history, family history, personal conditions information, and/or with any other information deemed important and/or essential in an individual's education analysis and/or academic lesson.

It is still another object of the present invention to provide an apparatus and a method for providing education information which can be utilized to allow payers and/or academic financing entities and individual entities and individuals to evaluate academic lessons, academic lesson plans, syllabi, curricula, academic lesson progress, and/or any other evaluations and/or verifications, for education requests processing.

It is yet another object of the present invention to provide an apparatus and a method for providing education information which can be utilized to allow education provider or education materials provider or education tools provider or education computer-enabled tools providers or payers to evaluate academic lessons, academic lesson plans, syllabi, curricula, academic lesson progress, and/or any other evaluations and/or verifications, requests processing for providing education and/or related services.

It is still another object of the present invention to provide an apparatus and a method for providing education information which can be utilized to find and/or locate supplies, instructional supplies, educational materials, educational content, and/or any other goods, products, and/or supplies, etc.

It is another object of the present invention to provide an apparatus and a method for providing education information which can be utilized to find and/or locate a payer or financing company for providing desired education financing and/or for paying for certain academic lessons and/or instructions.

It is still another object of the present invention to provide an apparatus and a method for providing education information which can be utilized by intermediaries, such as financing brokers, to find and/or locate academic financing entities and individual entities and individuals and/or payers who meet the needs of certain parties.

It is still another object of the present invention to provide an apparatus and a method for providing education information which can be programmed to provide notification of the availability of an education provider or education materials provider or education tools provider or education computer-enabled tools provider, the emergence of a student in need of a certain service or resource, the availability of a payer or an financing company to offer an academic financing or a certain academic financing, the availability of an education facility to provide certain service or resource, the availability of certain supplies, an educational resource, supply, information, material, content, and/or data, an expiration of an financing academic financing, and/or the occurrence of any event which may be of interest to students, users, education provider or education materials provider or education tools provider or education computer-enabled tools providers, payers, and/or intermediaries.

It is still another object of the present invention to provide an apparatus and a method for providing education information which can be utilized to prepare financing offers of enrollment, compare available academic offerings, generate academic offerings, and service academic financing requests.

It is another object of the present invention to provide an apparatus and a method for providing education information which can be utilized to provide for automatic education request submission.

It is another object of the present invention to provide an apparatus and a method for providing education information which can be utilized to provide for automatic education request submission once a final analysis has been determined and/or an academic lesson has been recommended.

It is still another object of the present invention to provide an apparatus and a method for providing education information which can be utilized to request education financing, education management financing, and/or educational instruction financing.

It is yet another object of the present invention to provide an apparatus and a method for providing education information which can be utilized to administer and/or maintain financial accounts for, and/or on behalf of, any of the students, users, education provider or education materials provider or education tools provider or education computer-enabled tools providers, payers, and/or intermediaries, described herein.

It is another object of the present invention to provide an apparatus and a method for providing education information which can provide for the security and/or the confidentiality of any data and/or information concerning students, users, education provider or education materials provider or education tools provider or education computer-enabled tools providers, payers, and/or intermediaries.

It is still another object of the present invention to provide an apparatus and a method for providing education information which can be utilized in conjunction with identification cards which are utilized to store information regarding students, education provider or education materials provider or education tools provider or education computer-enabled tools providers, payers, users, and/or intermediaries.

It is yet another object of the present invention to provide an apparatus and method for providing education information which can be utilized in order to maintain student education records or files private and/or to safeguard student education records or files.

It is another object of the present invention to provide an apparatus and method for providing education information which can provide notification to students and individuals when others have accessed, obtained, and/or made changes to their respective education records or files.

It is still another object of the present invention to provide an apparatus and method for providing education information which can enable students and individuals to restrict and/or limit access to their education records or files.

It is yet another object of the present invention to provide an apparatus and a method for providing education information which can be utilized in conjunction with intelligent agents, software agents, and/or mobile agents.

It is another object of the present invention to provide an apparatus and a method for providing education information which can be programmed to be self-activating and/or activated automatically.

It is still another object of the present invention to provide an apparatus and a method for providing education information which can be utilized to automatically generate and/or transmit any of the e-mails, electronic message transmissions, electronic notification transmissions, and/or any of the communications, described herein, between any of the parties which utilize the present invention.

It is yet another object of the present invention to provide an apparatus and a method for providing education information which can be utilized in conjunction with various electronic commerce technologies and/or security methods, techniques and technologies.

It is another object of the present invention to provide an apparatus and method for providing education information which can utilize electronic signatures and/or process electronic signatures and/or electronic signature information in performing any of the herein-described processing routines and/or functions.

Other objects and advantages of the present invention will be apparent to those skilled in the art upon a review of the Description of the Preferred Embodiment, taken in conjunction with the Drawings which follow.

### BRIEF DESCRIPTION OF THE DRAWINGS

In the Drawings:

FIG. 1 illustrates a preferred embodiment of the present invention, in block diagram form;

FIG. 2 illustrates the central processing computer of FIG. 1, in block diagram form;

FIG. 3 illustrates the education provider or education materials provider or education tools provider or education computer-enabled tools provider communication device of FIG. 1, in block diagram form;

FIG. 4 illustrates the payer communication of FIG. 1, in block diagram form;

FIG. 5 illustrates the student communication device of FIG. 1, in block diagram form;

FIG. 6 illustrates the intermediary communication device of FIG. 1, in block diagram form;

FIGS. 7A and 7B illustrate a preferred embodiment method of using the present invention, in flow diagram form;

FIGS. 8A and 8B illustrate another preferred embodiment method of using the present invention, in flow diagram form;

FIGS. 9A and 9B illustrate still another preferred embodiment method of using the present invention, in flow diagram form;

FIG. 10 illustrates yet another preferred embodiment method of using the present invention, in flow diagram form;

FIGS. 11A and 11B illustrate another preferred embodiment method of using the present invention, in flow diagram form;

FIGS. 12A and 12B illustrate still another preferred embodiment method of using the present invention, in flow diagram form;

FIGS. 13A, 13B and 13C illustrate yet another preferred embodiment method of using the present invention, in flow diagram form;

FIGS. 14A and 14B illustrate another preferred embodiment method of using the present invention, in flow diagram form;

FIGS. 15A and 15B illustrate another preferred embodiment method of using the present invention, in flow diagram form;

FIGS. 16A and 16B illustrate another preferred embodiment method of using the present invention, in flow diagram form; and

FIGS. 17A and 17B illustrate another preferred embodiment method of using the present invention, in flow diagram form.

### DESCRIPTION OF THE PREFERRED EMBODIMENT

The present invention is directed to an apparatus and a method for processing and/or for providing education information and/or education related information and, in particular, to an apparatus and a method for processing and/or for providing education information and/or education related information for a variety of education and education related applications.

The apparatus and method of the present invention facilitates the creation and management of a comprehensive education processing system which can manage student and administrator records, education products and education services providers, and education computing applications providers, and education technical solutions providers and other education provider or education materials provider or education tools provider or education computer-enabled tools provider records, education financing and/or payer records, and thereby provide an apparatus, system and methods for providing a variety and a multitude of education information processing applications, processes and services.

The present invention facilitates improved education quality, efficient information collection, processing and dissemination, efficient analysis and academic lesson, cost efficiency, cost containment, as well as many other financing and advantages as will be described herein.

The apparatus and method of the present invention also facilitates the distribution and management of education financing, educational instruction, education management, as well as requests processing related thereto.

The present invention also provides an apparatus and a method for providing a comprehensive processing system which incorporates data and/or information from any combination and/or all of the participants in the education field including, but not limited to, students and those seeking education, education provider or education materials provider or education tools provider or education computer-enabled tools providers, educators, including education or education related service providers, and/or any other person, individual and/or professional who can provide education, education related, instructional and/or instructional-related services and/or products, academic financing entities and individual entities and individuals, education and academic financing entities and individual entities and individuals, government academic financing entities, and public entities, private academic financing entities, academic institutions, education provider or education materials provider or education tools provider or education computer-enabled tools providers, and any other payer and/or education provider or education materials provider or education tools provider or education computer-enabled tools provider of education services and/or products, education requests processing centers, education financing brokers and/or agents, and/or any other third party and/or intermediary who or which acts on behalf of another and/or assists in to providing of education and/or related services.

The apparatus and method of the present invention can also be utilized in order to maintain student education records or files private, to safeguard student education records or files, to provide notification to students and other individuals when others have accessed, obtained, and/or made changes to their respective education records or files, and/or to enable students and individuals to restrict and/or limit access to their education records or files.

As used herein, the terms “individual”, “student”, “administrator”, “user” or the like, or their plural forms, refers to any person, individual, student, and/or administrator who uses the present invention, and/or who seeks and/or who receives education services, education related services, education related information, and/or any of the other services and/or products provided by the present invention.

As used herein, the terms “education products and education services providers, and education computing applications providers, and education technical solutions providers”, “education provider or education materials provider or education tools provider or education computer-enabled tools provider”, “education provider or education materials provider or education tools provider or education computer-enabled tools provider”, “educator”, “instructor”, “teacher”, “educational product supplier”, “educational materials provider”, “educational services provider”, “administrator”, “intermediary”, “education financing party”, “education information specialist”, etc., or their plural forms, refers to any education or education related education products and education services providers, and education computing applications providers, and education technical solutions providers, including any and all of the various education or education related specialists and/or specialties, including, but not limited to education or education related specialist, instructional specialists, including any and/or forms and/or types of instructors, education aid, administrator, and/or any other person, individual and/or professional who can provide education, education related products, education related services, instructional and/or instructional-related services and/or products.

As used herein, the terms “financially responsible party or financial record keeping party”, “payer”, “financing education provider or education materials provider or education tools provider or education computer-enabled tools provider”, “education financing education provider or education materials provider or education tools provider or education computer-enabled tools provider”, “educational instruction education provider or education materials provider or education tools provider or education computer-enabled tools provider”, “education management education provider or education materials provider or education tools provider or education computer-enabled tools provider”, etc., or their plural forms, refers to any academic financing entities and individual entities and individuals, education academic financing entities and individual entities and individuals, disability academic financing entities and individual entities and individuals, casualty academic financing entities and individual entities and individuals, academic institutions, education provider or education materials provider or education tools provider or education computer-enabled tools providers, and any other payer and/or education provider or education materials provider or education tools provider or education computer-enabled tools provider of education services and/or products, who which provide and/or pay for education and/or education related financing, services, and/or products, and/or who or which provide respective education financing, educational instruction and/or education management financing, services and/or products.

As used herein, the terms “broker”, “agent”, “billing service”, “collection agent”, “manager”, intermediary”, “assistant”, etc., or their plural forms, refer to any broker, financing broker, agent, financing agent, intermediary, third party, billing service education provider or education materials provider or education tools provider or education computer-enabled tools provider, collection agent, request processing agent, and/or any other person, individual, and/or entity, which acts on behalf of, or for, any of the individuals, students, educators, education provider or education materials provider or education tools provider or education computer-enabled tools providers, financially responsible party or financial record keeping parties, payers, etc., described herein.

As used herein, the term “data”, “information”, etc. or their plural forms, refer to any of test scores, standardized test scores, class test scores, school test scores, federal test scores, state test scores, municipal test scores, district test scores, rankings, international rankings, national rankings, state rankings, municipal rankings, district rankings, reports, government reports, federal government reports, state reports, municipal reports, international reports, international agency reports, grading, grades, graduation rates, dropout rates, holdback rates, leave back rates, suspension rates, discipline rates, discipline hearing rates, graduation figures, dropout figures, holdback figures, leave back figures, suspension figures, discipline figures, discipline hearing figures, district size, school size, department size, class size, curriculum, syllabus, homework requirements, advanced placement courses offered, college level coursework offered, online courses offered, class structure, demographic composition, sociographic composition, teacher-pupil ratio, school ratings, national school ratings, state school ratings, municipal school ratings, district school ratings, community school ratings, school type, school educational focus, magnet schools, educational disciplines, electives, elective coursework offered, education focus, district academic standards, school academic standards, school-wide performance metrics, school performance data, state academic standards, state academic data, federal academic standards, federal academic data, pay, compensation, pay scales for educators, community demographic information, community sociographic information, administrative resources, administrative data, administrative ratios, administrative roles, administrative responsibilities, lesson plans, lesson planning, lesson uniformity, syllabus uniformity, curriculum uniformity, education data related alerts, education data related notifications, education data related information restrictions, education information processing related alerts, education information processing related notifications, education information processing related restrictions, administrator schedule data, teacher schedule data, student schedule data, teacher training, teacher mentoring, student tutoring, school security data, detention data, disciplinary data, parent teacher association data, athletic program data, athletic requirements, attendance data, administrator attendance, teacher attendance, student attendance, payroll data, eligibility data, student eligibility data, teacher eligibility data, student eligibility data, transportation data, bus data, bussing data, districting data, meal data, meal program data, nutrition data, teacher certifications, teacher coursework, teacher degrees, teacher demographics, teacher sociographics and/or psychographics, administrator certifications, administrator coursework, administrator degrees, administrator demographics, administrator sociographics and/or psychographics, student demographics, student sociographics and/or psychographics, student disability data, student disability rates, class structure, education philosophies, education methodologies, reading performance data, reading levels, math performance data, math levels, grades, grading, administrator language proficiency, teacher language proficiency, student language proficiency, language courses offered, transfer data, transfer rate information, funding related needs, funding related requirements, funding related requests, funding related decisions, funding related data, educational mandates, educational requirements, institution history, institution achievement, institution awards, administrator history, administrator achievement, administrator awards, teacher history, teacher achievement, teacher awards, student history, student achievement, and student awards.

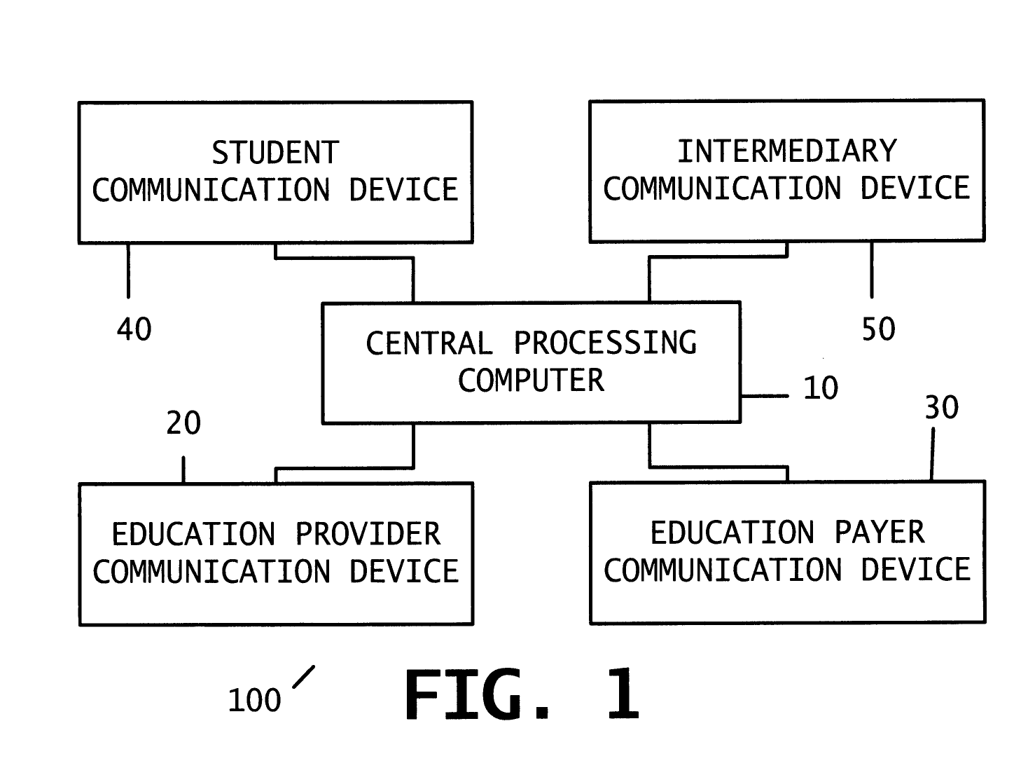

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment the central processing computer 10 can be a network or server computer.

In the preferred embodiment, the central processing computer 10 can provide control over the apparatus 100 and can perform any of the various processing services and/or functions described herein. The central processing computer 10 may be a single computer or system of computers and/or may be include a plurality of computers or computer systems which are utilized in conjunction with one another. The central processing computer 10, in the preferred embodiment can provide services for any of the other computers and/or computer systems described herein as being associated with any of the individuals, students, education provider or education materials provider or education tools provider or education computer-enabled tools providers, financially responsible party or financial record keeping parties, payers, brokers, agents, and/or intermediaries, described herein.

The apparatus 100 also includes an education provider or education materials provider or education tools provider or education computer-enabled tools provider communication device or computer 20 (hereinafter referred to as “education provider or education materials provider or education tools provider or education computer-enabled tools provider communication device 20” or “education provider or education materials provider or education tools provider or education computer-enabled tools provider computer 20”) which is associated with an education provider or education materials provider or education tools provider or education computer-enabled tools provider such as an education professional, an educational institution, a provider of educational instruction, and/or any other education provider or education materials provider or education tools provider or education computer-enabled tools provider of services described herein. Any number or amount of education provider or education materials provider or education tools provider or education computer-enabled tools provider computers 20 can be utilized in conjunction with an education provider or education materials provider or education tools provider or education computer-enabled tools provider and/or group of education provider or education materials provider or education tools provider or education computer-enabled tools providers. The education provider or education materials provider or education tools provider or education computer-enabled tools provider computer(s) 20 can communicate with, and operate in conjunction with, the central processing computer 10 and/or any of the other computers and/or computer systems associated with any of the other individuals and/or entities which utilize and/or operate in conjunction with the present invention.

The apparatus 100 can also include an education payer communication device or computer 30 (hereinafter referred to as “payer communication device 30” or “payer computer 30”) which is associated with an education payer such as an education financially responsible party and/or education financing guarantor and/or education financing government entity and/or education financing non-government entity or financial record keeping party, financing company, academic institution, a provider of educational instruction, and/or any other payer of education services and products described herein. Any number or amount of education payer computers 30 can be utilized in conjunction with an education payer and/or group of payers. The education payer computer(s) 30 can communicate with, and operate in conjunction with, the central processing computer 10 and/or any of the other computers and/or computer systems associated with any of the other individuals and/or entities which utilize and/or operate in conjunction with the present invention.

The apparatus 100 can also include a student or individual user communication device or computer 40 (hereinafter “student communication device 40” or “student computer 40”) which is associated with an education student such as a student, user, or administrator who seeks or who is provided with education and/or related services, products and/or related information. The student communication device 40 can also be utilized by any individual, party, or entity, who or which may merely utilize the present invention in order to obtain information of interest.

A student communication device 40 may also be located at public places or locations, such as at kiosks or other publicly available computer or communication devices. Any number or amount of student computers 40 can be utilized in conjunction with a student and/or group of students. The student computer(s) 40 can communicate with, and operate in conjunction with, the central processing computer 10 and/or any of the other computers and/or computer systems associated with any of the other individuals and/or entities which utilize and/or operate in conjunction with the present invention. The student computer(s) 40 can also be utilized by any other individual or entity desiring to utilize and/or to obtain information from the apparatus 100 and/or from any other the

The apparatus 100 can also include an intermediary communication device or computer 50 (hereinafter referred to as “intermediary communication device 50” or “intermediary computer 50”) which is associated with an intermediary, a broker, an agent, and/or any other individual and/or entity, that can utilize the present invention in order to act for and/or on behalf of any other individual, party, or entity, described herein. Any number or amount of intermediary computers 50 can be utilized in conjunction with an intermediary and/or group of intermediaries. The intermediary computer(s) 50 can communicate with, and operate in conjunction with, the central processing computer 10 and any of the other computers and/or computer systems associated with any of the other individuals and/or entities which utilize and/or operate in conjunction with the present invention.

In the preferred embodiment, any of the education provider or education materials provider or education tools provider or education computer-enabled tools provider computer(s) 20, the payer computer(s) 30, the student computer(s) 40, and/or the intermediary computer(s) 50, can be any computer or communication device, including, but not limited to, a personal computer, a home computer, a server computer, a network computer, a hand-held computer, a palmtop computer, a laptop computer, a personal communication device, a personal digital assistant, a telephone, a digital telephone, a television, an interactive television, a beeper, a pager, a watch, and/or any other device capable of receiving and/or transmitting electronic signals, and/or light signals, and/or particle signals, and/or digital signals.

Each of the central processing computer(s) 10, the education provider or education materials provider or education tools provider or education computer-enabled tools provider computer(s) 20, the payer computer(s) 30, the student computer(s) 40, and/or the intermediary computer(s) 50, can transmit information to, as well as receive information from, any of the computers 10, 20, 30, 40, and 50, described herein. In this regard, each of the computers 10, 20, 30, 40, and 50, can communicate with, process information from, and/or share data and/or information with, each other and/or any other computer or computers 10, 20, 30, 40, and 50, described herein and/or utilized in conjunction with the present invention. In this manner, data and/or information transfer between any of the computers 10, 20, 30, 40, and 50, can communicate with any other computer or computers 10, 20, 30, 40, and 50, in a bi-directional manner.

The central processing computer(s) 10, the education provider or education materials provider or education tools provider or education computer-enabled tools provider computer(s) 20, the payer computers(s) 30, the student computer(s) 40, and the intermediary computer(s) 50, can communicate with one another, and/or be linked to one another, over a communication network, a telecommunication network, a telephone network, a line-connected network, and/or a wireless communication network. Each of the computers 10, 20, 30, 40, and 50, can be linked with any other computer or computers directly or indirectly directly or indirectly with one another so as to facilitate a direct or indirect bi-directional communication said respective computers.

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith.

Although the Internet and/or the World Wide Web is a preferred communication system and/or medium utilized, the present invention, in all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

In the preferred embodiment, each of the central processing computer(s) 10, the education provider or education materials provider or education tools provider or education computer-enabled tools provider computer(s) 20, the payer computer(s) 30, the student computer(s) 40, and intermediary computer(s), can transmit data and/or information using TCP/IP, as well as any other Internet and/or World Wide Web, and/or communication, protocols.

The apparatus 100 of the present invention can utilize electronic commerce technologies and security methods, techniques and technologies, in any and/or all of the instances of data and/or information processing, and/or data and/or information transmission described herein.

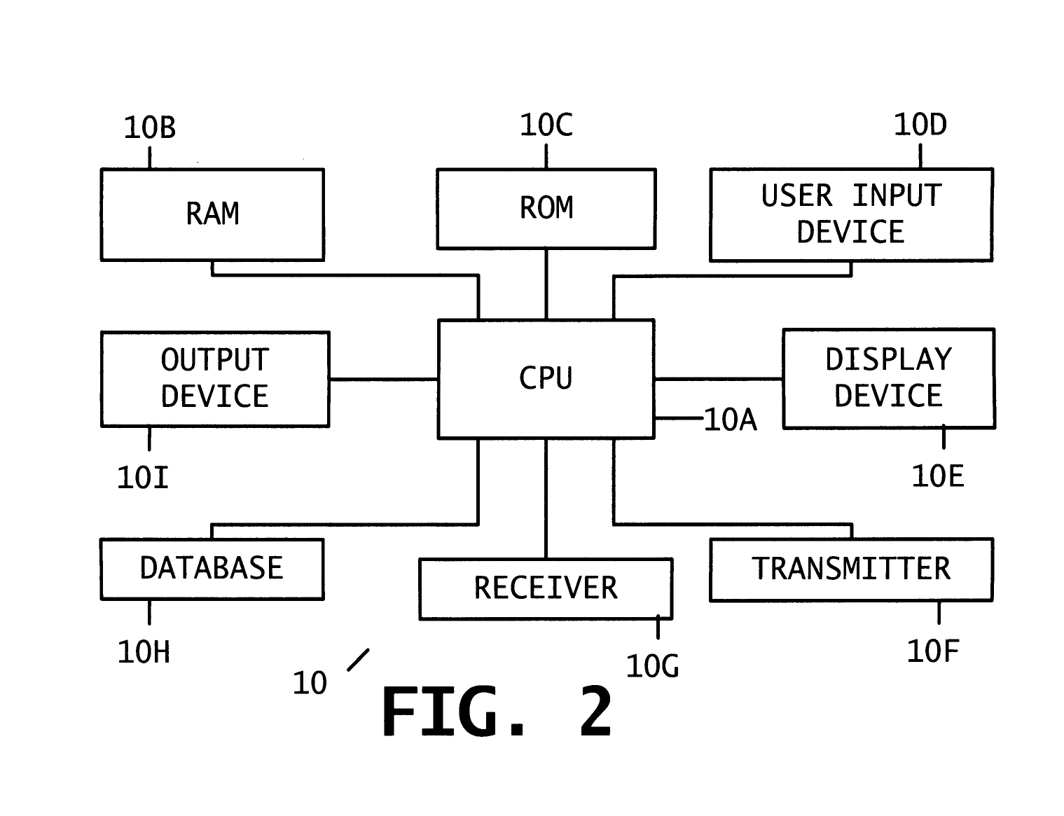

FIG. 2 illustrates the central processing computer 10, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering education data and/or information, for example testing monitors, educational materials usage monitors, clocks and/or timers, biometric measurement devices and monitors, educational materials consumption monitors, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, the education provider or education materials provider or education tools provider or education computer-enabled tools provider computer(s) 20, the payer computers(s) 30, the student computer(s) 40, and the intermediary computer(s) 50 individual computer(s), which may be utilized in conjunction with the present invention. The central processing computer 10 also includes a receiver 10G, for receiving signals and/or data and/or information from any one or more of the central processing computer(s) 10, the education provider or education materials provider or education tools provider or education computer-enabled tools provider computer(s) 20, the payer computers(s) 30, the student computer(s) 40, and the intermediary computer(s) 50, which may be utilized in conjunction with the present invention.

The central processing computer 10 also includes a database(s) 10H which contains data and/or information pertaining to the students, education provider or education materials provider or education tools provider or education computer-enabled tools providers, payers, and intermediaries who or which are serviced by the present invention and/or who or which utilize the present invention.

The database 10H can contain any and/or all of the information needed and/or required in order to perform any and/or all of the functions, services and/or operations described herein as being performed by the central processing computer 10 or the apparatus 100 of the present invention. In this regard the database 10H can contain data and/or information regarding student name, student identification information, student social security number or other identification information, date of birth, educators or education provider or education materials provider or education tools provider or education computer-enabled tools providers, teachers, instructors, financing or payer information, group financing information, group education financing information, educational instruction information, education management information, student address, phone number, e-mail and/or other contact information, education or education related history, behavior/psychological history, academic history, family history, family education or education related, behavior/psychological, and/or academic history, financing education financing, financing co-payment and/or deductible information, financing information, the financial payment request, financial grant request, financial credit request, financial loan request instructions, the financial payment request, financial grant request, financial credit request, financial loan request forms, education products and education services providers, and education computing applications providers, and education technical solutions providers or education provider or education materials provider or education tools provider or education computer-enabled tools provider appointment schedules, past academic lessons, past analysis, evaluations, the financial payment request, financial grant request, financial credit request, financial loan request forms, employer information, lifestyle information, academic lesson plans, syllabi, curricula, academic lesson progress, broker/agent/intermediary information, education information, age, sex, marital status, employee financing information, types or services and/or academic lessons needed, and any other data and/or information regarding the student which would be needed and/or desired in order to perform any and/or all of the functions, services and/or operations described herein.

The database(s) 10H can also contain education and/or education or education related video, image, and/or audio, data and/or information, such as, for example, scanned forms, digital documents, electronic data, electronic exams, and/or any other video, imaging, and/or audio, education data and/or information which can be utilized by education provider or education materials provider or education tools provider or education computer-enabled tools providers, payers, intermediaries, students, and/or other users of the present invention. In this manner, the present invention can facilitate the availability of any of the above-described video, image, and/or audio, data and/or information in a network environment. For example, an education or education related specialist can have access to, and/or review, an electronic exam for a student, from any location and at any time.

The database 10H can also contain data and/or information regarding education provider or education materials provider or education tools provider or education computer-enabled tools providers including education provider or education materials provider or education tools provider or education computer-enabled tools provider name, education provider or education materials provider or education tools provider or education computer-enabled tools provider social security number or identification number, type of professional or service education provider or education materials provider or education tools provider or education computer-enabled tools provider, address, phone number, fax number, e-mail and/or other contact information, experience, specialties, financings accepted, schedule of charges, financial account identification information, resume information, education, work experience, request forms, appointment schedules, instructions performed, and/or any other data and/or information concerning the education provider or education materials provider or education tools provider or education computer-enabled tools providers for providing any and/or all of the functions, services, and/or operations described herein as being performed by the present invention.

The database 10H can also contain data and/or information regarding all possible fields of education, instruction, education financing, education materials provisioning, education services provisioning, education administration, education management, instructional, and/or any other possible education fields and/or subject matter which can possibly by utilized in the processing and/or operation of the present invention.

The database 10H can also contain information on requirements, evaluations, courses and/or academic need and/or requirements, theories, scientific theories, research data and/or information, analysis information, academic lesson information, academic lesson plans, syllabi, curricula, academic lesson processes, academic lesson progresses, academic lesson interactions, education activities, education activity results, expected academic lesson results, academic lesson education provider or education materials provider or education tools provider or education computer-enabled tools providers, academic lesson durations, academic lesson costs, pre-academic lesson information, post-academic lesson information, academic lesson monitoring information, statistical information regarding assessments, academic lessons, academic lesson success rates, academic lesson failure rates, academic lesson centers, instruction plans, syllabi, curricula, instruction success rates, instruction failure rates, academic lesson instructions, educational content academic lessons, non-instruction academic lessons, education institutions, academic lesson evaluating criteria, academic lesson mistakes and/or mishaps, indicators of mistakes and/or mishaps, corrective actions, links to education provider or education materials provider or education tools provider or education computer-enabled tools providers, links to academic lesson centers or institutions, reimbursement rates, nutrition information, diet information, exercise information, exercise routines, academic lesson options, education advise, instructional advice, preventive service or resource, preventive instruction, education maintenance, tutorial and instruction information, tutorial interaction information, video information, including video files or clips and other information, regarding requirements, courses, academic lessons and follow-up service or resource, audio information, including audio files or clips and other information, regarding requirements, courses, academic lessons and follow-up service or resource, academic lesson and/or instruction information and/or narratives, academic lesson analysis, analysis, analysis monitoring, analysis confirmation and/or checking, and/or other information for providing the herein-described functions, services, and/or operations.

The database 10H can also contain information regarding the academic financing entities and individual entities and individuals and payers described herein, including, but not limited to, payer name, address, phone number, fax number, e-mail address, identification number(s), education financing types, academic offerings and/or education financings provided, reimbursement rates, students and/or education provider or education materials provider or education tools provider or education computer-enabled tools providers serviced and/or covered by the payer, academic financing information, request forms, request instructions, request status, request processing information, request submission instructions and academic offerings, reasonable and customary charges, co-payment information, pre-approval information and/or instructions, request form information, electronic form request forms, financing and/or education financing requirements, guidelines, and/or triggering events, covered instructions and/or academic lessons, uncovered instructions and/or academic lessons, request approval information, request approval history, request approval statistics, request rejection or denial information, request rejection or denial history, request rejection or denial statistics, financial account information, network education provider or education materials provider or education tools provider or education computer-enabled tools provider information, network student information, request statistics, educational planning service or resource and/or financing information, financing information, financing request information and/or request forms, request submission information, request processing information, request status information, payment information and statistics, and/or any other data and/or information regarding and/or related to payers which are needed and/or desired for providing any and/or all of the functions, services, and/or operations described herein.

The database 10H can also contain data and/or information regarding the brokers, agents and/or intermediaries described herein, including, but not limited to, intermediary name, address, phone number, fax number, e-mail address, administrators, students services, financing academic offerings, academic financing information, academic financing quote information, academic financing proposal information, any and/or all of the above information described herein regarding students, education provider or education materials provider or education tools provider or education computer-enabled tools providers, payers, etc. which may be of interest to the intermediaries described herein which may be useful and/or beneficial to the intermediaries in providing any of the functions, services, and/or operation described herein.

The database 10H can also contain contact information such as phone numbers, fax numbers, pager numbers, beeper numbers, e-mail addresses, hyperlinks to, and/or any other information which can facilitate contact between any of the parties described herein. The database 10H also includes electronic signature data and/or information for any of the parties, students, education provider or education materials provider or education tools provider or education computer-enabled tools providers, payers, and/or intermediaries, described herein for facilitating transactions, request submissions, financial transactions, etc., by and/or between any of the above students, education provider or education materials provider or education tools provider or education computer-enabled tools providers, payers, and/or intermediaries.

The data and/or information in the database 10H can also include links to any other information, information sources, news sources, and/or other information and/or data which can or may be utilized by the present invention and/or by any of the students, education provider or education materials provider or education tools provider or education computer-enabled tools providers, payers, intermediaries and/or any other users of the present invention.

The database 10H can also contain data and/or information regarding education news, education developments, education discoveries, etc., for and including the education or education related field, instructional field, educational product field, educational services field, etc., and/or any other education field or fields.

The database 10H, in the preferred embodiment, can also contain video and/or audio files which can be utilized for training of education professionals as well as for providing general information to any user of the present invention. In this manner, and as will be described herein below, the apparatus 100 can be utilized as a simulator for providing training in education or education related planning, education or education related training, instructional training, and/or for training any of the education provider or education materials provider or education tools provider or education computer-enabled tools providers described herein and/or envisioned.

For example, the present invention can be utilized to provide an education or education related education products and education services providers, and education computing applications providers, and education technical solutions providers with a set of evaluations, evaluate the analysis and academic lesson recommended and provide follow-up student conditions which may or may not call for the education or education related education products and education services providers, and education computing applications providers, and education technical solutions providers to re-evaluate his or her analysis and/or academic lesson or lessons. In a similar fashion, the present invention can be used for training and continuing education and training for any of the education provider or education materials provider or education tools provider or education computer-enabled tools providers described herein and/or otherwise envisioned utilizing the present invention.

The database 10H can also contain data and/or information restricting access by any of the education provider or education materials provider or education tools provider or education computer-enabled tools providers, payers, students, intermediaries, and/or other users, to any of the data and/or information stored in the database 10H.

The database 10H can also contain information correlating evaluations and/or conditions with assessments, assessments, and/or academic lessons, academic lesson methods, instructions, etc. The database 10H also contains any and/or all information needed and/or desired for facilitating the processing of evaluations, conditions, education or education related histories, family histories, and other information, in order to arrive at assessments and/or assessments, academic lessons, prescriptions, instructions and/or any other education and/or education related information.

The database 10H can also contain statistical and/or other probabilistic and/or mathematical information for assigning and/or correlating certain levels and/or estimates for any and/or all of the information, assessments, assessments, academic lessons, instructions, and/or any other information processed and/or generated by the central processing computer 10 and/or the apparatus 100. Applicant hereby incorporates by reference herein the teachings of Basic Business Statistics Concepts and Applications, Mark L. Berenson and David M. Levine, 6.sup.th Edition, Prentice Hall 1996.

The database 10H, in the preferred embodiment, can be a database which may include individual databases or collections of databases, with each database being designated to store any and all of the data and/or information described herein. The database 10H, or collection of databases, may be updated by each of the respective students, education provider or education materials provider or education tools provider or education computer-enabled tools providers, payers, users, and/or intermediaries, and/or by any other third party, in real-time, and/or via dynamically linked database management techniques.

The data and/or information stored in the database 10H can also be updated by and/or dynamically linked to, various external sources, including but not limited to news services, research publications, research facilities, education laboratories, education provider or education materials provider or education tools provider or education computer-enabled tools providers of education goods and/or services, educational companies, research institutions, schools. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The data and/or information which is contained and/or stored in the database 10, as well as any of the other databases 20H, 30H, 40, and 50H, described herein can be obtained from the various students, individuals, education provider or education materials provider or education tools provider or education computer-enabled tools providers, payers, and/or intermediaries, who or which utilize and/or who or which are serviced by the present invention. For example, the respective students, education provider or education materials provider or education tools provider or education computer-enabled tools providers, payers, intermediaries, and/or other users, could fill out questionnaires, forms, narratives, request forms, and/or any other information medium, in written form, electronically, and/or otherwise.

Data and/or information stored in the database 10H as well as any of the other databases described herein can be updated by multiple parties. For example, a student may provide education or education related history for his or her individual file, his or her education or education related education products and education services providers, and education computing applications providers, and education technical solutions providers can update the education or education related history information for the student upon examining and/or treating him or her. The payer may also update the file with any associated payment or payment-related information. Should the student go to another education products and education services providers, and education computing applications providers, and education technical solutions providers or different type of education products and education services providers, and education computing applications providers, and education technical solutions providers, all previous information would be available for, and can be updateable by, the next education products and education services providers, and education computing applications providers, and education technical solutions providers.

The database 10H can also contain information regarding alternate education techniques, and/or other non-traditional, non-classical, vocational, non-vocational, physical training or instruction, behavior/psychological training or instruction, instructional lessons and/or techniques.

The database 10H can also include statistical data and/or information regarding assessments, and/or alternate assessments, academic lesson success, academic lesson failure, as well as statistical data and/or information regarding misassessments. The database 10H also contains data and/or information regarding experimental academic lessons as well as statistical information regarding same, successes of same and failures of same.

In any and/or all of the embodiments described herein, any of the data and/or information which is or which may be stored in the database 10H, and/or any of the other databases described herein, can be utilized and/or can appear in any of the reports, analytical reports, academic lesson reports, evaluation reports, education provider or education materials provider or education tools provider or education computer-enabled tools provider reports, payer reports, student reports, training reports, and/or any other reports, described herein.

The central processing computer 10 also includes an output device 10I for output any data, information, report, etc., described herein. In the preferred embodiment, the output device 10I can be a printer, a display, a transmitter, a modem, and/or any other device which can be used to output data.

Any of the data and/or information for any of the students, individuals, education provider or education materials provider or education tools provider or education computer-enabled tools providers, payers, and/or intermediaries, can be updated by different parities and which such updated data and/or information being made available to other respective parties so as to provide and ensure comprehensive and up-to-date education and education related information.

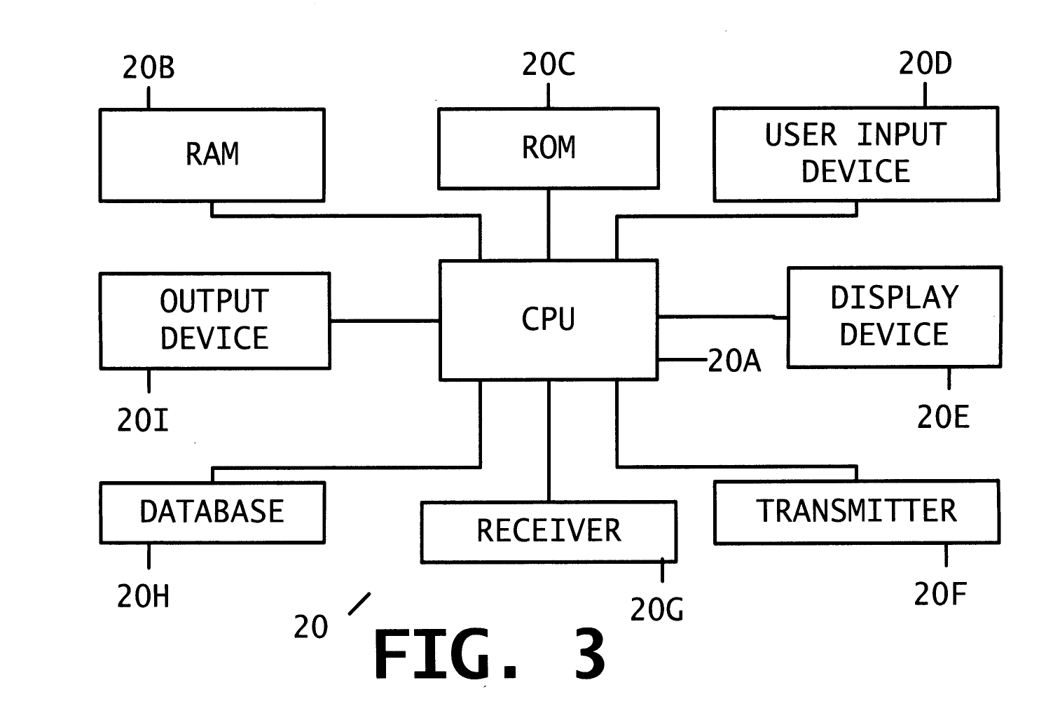

FIG. 3 illustrates the education provider or education materials provider or education tools provider or education computer-enabled tools provider communication device 20, in block diagram form. The education provider or education materials provider or education tools provider or education computer-enabled tools provider communication device 20, in the preferred embodiment, can be personal computer, a network computer or computer system, or any other computer or communication device, which is utilized as an education provider or education materials provider or education tools provider or education computer-enabled tools provider computer 20. In the preferred embodiment, the education provider or education materials provider or education tools provider or education computer-enabled tools provider communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The education provider or education materials provider or education tools provider or education computer-enabled tools provider communication device 20 also includes a random access memory device(s) 20B (RAM) and a read only memory device(s) 20C (ROM), each of which is connected to the CPU 20A, a user input device 20D, for entering data and/or commands into the education provider or education materials provider or education tools provider or education computer-enabled tools provider communication device 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering education data and/or information, for example pulse rate monitors, etc., if desired, which input device(s) are also connected to the CPU 20A.

The user input device 20D can also acquire, receive, generate and/or provide, data which can be entered by a user or individual and/or can be a device which can acquire, receive, generate and/or provide, digital data such as education or education related, education, biometric, physiological, and/or any other kind of education data and/or education related data. For example, a user input device 20D can be a keyboard for allowing a user to input information into the education provider or education materials provider or education tools provider or education computer-enabled tools provider communication device and/or a user input device can, for example, by a computer-based training device which can receive information from a student or individual and generate a digital signal, digital data, analog data, and/or any other signal, data, and/or information, which is representative of the student's or individual's test performance, biometric information related to the education activity, and/or physiological state related to the education activity.

The user input device 20D can also be, or can include, any one or more of, and/or any combination of, an educational materials analysis device or machine, a biometric sensor, a keyboard, a tablet computing device, a surface computing device, a touch-screen computing device, a camera, a microphone, an educational activity monitoring or measurement device, a radiotelemetric device, a doppler device, a carbon dioxide detection or measurement device, a heart rate measurement, monitoring device, a finger tip monitoring device, a behavior/psychological monitoring device, physiological data measuring device, breathalyzer device, camera probing device, microscopic camera probing device, and/or any other bio-metric or physiological data measuring device(s) and/or data acquisition device (hereinafter referred to generally or collectively as “education equipment input device”, “education measurement input device”, or “education monitoring input device”).

The education provider or education materials provider or education tools provider or education computer-enabled tools provider communication device 20 also includes a display device 20E for displaying data and/or information to a user or operator.

The education provider or education materials provider or education tools provider or education computer-enabled tools provider communication device 20 also includes a transmitter(s) 20F, for transmitting signals and/or data and/or information to any one or more of the central processing computer(s) 10, the education provider or education materials provider or education tools provider or education computer-enabled tools provider computer(s) 20, the payer computers(s) 30, the student computer(s) 40, and the intermediary computer(s) 50 individual computer(s), which may be utilized in conjunction with the present invention. The education provider or education materials provider or education tools provider or education computer-enabled tools provider communication device 20 also includes a receiver 20G, for receiving signals and/or data and/or information from any one or more of the central processing computer(s) 10, the education provider or education materials provider or education tools provider or education computer-enabled tools provider computer(s) 20, the payer computers(s) 30, the student computer(s) 40, and the intermediary computer(s) 50, which may be utilized in conjunction with the present invention.

The education provider or education materials provider or education tools provider or education computer-enabled tools provider communication device 20 also includes a database(s) 20H. The database 20H can contain and/or be linked to any of the data and/or information described herein as being stored in the database 10H.

The education provider or education materials provider or education tools provider or education computer-enabled tools provider communication device 20 also includes an output device 201 for output any data, information, report, etc., described herein. In the preferred embodiment, the output device 201 can be a printer, a display, a transmitter, a modem, an audio signal, a video signal, a text display, a digital display, and/or any other device which can be used to output data.

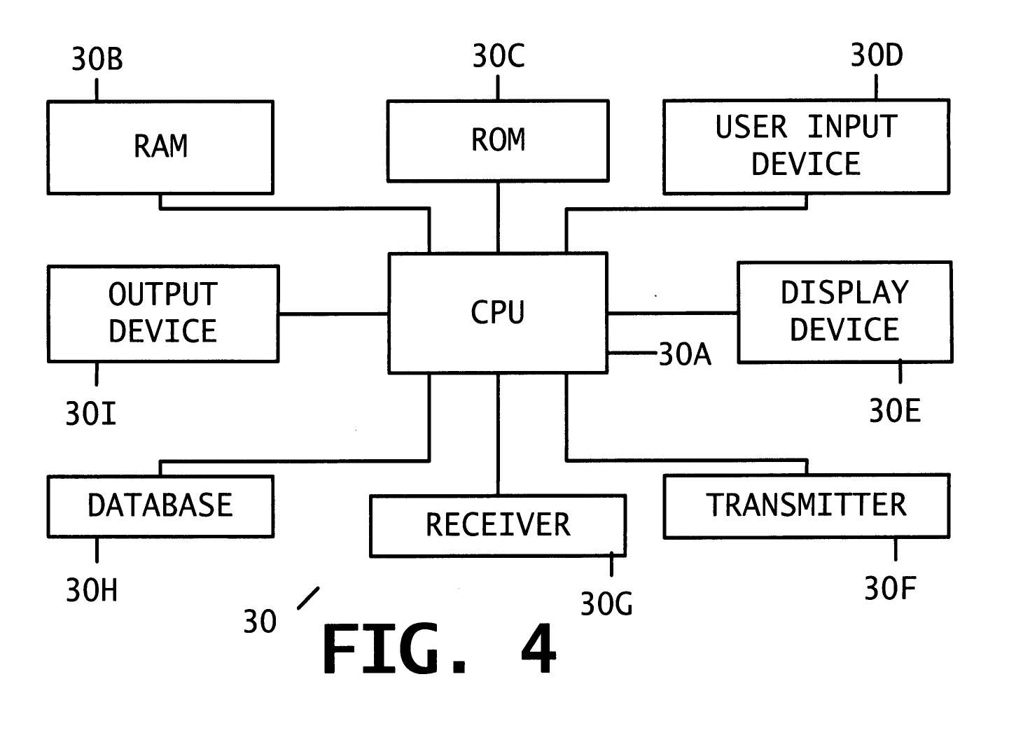

FIG. 4 illustrates the payer communication device 30, in block diagram form. The payer communication device 30, in the preferred embodiment, can be personal computer, a network computer or computer system, or any other computer or communication device, which is utilized as a payer computer 30. In the preferred embodiment, the payer communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The payer communication device 30 also includes a random access memory device(s) 30B (RAM) and a read only memory device(s) 30C (ROM), each of which is connected to the CPU 30A, a user input device 30D, for entering data and/or commands into the payer communication device 30, which includes any one or more of a keyboard, a scanner, a touch screen device, a motion device, a user pointing device, such as, for example, a mouse, a touch pad, and/or an audio input device and/or a video input device, and/or any device, electronic and/or otherwise which can be utilized for inputting and/or entering education data and/or information, for example pulse rate monitors, educational testing monitors, education assignment monitors, etc., if desired, which input device(s) are also connected to the CPU 30A. The payer communication device 30 also includes a display device 30E for displaying data and/or information to a user or operator.

The payer communication device 30 also includes a transmitter(s) 30F, for transmitting signals and/or data and/or information to any one or more of the central processing computer(s) 10, the education provider or education materials provider or education tools provider or education computer-enabled tools provider computer(s) 20, the payer computers(s) 30, the student computer(s) 40, and the intermediary computer(s) 50 individual computer(s), which may be utilized in conjunction with the present invention. The payer communication device 30 also includes a receiver 30G, for receiving signals and/or data and/or information from any one or more of the central processing computer(s) 10, the education provider or education materials provider or education tools provider or education computer-enabled tools provider computer(s) 20, the payer computers(s) 30, the student computer(s) 40, and the intermediary computer(s) 50, which may be utilized in conjunction with the present invention.

The payer communication device 30 also includes a database(s) 30H. The database 30H can contain and/or be linked to any of the data and/or information described herein as being stored in the database 10H.

The payer communication device 30 also includes an output device 301 for output any data, information, report, etc., described herein. In the preferred embodiment, the output device 301 can be a printer, a display, a transmitter, a modem, and/or any other device which can be used to output data.

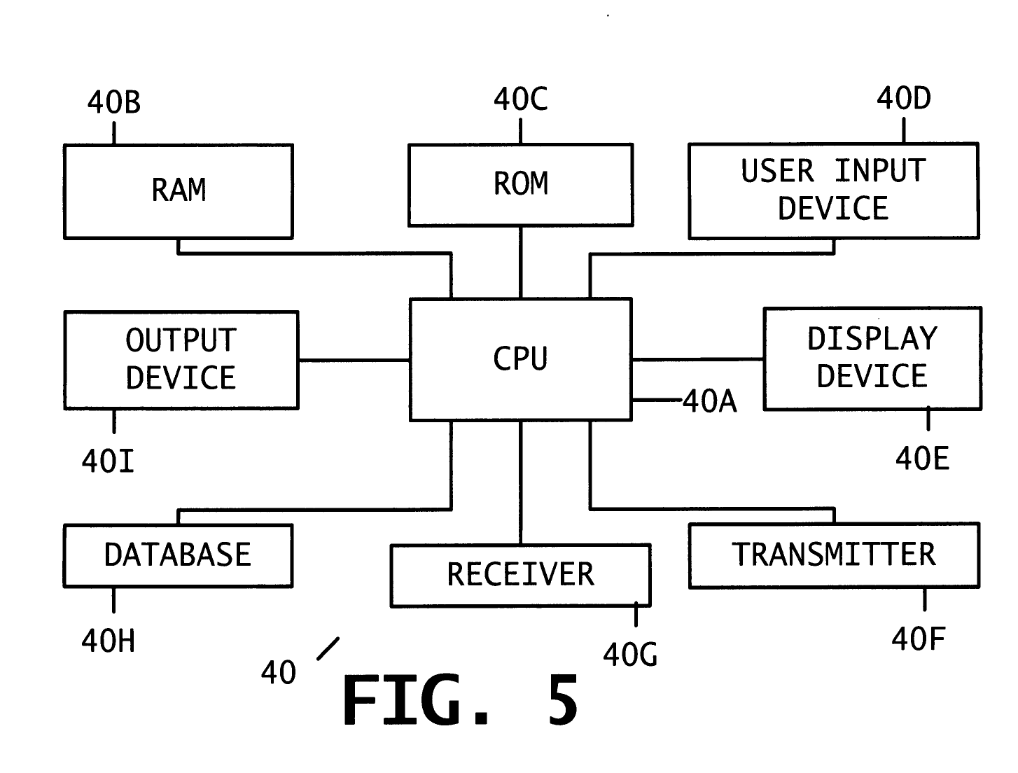

FIG. 5 illustrates the student communication device 40, in block diagram form. The student communication device 40, in the preferred embodiment, can be personal computer, a network computer or computer system, or any other computer or communication device, which is utilized as a student computer. In the preferred embodiment, the student communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The student communication device 40 also includes a random access memory device(s) 40B (RAM) and a read only memory device(s) 40C (ROM), each of which is connected to the CPU 40A, a user input device 40D, for entering data and/or commands into the student communication device 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering education data and/or information, for example an assignment completion and/or status, educational materials in use, testing materials or status and/or results, experiment materials and/or status and/or results, administrative status, procurement status, etc., if desired, which input device(s) are also connected to the CPU 40A.

The user input device 40D can also acquire, receive, generate and/or provide, data which can be entered by a user or individual and/or can be a device which can acquire, receive, generate and/or provide, digital data such as education or education related, education, bio-metric, physiological, and/or any other kind of education data and/or education related data. For example, a user input device 20D can be a keyboard for allowing a user to input information into the student communication device and/or a user input device can, for example, by an assignment or testing monitor machine, or institutional application process, which can receive information from a student or individual and generate a digital signal, digital data, analog data, and/or any other signal, data, and/or information, which is representative of the student's or individual's assignment completion and/or status, educational materials in use, testing materials or status and/or results, experiment materials and/or status and/or results, administrative and/or enrollment status.

The user input device 40D can also be, or can include, any one or more of, and/or any combination of, a keyboard, a scanner, a touch screen device, a motion device, a user pointing device, such as, for example, a mouse, a touch pad, and/or an audio input device and/or a video input device, and/or any device, electronic and/or otherwise which can be utilized for inputting and/or entering education data and/or information, and/or any other bio-metric or physiological data measuring device(s) and/or data acquisition device data acquisition device (hereinafter referred to generally or collectively as “education equipment input device”, “education measurement input device”, or “education monitoring input device”).

The student communication device 20 also includes a display device 40E for displaying data and/or information to a user or operator.

The student communication device 40 also includes a transmitter(s) 40F, for transmitting signals and/or data and/or information to any one or more of the central processing computer(s) 10, the education provider or education materials provider or education tools provider or education computer-enabled tools provider computer(s) 20, the payer computers(s) 30, the student computer(s) 40, and the intermediary computer(s) 50 individual computer(s), which may be utilized in conjunction with the present invention. The student communication device 40 also includes a receiver 40G, for receiving signals and/or data and/or information from any one or more of the central processing computer(s) 10, the education provider or education materials provider or education tools provider or education computer-enabled tools provider computer(s) 20, the payer computers(s) 30, the student computer(s) 40, and the intermediary computer(s) 50, which may be utilized in conjunction with the present invention.

The student communication device 40 also includes a database(s) 40H. The database 40H can contain and/or be linked to any of the data and/or information described herein as being stored in the database 10H.

The student communication device 40 also includes an output device 40I for output any data, information, report, etc., described herein. In the preferred embodiment, the output device 40I can be a printer, a display, a transmitter, a modem, and/or any other device which can be used to output data.

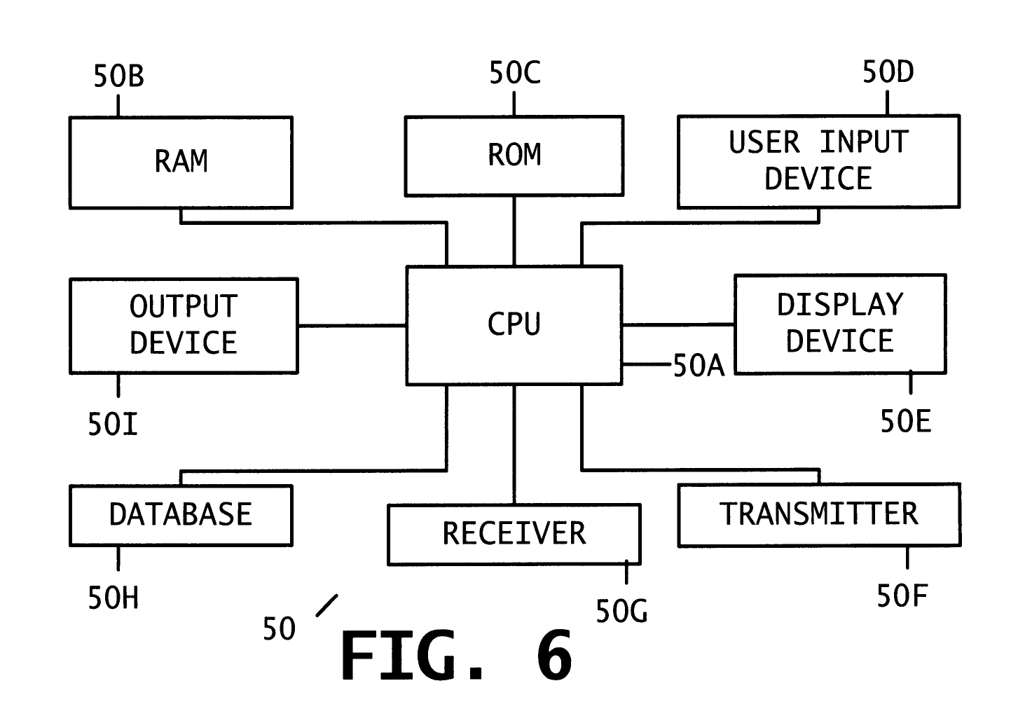

FIG. 6 illustrates the intermediary computer 50, in block diagram form. The intermediary computer 50, in the preferred embodiment, can be personal computer, a network computer or computer system, or any other computer or communication device, which is utilized as an intermediary computer 50. In the preferred embodiment, the intermediary computer 50 includes a central processing unit or CPU 50A, which in the preferred embodiment, is a microprocessor. The CPU 50A may also be a mobile computer, a microcomputer, a minicomputer, a personal computer, a macrocomputer, and/or a mainframe computer, depending upon the application.

The intermediary computer 50 also includes a random access memory device(s) 50B (RAM) and a read only memory device(s) 50C (ROM), each of which is connected to the CPU 50A, a user input device 50D, for entering data and/or commands into the intermediary computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering education data and/or information, for example pulse rate monitors, educational testing monitors, education assignment monitors, electrocardiograms, educational materials-sugars monitors, etc., if desired, which input device(s) are also connected to the CPU 50A. The intermediary computer 50 also includes a display device 50E for displaying data and/or information to a user or operator.

The intermediary computer 50 also includes a transmitter(s) 50F, for transmitting signals and/or data and/or information to any one or more of the central processing computer(s) 10, the education provider or education materials provider or education tools provider or education computer-enabled tools provider computer(s) 20, the payer computers(s) 30, the student computer(s) 40, and the intermediary computer(s) 50 individual computer(s), which may be utilized in conjunction with the present invention. The intermediary computer 50 also includes a receiver 50G, for receiving signals and/or data and/or information from any one or more of the central processing computer(s) 10, the education provider or education materials provider or education tools provider or education computer-enabled tools provider computer(s) 20, the payer computers(s) 30, the student computer(s) 40, and the intermediary computer(s) 50, which may be utilized in conjunction with the present invention.

The education provider or education materials provider or education tools provider or education computer-enabled tools provider communication device 50 also includes a database(s) 50H. The database 50H can contain and/or be linked to any of the data and/or information described herein as being stored in the database 10H.

The intermediary communication device 50 also includes an output device 50I for output any data, information, report, etc., described herein. In the preferred embodiment, the output device 50I can be a printer, a display, a transmitter, a modem, and/or any other device which can be used to output data.

In any and/or all of the embodiments described herein, any one of the central processing computers 10, the education provider or education materials provider or education tools provider or education computer-enabled tools provider communication devices 20, the payer communication devices 30, the student communication devices 40, and/or the intermediary communication devices 50, can include input devices (not shown) for facilitating the data entry of a student's vital signs and or other education or education related data such as, but not limited to, pulse rate, educational materials pressure, educational materials-sugar level, etc., and any other data and or information which can be input into the respective computer and/or communication device and be transmitted to the central processing computer consistent with the utilization of the present invention as described herein.

The apparatus and method of the present invention can be utilized in numerous preferred embodiments in order to provide a vast array of education and education related services for any one or more of the various parties described herein. While certain of the preferred embodiments may be described with regards to utilization by a particular party, it is important to note that any student, user, education provider or education materials provider or education tools provider or education computer-enabled tools provider, payer, and/or intermediary may utilize the present invention in the same, similar and/or analogous manner. For example, a preferred embodiment for determining and/or ascertaining an education or education related analysis can be described as being utilized by a treating physician as well as be utilized by an education provider or education materials provider or education tools provider or education computer-enabled tools provider to verify and/or check an analysis as well as by a student or other user or individual in order to perform a self-analysis or double check a educators analysis. In the same manner, any other preferred embodiment and/or other uses of the present invention can be utilized by any of the parties described herein.

The present invention, in its various preferred embodiments can be utilized to create and maintain comprehensive student databases which can be accessed via a network environment and/or otherwise, to perform education and/or education related assessments, to provide education and/or education related expected assessments, to provide education and/or education related academic lesson plans or programs, and/or to provide education and/or education related academic lesson progress reports and/or evaluations.

The present invention can also be utilized in order to provide training and continuing education services for education and/or education related professionals, to provide education, education related, and/or instructional information, to provide information about education and/or education related student, education provider or education materials provider or education tools provider or education computer-enabled tools providers, payers, and/or intermediaries, to provide scheduling management services for education provider or education materials provider or education tools provider or education computer-enabled tools providers, to provide notification services for students, education provider or education materials provider or education tools provider or education computer-enabled tools providers, payers and/or intermediaries and/or any other parties described herein, and/or to locate education provider or education materials provider or education tools provider or education computer-enabled tools providers, payers and/or intermediaries.

The present invention can also be utilized, in preferred embodiments, in order to education and/or education related request processing services, requests submissions, request processing, request status checking, and request reconciliation, request fraud prevention, academic lesson evaluation, education and/or education financing academic financing generation, management and administration, education provider or education materials provider or education tools provider or education computer-enabled tools provider, payer and/or intermediary evaluation, tutorial and/or academic lesson interactivity, academic lesson, instruction and/or education program availability and/or notification services, student, education provider or education materials provider or education tools provider or education computer-enabled tools provider, payer, intermediary, and/or third party, notification services.

The present invention can also be utilized as a clearinghouse for facilitating the offering, selling, buying, trading, and/or other commerce and/or transactions, involving education and/or education related services, products and/or goods.

In any and/or all of the embodiments described herein, the various computers and/or communication devices 10, 20, 30, 40 and/or 50, can be utilized to transmit and/or to receive transmissions, information, messages, and/or notification messages and/or signals to, and/or between, the respective parties associated with the respective computers and/or communication devices. The transmission of information, messages, and/or notification messages and/or signals, in any and/or all of the embodiments described herein can be effected via any one or more of e-mail messages, telephone messages, beeper or pager messages, physical mail delivery, electronic data transmission, and/or can be made via any other suitable and/or appropriate communication method and/or technique.

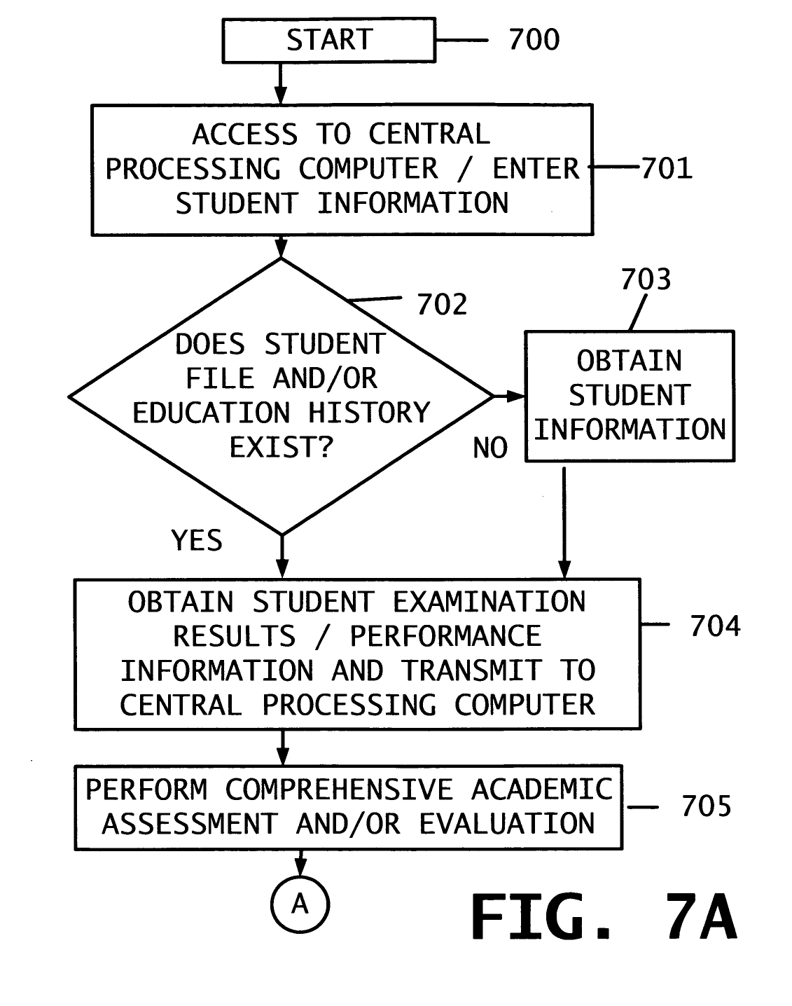

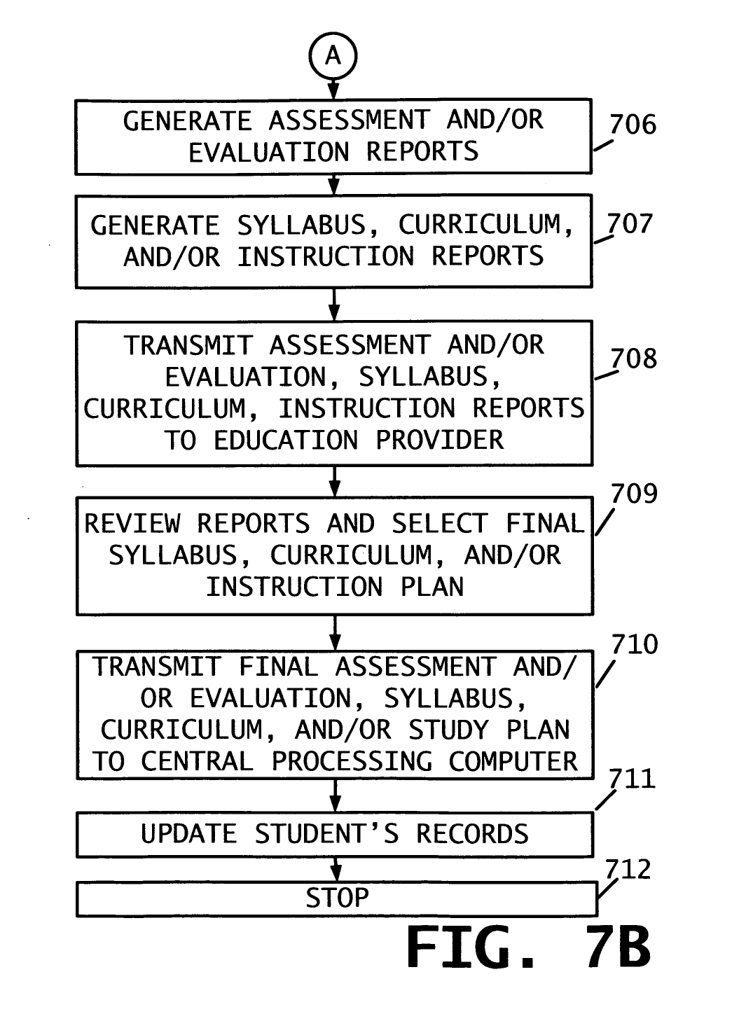

In a preferred embodiment, the present invention can be utilized in order to perform an analysis of an academic need and/or requirement, requirement and/or other condition. FIGS. 7A and 7B illustrate a preferred embodiment method of using the present invention, in block diagram form. While the method of FIGS. 7A and 7B is described in the context of an education or education related education products and education services providers, and education computing applications providers, and education technical solutions providers performing an analysis of an education or education related condition, the method of FIGS. 7A and 7B can be similarly utilized by instructors, psychologists, psychiatrists, dentists, and/or any other education provider or education materials provider or education tools provider or education computer-enabled tools provider or education professional described herein. The method of FIGS. 7A and 7B may also be utilized by any user, student, education provider or education materials provider or education tools provider or education computer-enabled tools provider, payer, and/or intermediary in order to ascertain an analysis and/or in order to check on, verify, and/or ascertain the correctness of an analysis of another.

The operation of the apparatus 100 commences at step 700. At step 701, the education provider or education materials provider or education tools provider or education computer-enabled tools provider can access the central processing computer 10 and enter data and/or information regarding the student. At step 702, the central processing computer 10 will determine if a file and/or education or education related history exists for the student. If, at step 702, it is determined that an education or education related history does not exist, the central processing computer 10 will, at step 703, request that an education or education related history, family history and/or other information related thereto be provided by the student or accompanying individual. At step 703, the information provided by the student or accompanying individual will then be entered via the education provider or education materials provider or education tools provider or education computer-enabled tools provider communication device 20 and transmitted to, and be stored at, the central processing computer 10. Thereafter, processing will proceed to step 704.

If, at step 702, it is determined that a student's education or education related history does in fact exist, the processing will proceed to step 704. At step 704, the student's evaluations, if any, and/or examination findings, are obtained from the student and are transmitted from the education provider or education materials provider or education tools provider or education computer-enabled tools provider communication device 20 to the central processing computer 10.

At step 704, data and/or information which can be obtained via any of the herein-described education equipment input devices 20D, education measurement input devices 20D, or education monitoring input devices 20D, can also be transmitted to the central processing computer 10. The data and/or information obtained via any of the described education equipment input devices 20D, education measurement input devices 20D, or education monitoring input devices 20D, can be transmitted from the education provider or education materials provider or education tools provider or education computer-enabled tools provider communication device 20 to the central processing computer 10.

In this manner, the data and/or information which is transmitted to the central processing computer 10, at step 704, can include education provider or education materials provider or education tools provider or education computer-enabled tools provider or user entered data and/or information, which can be entered via the user input device 20D such as a keyboard, a mouse, a card reader, or other input device which can be utilized in conjunction with a computer or a communication device, and/or can include data and/or information which can be obtained and/or acquired by any of the herein-described education equipment input devices 20D, education measurement input devices 20D, or education monitoring input devices 20D.

In a preferred embodiment, both education provider or education materials provider or education tools provider or education computer-enabled tools provider or user entered data and/or information obtained and/or acquired by any of the herein-described education equipment input devices 20D, education measurement input devices 20D, or education monitoring input devices 20D, can be utilized in performing a student analysis. In another preferred embodiment, only data and/or information obtained and/or acquired by any of the herein-described education equipment input devices 20D, education measurement input devices 20D, or education monitoring input devices 20D, can be utilized in performing a student analysis. In another preferred embodiment, only education provider or education materials provider or education tools provider or education computer-enabled tools provider or user entered data and/or information can be utilized in performing a student analysis.

The central processing computer 10 will, at step 705 receive and process the student evaluations, if any, examination findings, and/or any other data and/or information, in conjunction with the student's education or education related history and/or other information, education or education related theories, principles, criteria and/or other education or education related information needed to make an analysis. At step 705, the central processing computer 10 will perform a comprehensive analytical evaluation of the student's evaluations, if any, and/or the examination findings.

As described above, the analytical evaluation or analysis can be based upon both education provider or education materials provider or education tools provider or education computer-enabled tools provider or user entered data and/or information and data and/or information obtained or acquired by any of the herein-described education equipment input devices 20D, education measurement input devices 20D, or education monitoring input devices 20D, can be based upon only data and/or information obtained and/or acquired by any of the herein-described education equipment input devices 20D, education measurement input devices 20D, or education monitoring input devices 20D, or can be based upon only education provider or education materials provider or education tools provider or education computer-enabled tools provider or user entered data and/or information.

For example, an education provider or education materials provider or education tools provider or education computer-enabled tools provider can enter student evaluation information along with student data obtained from any of the herein-described education equipment input devices 20D, education measurement input devices 20D, or education monitoring input devices 20D. An analysis can, thereafter, be processed utilizing data obtained from both the education provider or education materials provider or education tools provider or education computer-enabled tools provider and any of the herein-described education equipment input devices 20D, education measurement input devices 20D, or education monitoring input devices 20D.

Student data can also be obtained solely from any of the herein-described education equipment input devices 20D, education measurement input devices 20D, or education monitoring input devices 20D, with such student data being utilized in order to arrive at an analysis. Student data, in another preferred embodiment, can also be obtained solely from an education provider or education materials provider or education tools provider or education computer-enabled tools provider or the student himself or herself. A student can also utilized the apparatus in conjunction with home education equipment input devices, education measurement input devices, or education monitoring input devices.

At step 706, the central processing computer 10 will generate a analytical report which can include an analysis of the student's condition, if needed. The analytical report which is generated at step 706 can, if needed, include a single analysis and/or a list of possible assessments, along with their respective probabilities of occurrence and/or statistical information corresponding thereto, which may pertain to the student's condition. At step 707, the central processing computer 10 will then generate an academic lesson report which will outline and/or recommend academic lesson for the single analysis and/or for the list of possible assessments, if any. The central processing computer 10, when generating the academic lesson report, can process same in conjunction with, and consider, possible tutorial interactions and/or academic lesson interactions.

At step 708, the central processing computer 10 will transmit the analytical report and/or academic lesson report to the education provider or education materials provider or education tools provider or education computer-enabled tools provider's communication device 20 at which point the education or education related education products and education services providers, and education computing applications providers, and education technical solutions providers can obtain the analysis or possible assessments, if any, and corresponding academic lesson plans. The education or education related education products and education services providers, and education computing applications providers, and education technical solutions providers can then, at step 709, review the analytical report and/or academic lesson report and choose a final analysis and/or academic lesson plan, if needed, to administer to the student.

At step 710, the education or education related education products and education services providers, and education computing applications providers, and education technical solutions providers will transmit the final analysis and academic lesson plan, including the recommended academic lesson and/or academic lesson plan, if any, to the central processing computer 10. At step 711, the central processing computer 10 will then update the student's records in the database 10H so as to include all of the data and information described as being processed and/or generated by the central processing computer 10, including, but not limited to the student's evaluations, if any, the examination findings, the information contained in the analytical report and the academic lesson report, the final analysis and the recommended academic lesson.

Thereafter, operation of the apparatus 100 will cease at step 712. The student's records will then be updated and be available for the student's next academic lesson and/or analysis.

In another preferred embodiment, the analytical report and/or academic lesson reports can be accompanied by education or education related information, textbook materials, laboratory materials, reference materials, video clips of any pertinent information, audio clips of any pertinent information, hyperlinks to informational sources, information regarding education provider or education materials provider or education tools provider or education computer-enabled tools providers and/or facilities for obtaining academic lesson and/or instruction, education provider or education materials provider or education tools provider or education computer-enabled tools provider and/or facility contact information, and/or any other pertinent and/or relevant information.

In another preferred embodiment, the analytical report and/or academic lesson reports can be accompanied by education and/or instructional information which can include suggestions for education and/or instructional foods, goods, products, and/or services. The analytical report and/or academic lesson reports can also be accompanied by education and/or fitness information, diets, nutritional information, and/or any other information which may be of assistance to the student and/or education provider or education materials provider or education tools provider or education computer-enabled tools provider. The analytical and/or academic lesson reports can also contain warnings regarding misassessments, warnings about academic lessons, information about experimental academic lessons, etc. The analytical and/or academic lesson reports can also contain information, statistical and/or otherwise, regarding assessments, misassessments, academic lesson successes, and/or academic lesson failures. The analytical and/or academic lesson reports can also contain information regarding alternate education such as academic lessons regarding herbal remedies and/or academic lessons, meditation, self-healing, faith healing, yoga, tai chi, exercise instruction, and/or other therapies and/or instruction types.

As noted above, the method of utilizing the present invention, as described in FIGS. 7A and 7B, is equally applicable to, and can be utilized in the same manner, by any and/or all of the respective education provider or education materials provider or education tools provider or education computer-enabled tools providers, professionals, and/or related education provider or education materials provider or education tools provider or education computer-enabled tools providers. The apparatus of FIGS. 7A and 7B can also be utilized in a same or similar manner by any of the herein-described users, students, education provider or education materials provider or education tools provider or education computer-enabled tools providers, or education payers.

The apparatus of FIGS. 7A and 7B can also utilize electronic signatures and/or process electronic signatures and/or electronic signature information which can correspond to any of the herein-described parties in performing any of the herein-described processing routines and/or functions.

In another preferred embodiment, the apparatus and method of the present invention can be utilized to ensure that a proper academic lesson and/or instruction is performed for the student. Referring once again to FIGS. 7A and 7B and the above description of same, the present invention can be utilized to ensure that a subsequent academic lesson and/or academic lessons are performed as recommended. As noted above with reference to FIG. 6 and, in particular, a final analysis and recommended academic lesson is stored in the student's file or records in the database 10H of the central processing computer.

When the student seeks academic lesson from a subsequent education or education related education products and education services providers, and education computing applications providers, and education technical solutions providers, instructor, or other education professional, the education or education related education products and education services providers, and education computing applications providers, and education technical solutions providers, instructor, or other education professional, can access the central processing computer 10 at the time of academic lesson, access the student's education or education related history and recommended academic lesson plan and assess same in order to make sure that the academic lesson to be provided is called for in the recommended academic lesson. In this manner, the present invention can be utilized in order to prevent education or education related and/or instructional mistakes, mishaps and/or other instances when improper academic lesson could occur.

It is also envisioned that the subsequent service or resource education or education related education products and education services providers, and education computing applications providers, and education technical solutions providers, instructor, or other education professional, could also re-evaluate the student's condition and/or records and seek additional assistance and/or perform a separate and independent assessment and/or analysis of the student. In any event, the present invention can provide the subsequent service or resource education or education related education products and education services providers, and education computing applications providers, and education technical solutions providers, instructor, or other education professional, with the student's complete education or education related history, information, past assessments and/or past academic lessons and/or prescriptions. In this manner, a subsequent service or resource education provider or education materials provider or education tools provider or education computer-enabled tools provider can be provided with as complete and as up to date information as possible in order to administer academic lesson.

For example, the present invention can be utilized in the following manner. A student scheduled for instruction on a certain part (i.e. left ankle) may enter the educational institution. Due to an educational institution clerical error, the right ankle is noted to be operated on.

Prior to the instruction, the instructor may access the central processing computer 10, via an education provider or education materials provider or education tools provider or education computer-enabled tools provider communication device 20 located in the operating room, and/or another location in the educational institution, in order to verify the instruction to be performed. In response thereto, the central processing computer 10 will transmit a message that it is the left ankle which is to be operated on. Thereafter, the instructor can investigate the situation and ensure that the correct and recommended instruction and/or instruction is performed. Once the instruction is completed, the student's record will be updated accordingly. While an instructional instruction is described, it is important to note that any academic lesson, instruction, etc., which can be performed by any education professional described herein, and/or in any education field described herein, can be verified in the above-described manner. In this manner, the present invention can be utilized to pre-screen subsequent and/or follow-up academic lessons and/or instructions so as to prevent education mistakes and/or mishaps.

The embodiment of FIGS. 7A and 7B can perform assessments by utilizing entered data and/or information and/or data and/or information which can be obtained by, acquired by, and/or measured by, any of the herein-described user input devices 20D.

In another preferred embodiment, the education professional can access the central processing computer 10 via the education provider or education materials provider or education tools provider or education computer-enabled tools provider communication device 20, access the student's or administrator's record and input information concerning the academic lesson and/or instruction to be performed. Thereafter, the central processing computer 10 can process the information and transmit a message to the education professional notifying the education professional that the academic lesson and/or instruction is either the recommended academic lesson or instruction or that it is not the recommended academic lesson and/or instruction. The message provided by the central processing computer, to the treating education professional, can also include information regarding the academic lesson and/or the instruction, such as lessons, steps, and/or any other accompanying information.

In any and/or all of the embodiments described herein, the central processing computer 10, in performing any processing of student information, analysis information, and/or academic lesson information, described herein, can perform such processing in conjunction with tutorial and/or other academic lesson interaction information so as to provide an added safeguard in the analysis and academic lesson planning processes. Any and/or all processing described herein is also performed in conjunction with each student's education or education related history, family history, personal conditions information, and/or with any other information deemed important and/or essential in the individual's education assessments and/or academic lessons.

In another preferred embodiment, the present invention can be utilized to perform academic lesson evaluations and/or academic lesson monitoring. In this manner, the present invention can be utilized by any of the education provider or education materials provider or education tools provider or education computer-enabled tools providers, payers, students, users, and/or intermediaries, described herein to evaluate and/or monitor academic lessons, provide training and/or oversight for education provider or education materials provider or education tools provider or education computer-enabled tools providers and/or professionals, and/or allow payer and/or academic financing entities and individual entities and individuals to evaluate academic lessons, academic lesson plans, syllabi, curricula, academic lesson progress, and/or any other evaluations and/or verifications for education requests processing. In this embodiment, the present invention can be utilized so as to safeguard against the use of incorrect and/or unconventional and/or fraudulent academic lesson and/or service or resource.

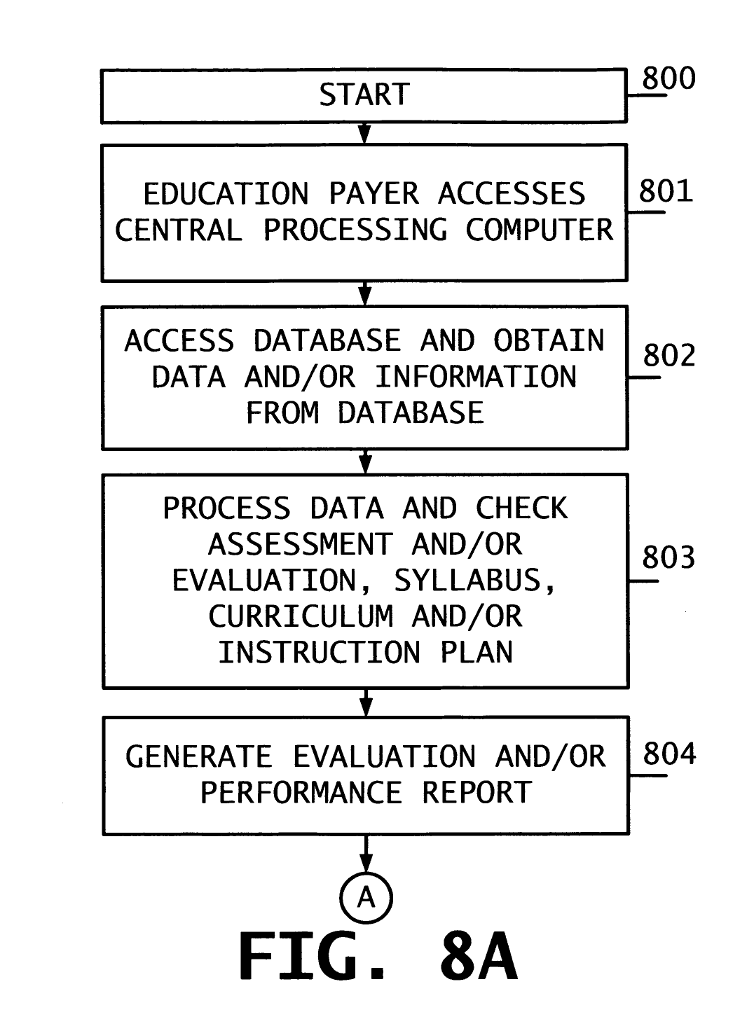

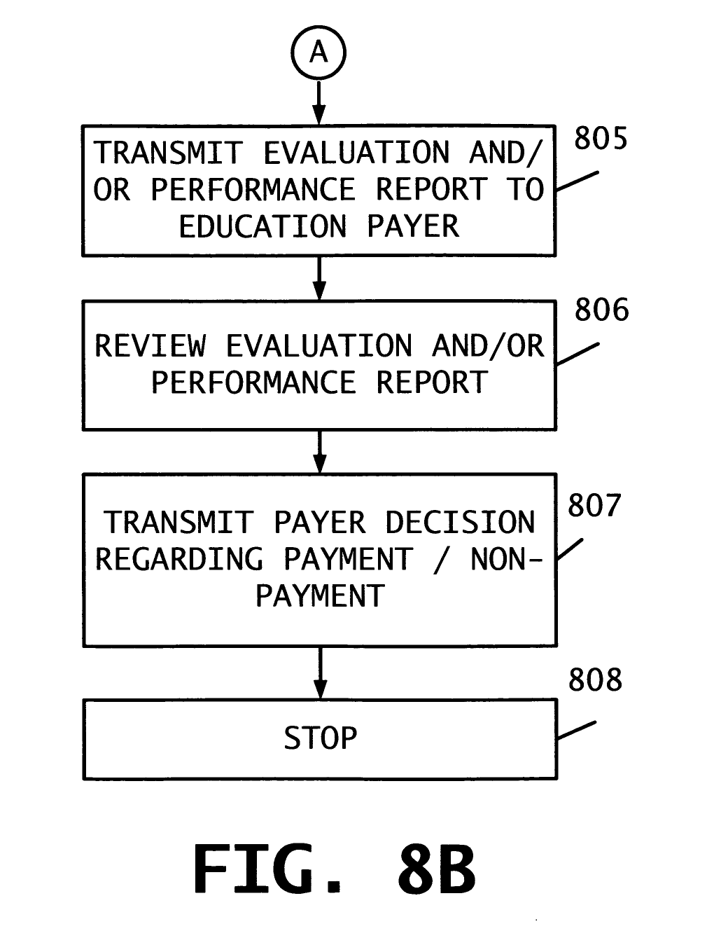

FIGS. 8A and 8B illustrate another preferred embodiment of a method of use of the present invention, in flow diagram form. FIGS. 8A and 8B illustrate a preferred embodiment method of use of the present invention in order to evaluate and/or monitor academic lessons, academic lesson plans and/or the administration of education. While described as being utilized by payers and/or an financing company in evaluating and/or monitoring academic lesson, it is important to note that the embodiment of FIGS. 8A and 8B can be utilized by any education provider or education materials provider or education tools provider or education computer-enabled tools provider, student, user, including education students and/or education professionals-in-training, or other education provider or education materials provider or education tools provider or education computer-enabled tools providers, and/or intermediary, for obtaining the information provided by the embodiment of FIGS. 8A and 8B and utilizing it any manner they see fit.

With reference to FIGS. 8A and 8B, the operation of the apparatus 100 commences at step 800. At step 801, the payer or payer's employee or agent (hereinafter, for simplicity, referred to at payer's employee) can access the central processing computer 10. At step the payer's employee can enter information concerning the student, the academic lesson, and/or service or resource, which is desired to be evaluated and/or monitored.

At step 802, the central processing computer 10 will access the database 10H and obtain student information, student education or education related history, family history, if pertinent, evaluation information, education provider or education materials provider or education tools provider or education computer-enabled tools provider information, analytical report information, academic lesson report information, final assessments information, recommended academic lesson information, and/or any other information which can be relevant and/or pertinent. Any and/or all of the information described above can be stored in the database 10H from prior processing and/or use of the present invention. Other data and/or information can also be obtained from the payer's employee and/or from other third party and/or outside sources.

At step 803, the central processing computer 10 will perform a processing routine in conjunction with the above-described information in order to determine if the assessments and associated and/or related academic lesson or academic lessons are appropriate and/or in-line with current standards for the given education field. The central processing computer 10 can also calculate and/or provide statistical information regarding any of assessments and/or academic lessons under study. At step 804, the central processing computer 10 will generate an evaluation report which will provide data and information regarding the information obtained from step 803.

The central processing computer 10 can then, at step 805, transmit the evaluation report and/or any other appropriate information, to the payer communication device 30. The central processing computer, in another preferred embodiment, can, at step 803 and/or at step 804, determine and/or provide, as part of the evaluation report, information concerning whether the assessments and/or academic lessons are considered appropriate and/or valid, and/or in-line with standards, as well as recommend that requests for the academic lesson(s) are valid and should be paid by the payer, and/or that the requests for the academic lesson(s) are invalid and should be denied.

Thereafter, at step 806, the payer or the payer's employee can review the evaluation report and take any action deemed appropriate. At step 807, the payer or payer's employee can transmit data and/or information regarding the payer's or payer employee's action and/or decision. Step 807 is an optional step and can be dispensed with if the payer or payer's employee chooses not to respond to and/or to transmit information to, the central processing computer 10. Thereafter, the operation of the apparatus will cease at step 808.

The apparatus of FIGS. 8A and 8B can also utilize electronic signatures and/or process electronic signatures and/or electronic signature information which can correspond to any of the herein-described parties in performing any of the herein-described processing routines and/or functions.

The present invention when utilized as described in FIGS. 8A and 8B, can provide academic lesson evaluation and/or monitoring for education payers which can be utilized for performing requests processing, education provider or education materials provider or education tools provider or education computer-enabled tools provider evaluations, student evaluations, and/or any other useful and/or desired purpose. The present invention, when utilized as described in FIGS. 8A and 8B, can also be utilized by any education provider or education materials provider or education tools provider or education computer-enabled tools provider, student, payer, user, and/or intermediary, to evaluate and/or monitor academic lessons, evaluate education provider or education materials provider or education tools provider or education computer-enabled tools providers, evaluate students, evaluate payers, ascertain payers requests paying and/or processing traits, and/or for educational purposes and/or for any other useful and/or desired purpose.

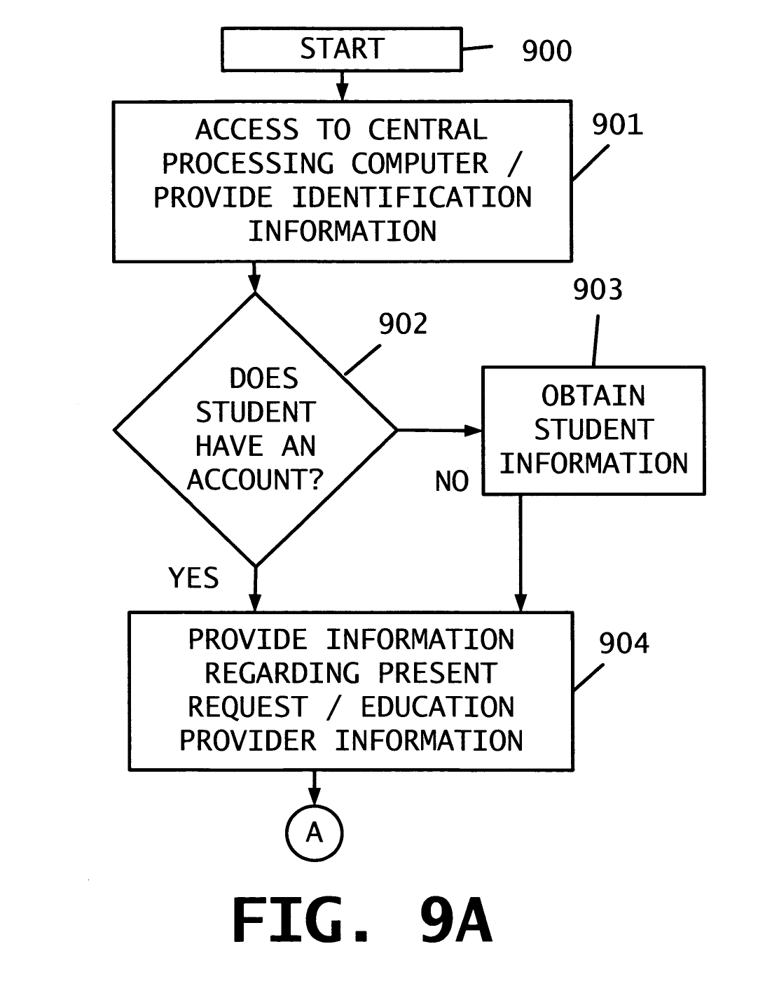

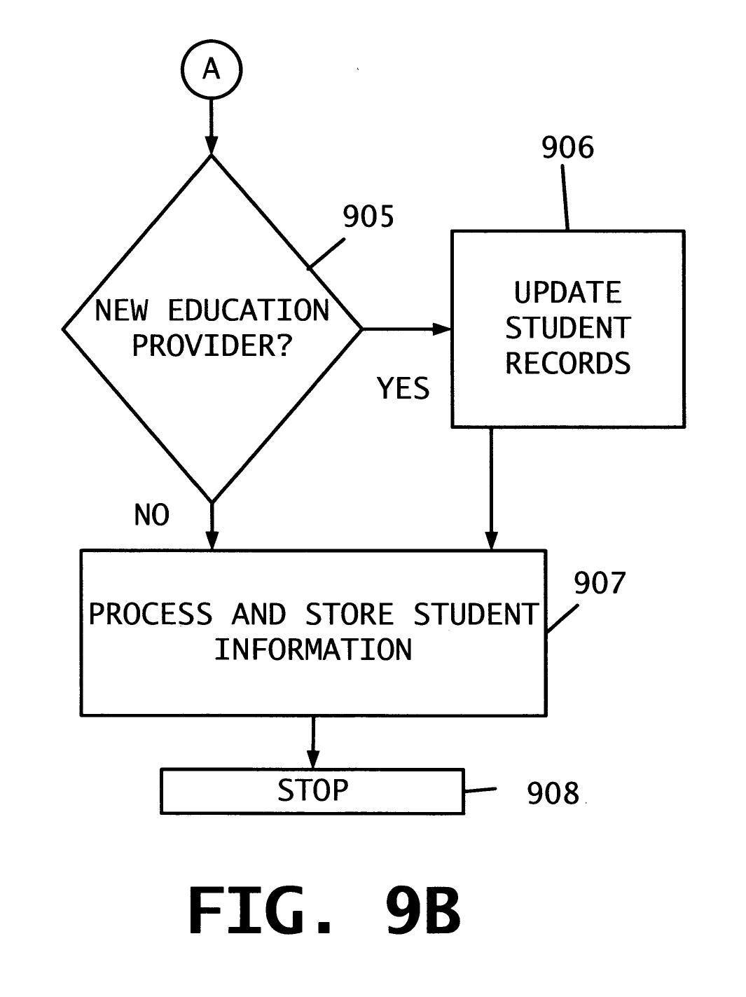

In another preferred embodiment of the present invention, the apparatus and method of the present invention can be utilized to create and maintain a comprehensive student education database. FIGS. 9A and 9B illustrate another preferred embodiment use of the present invention, in flow diagram form. With reference to FIGS. 9A and 9B, the operation of the apparatus 100 commences at step 900.

At step 901, the student will access the central processing computer 10 and provide identification information. At step 902, the central processing computer 10 will determine whether the student has an account and/or a file with the central processing computer and/or the service utilizing same. If, at step 902, it is determined that the student does not have an account with the central processing computer 10, the processing will proceed to step 903 and student will be prompted and/or asked to fill out any necessary forms and/or answer questions so as to provide a comprehensive education or education related history and family history, if possible.

All provided data and/or information will be stored in the database 10H and a student account, file and/or record will be created at step 903. Thereafter, processing will proceed to step 904. If, at step 902, the student is determined to have an account with the central processing computer, processing will proceed directly to step 904.

At step 904, the student will provide information concerning the present education request and present education provider or education materials provider or education tools provider or education computer-enabled tools provider information. At step 905, the central processing computer 10, will then determine if the present education provider or education materials provider or education tools provider or education computer-enabled tools provider is a new education provider or education materials provider or education tools provider or education computer-enabled tools provider. If, at step 905, it is determined that the present education provider or education materials provider or education tools provider or education computer-enabled tools provider is a new education provider or education materials provider or education tools provider or education computer-enabled tools provider, the central processing computer 10 will proceed to step 906 and update the student's files or records so as to include the present education provider or education materials provider or education tools provider or education computer-enabled tools provider as a new education provider or education materials provider or education tools provider or education computer-enabled tools provider for the student. Thereafter, the central processing computer 10 will proceed to step 907 and will process and store, in the database 10H and/or in the student's files or records, any pertinent student information, evaluations, assessments and/or academic lessons, final analysis and/or recommended academic lesson, for the education provider or education materials provider or education tools provider or education computer-enabled tools provider visit or for the event or occurrence.

If, however, at step 905, it is determined that the present education provider or education materials provider or education tools provider or education computer-enabled tools provider is an existing education provider or education materials provider or education tools provider or education computer-enabled tools provider for the student, the central processing computer 10 will proceed directly to step 907 and process and store, in the database 10H and/or in the student's files or records, any pertinent student information, evaluations, assessments and/or academic lessons, final analysis and/or recommended academic lesson, for the education provider or education materials provider or education tools provider or education computer-enabled tools provider visit or for the event or occurrence. Thereafter, operation of the present invention will cease at step 908.

The apparatus of FIGS. 9A and 9B can also utilize electronic signatures and/or process electronic signatures and/or electronic signature information which can correspond to any of the herein-described parties in performing any of the herein-described processing routines and/or functions.

In this manner, the present invention can be utilized so as to create and maintain a comprehensive education student database which can be accessed by any education provider or education materials provider or education tools provider or education computer-enabled tools provider, payer, intermediary, and/or other party or user, in order to access the student's education files and/or records. The comprehensive database, which in the preferred embodiment of the present invention, is stored and/or maintained in the database 10H of the central processing computer 10, can contain and/or store any of the data and/or information obtained from, and/or provided by, any and/or all of the herein-described embodiments of the present invention.

The comprehensive database provides a data and/or information source which can be accessed by any education provider or education materials provider or education tools provider or education computer-enabled tools provider, from anywhere in the world, and at any time, in order to obtain information about a student in his, her, or its service or resource. For example, a student traveling far from home and out of reach by his or her current education provider or education materials provider or education tools provider or education computer-enabled tools provider can be treated by another education provider or education materials provider or education tools provider or education computer-enabled tools provider who can access the central processing computer 10, from any location, and at any time, and obtain up-to-date and/or comprehensive student education and/or education or education related and family history information, current education and/or education or education related condition, current academic lesson and/or service or resource and/or any other information which can facilitate optimal education and/or education or education related academic lesson.

In the same manner, new education provider or education materials provider or education tools provider or education computer-enabled tools providers can obtain existing information concerning education and/or education or education related history, family history, current education conditions and/or academic lessons as well as any other information from the central processing computer 10 thereby allowing the new education provider or education materials provider or education tools provider or education computer-enabled tools provider to obtain accurate information and dispensing with the need to obtain same form the student. The information provided from the present invention can also assist the education provider or education materials provider or education tools provider or education computer-enabled tools provider in planning the student. Education provider or education materials provider or education tools provider or education computer-enabled tools providers can also utilize the comprehensive database in order to ascertain past and/or current education provider or education materials provider or education tools provider or education computer-enabled tools providers who may be contacted for assistance and/or for insight in the academic lesson process.

In a similar manner, payers can utilize the comprehensive database in order to ascertain payer eligibility, the existence of special considerations and/or to obtain any other useful information.

In another preferred embodiment, the present invention can be utilized in order to find and/or to locate education provider or education materials provider or education tools provider or education computer-enabled tools providers and/or payers of, and for, respectively, various education academic lessons, education services and/or education goods or products and/or education related goods or products. Information regarding the various education provider or education materials provider or education tools provider or education computer-enabled tools providers and/or payers, along with information regarding the services and/or goods or products they provide and/or pay for, respectively, is stored in the database 10H.

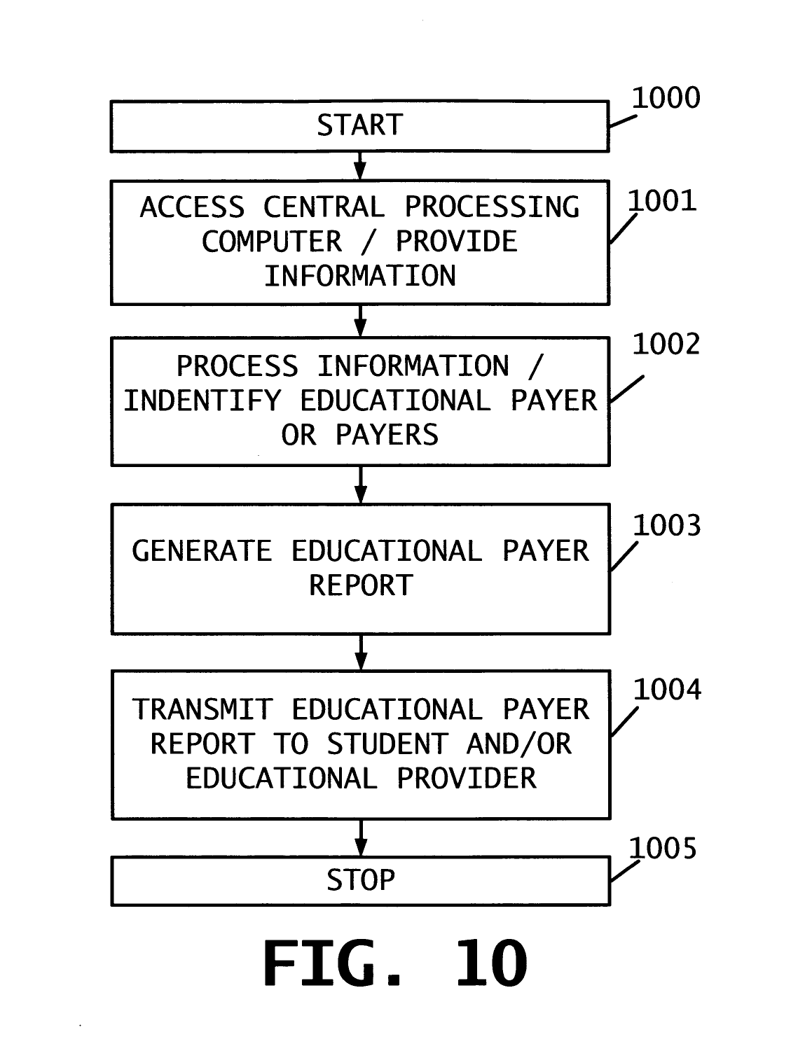

FIG. 10 illustrates another preferred embodiment method of utilizing the present invention. In the embodiment of FIG. 10, the present invention can be utilized by any student, user, education provider or education materials provider or education tools provider or education computer-enabled tools provider, payer, and/or intermediary, in order to locate an education provider or education materials provider or education tools provider or education computer-enabled tools provider and/or a payer of education and/or education related services, goods, or products. For example, assume that a student has been recently diagnosed as needing an operation to repair his vision. The student or his education provider or education materials provider or education tools provider or education computer-enabled tools provider would need to find an education products and education services providers, and education computing applications providers, and education technical solutions providers who specializes in performing the needed instructional instruction. The present invention can thereafter be utilized to locate a specialist for performing that function.

With reference to FIG. 10, operation of the apparatus 100 commences at step 1000. At step 1001, the student or education provider or education materials provider or education tools provider or education computer-enabled tools provider accesses that central processing computer 10 and provides information regarding the service needed. At step 1002, the central processing computer 10 will process the request and identify one or more specialists along with their backgrounds, financing education financing accepted, fees, and/or any educational, professional experience and/or any other information about the education provider or education materials provider or education tools provider or education computer-enabled tools provider. At step 1003, the central processing computer 10 can generate an education provider or education materials provider or education tools provider or education computer-enabled tools provider report and transmit same to the student or education provider or education materials provider or education tools provider or education computer-enabled tools provider at step 1004. Thereafter, operation of the apparatus ceases at step 1005.

In a similar manner, the embodiment of FIG. 10 can be utilized to find a facility for receiving a certain and/or desired form of service or resource and/or for obtaining a certain instruction. In this embodiment, the facility is defined to be the education provider or education materials provider or education tools provider or education computer-enabled tools provider and the present invention can be utilized as described above.

In another similar manner, the embodiment of FIG. 10 can be utilized to find a payer or financing company for providing desired education financing and/or for paying for certain academic lessons and/or instructions. In the case of locating payers, the method of FIG. 10 can be repeated for locating payers for certain education services, goods or products.

At step 1001, the student or education provider or education materials provider or education tools provider or education computer-enabled tools provider accesses that central processing computer 10 and provides information regarding the education financing needed. At step 1002, the central processing computer 10 will process the request and identify one or more payers along with information about the payer or payers. At step 1003, the central processing computer 10 can generate a payer report and transmit same to the student or education provider or education materials provider or education tools provider or education computer-enabled tools provider at step 1004. Thereafter, operation of the apparatus ceases at step 1005.

In another similar manner, the embodiment of FIG. 10 can be utilized to find and/or locate supplies, instructional supplies, educational materials, educational content, and/or any other goods, products, and/or supplies, etc. In this embodiment, the identification, location, cost, etc., of any of the above goods, products, supplies, education programs etc., can be stored in the database 10H.

With reference to FIG. 10, operation of the apparatus 100 commences at step 1000. At step 1001, the student or education provider or education materials provider or education tools provider or education computer-enabled tools provider accesses that central processing computer 10 and provides information regarding the supply, education program, educational materials, instruction, and/or any other good, product, or supply or supplies needed.

At step 1002, the central processing computer 10 will process the request and identify the existence and/or location of the respective supply, education program, educational materials, instruction, and/or any other good, product, or supply or supplies, along with its location, cost and any other pertinent information. At step 1003, the central processing computer 10 can generate a report and transmit same to the student or education provider or education materials provider or education tools provider or education computer-enabled tools provider at step 1004. Thereafter, operation of the apparatus ceases at step 1005.

In another similar manner, the embodiment of FIG. 10 can be utilized to find a payer or financing company for providing desired education financing and/or for paying for certain academic lessons and/or instructions. In the case of locating payers, the method of FIG. 10 can be repeated for locating payers for certain education services, goods or products. At step 1001, the student or education provider or education materials provider or education tools provider or education computer-enabled tools provider accesses that central processing computer 10 and provides information regarding the education financing needed. At step 1002, the central processing computer 10 will process the request and identify one or more payers along with information about the payer or payers. At step 1003, the central processing computer 10 can generate a payer report and transmit same to the student or education provider or education materials provider or education tools provider or education computer-enabled tools provider at step 1004. Thereafter, operation of the apparatus ceases at step 1005.

The embodiment of FIG. 10 can also be utilized by intermediaries, such as financing brokers who need to find certain academic financing entities and individual entities and individuals and/or payers who meet the needs of certain students and/or administrators, and/or other individuals and/or third parties.

In another preferred embodiment of FIG. 10, any student, user, education provider or education materials provider or education tools provider or education computer-enabled tools provider, payer, and/or intermediary can request to be notified of the availability of an education provider or education materials provider or education tools provider or education computer-enabled tools provider, the emergence of a student in need of a certain service or resource, the availability of a payer or an financing company to offer an academic financing or a certain academic financing, the availability of an education facility to provide certain service or resource, the availability of certain supplies, an educational resource, supply, information, material, content, and/or data, an expiration of an financing academic financing (i.e. education financing, educational instruction, education management, etc.,) and/or the occurrence of any event which may be of interest to any of the students, users, education provider or education materials provider or education tools provider or education computer-enabled tools providers, payers, and/or intermediaries, described herein.

In this embodiment, the party requesting to be notified of the event or occurrence, whichever it may be, (hereinafter the “requesting party”), can access the central processing computer 10 via their respective communication device. Thereafter, the requesting party can enter his request, provide any conditions attached to the request, and provide contact information. The central processing computer 10 can process the information received from the requesting party and store all pertinent information in the database 10H. Thereafter, another party (hereinafter the “supplying party”) contacts the central processing computer 10, either to enter information about the occurrence of an event and/or the availability of a service, a good or products, and/or any other herein-described and/or envisioned occurrence and/or good, product and/or service availability, or to review requests which have been previously submitted, which the supplying party may be interested in responding to.

If the entry of the supplying party can satisfy a request of a requesting party, and/or if the supplying party desires to satisfy a request of a requesting party, the central processing computer 10 will generate and/or transmit an e-mail message, a beeper or pager message, and/or a telephone call, and/or other communication to the communication device of the requesting party.

The communication or message can include information for bring the requesting party and the supplying party together to act towards effecting and/or consummating the transaction. Thereafter, upon notification to the central processing computer 10 by either the requesting party and/or the supplying party, or both, the central processing computer 10 can remove the request from the database 10H. In this manner, the central processing computer 10 and/or the apparatus 100 can be utilized as a clearinghouse for effecting transactions for any of the services, goods, products, and/or any other entities described herein.

In another preferred embodiment, the present invention can be utilized to schedule appointments with any of the students, education provider or education materials provider or education tools provider or education computer-enabled tools providers, payers, and/or intermediaries, described herein. In this manner, for example, can make an appointment with the education provider or education materials provider or education tools provider or education computer-enabled tools provider over the communication network which services the present invention.

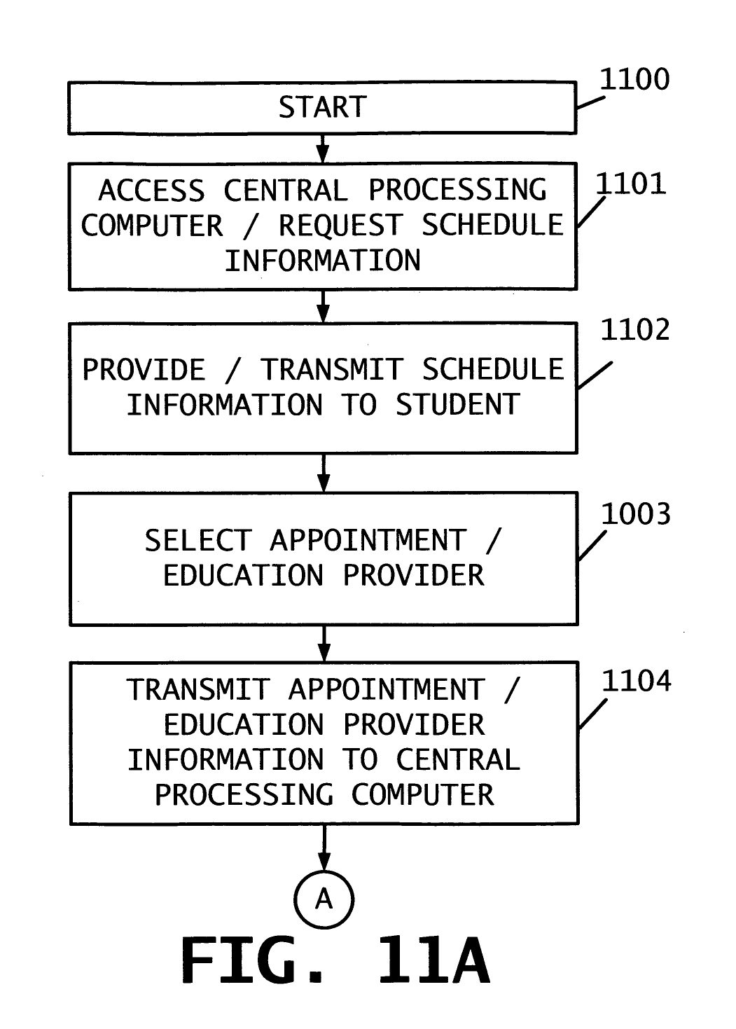

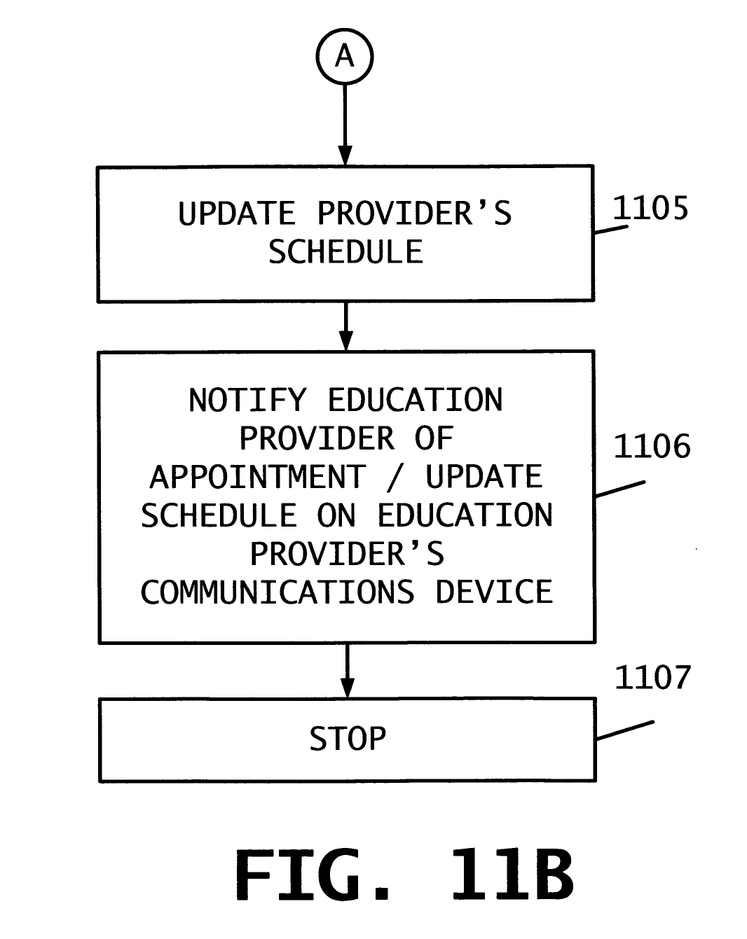

FIGS. 11A and 11B illustrate another preferred embodiment method of using the present invention, in flow diagram form. In the embodiment of FIGS. 11A and 11B, education provider or education materials provider or education tools provider or education computer-enabled tools provider scheduling information can be stored in the database 10H. Operation of the apparatus 100 commences at step 1100. At step 1101, the student accesses the central processing computer 10 and requests the schedule or schedules of an education provider or education materials provider or education tools provider or education computer-enabled tools provider or a number of education provider or education materials provider or education tools provider or education computer-enabled tools providers. At step 1102, the central processing computer 10 provides the schedule information to the student. At step 1103, the student can select the appointment he or she wishes to make.

At step 1104, the appointment information is transmitted to and received at the central processing computer 10. At step 1105, the central processing computer 10 will update the education provider or education materials provider or education tools provider or education computer-enabled tools provider's schedule to reflect the new appointment. At step 1106, the central processing computer 10 will transmit a signal, such as an e-mail and/or other transmission and/or communication to education provider or education materials provider or education tools provider or education computer-enabled tools provider communication device 20 to notify the education provider or education materials provider or education tools provider or education computer-enabled tools provider and to update the education provider or education materials provider or education tools provider or education computer-enabled tools providers schedule on the education provider or education materials provider or education tools provider or education computer-enabled tools provider computer 20. In the preferred embodiment, the scheduling files stored on the database 10H of the central processing computer 10 and the database 20H on the education provider or education materials provider or education tools provider or education computer-enabled tools provider communication device 20, and/or any portions and/or fields, or records, of same, can be dynamically linked to one another so that changes made to the schedule or schedules by either the central processing computer and/or on the education provider or education materials provider or education tools provider or education computer-enabled tools provider communication device will be reflected in real-time so as to ensure that the most up-to-date schedules are available at all times.

Operation of the apparatus 100 will thereafter cease at step 1107. In another preferred embodiment, the central processing computer and/or the education provider or education materials provider or education tools provider or education computer-enabled tools provider communication device can generate and/or transmit an e-mail to the student communication device 40 in order to confirm the appointment and/or to serve as a reminder to the student.

In the same manner, any student, user, education provider or education materials provider or education tools provider or education computer-enabled tools provider, payer, and/or intermediary can utilize the preferred embodiment of FIGS. 11A and 11B in order to schedule an appointment with any other student, user, education provider or education materials provider or education tools provider or education computer-enabled tools provider, payer, and/or intermediary, described herein.

In another preferred embodiment, the present invention can be utilized by intermediaries, such as, but not limited to brokers, financing brokers, agents, and others, in order to service their respective administrators. For example, the database 10H can contain financing academic financing information, conditions, premiums, financially responsible party or financial record keeping parties providing same, as well as any other useful information in servicing student's needs. The database 10H can also contain administrator information, academic financing requirements for any of the education financing, educational instruction, and/or education management, academic offerings in force for the insured along with premiums paid and/or expiration dates.

In another preferred embodiment, a broker, for example can prepare offers of enrollment, compare available academic offerings, generate academic offerings, and service academic financing requests via the information provided by the central processing computer 10 and/or the apparatus 100 of the present invention. The broker may also request to be notified, electronically and/or otherwise via a message generated and/or transmitted via the central processing computer 10, of times and/or instances when an student's academic financing is up for renewal.

The broker may then utilize any of the information provided by, and/or contained in, the database 10H of the present invention in order to respond to an insured administrator's needs and/or requests, such as, but not limited to preparing offers of enrollment for comparison, finding an academic financing and/or academic offerings for addressing the student's particular needs, assisting in resolving requests issues and/or requests processing issues, and/or assisting and/or providing any other information which could allow the broker or other intermediary to provide assistance to, and/or to provide added value to its administrator or administrators.

In this, manner, the present invention can provide a platform for allowing a broker to provide improved services to his or her insured while also providing for a more paperless working relationship.

In another preferred embodiment of the present invention, the present invention can be utilized in order to provide notification to any of the students, education provider or education materials provider or education tools provider or education computer-enabled tools providers, payers, users, and/or intermediaries. For example, an education or education related specialist can be electronically and/or otherwise notified if a student is diagnosed with an requirement and/or a condition which he or she specializes in treating.

As another example, a payer can be electronically and/or otherwise notified when a student may be admitted to an educational institution and/or other facility for service or resource. The present invention can also be utilized to electronically and/or otherwise notify an education provider or education materials provider or education tools provider or education computer-enabled tools provider when his or her student has been diagnosed with an requirement even when the student may not be under the education provider or education materials provider or education tools provider or education computer-enabled tools provider's service or resource, and/or to notify a student if an education provider or education materials provider or education tools provider or education computer-enabled tools provider has become available to perform an academic lesson and/or an instruction on, and/or for, the student.

The present invention can also be utilized in order to provide notification, electronically and/or otherwise, to any respective party, regarding any event, happening, and/or occurrence, which is described herein and/or which may be reasonably foreseen from the comprehensive nature of the present invention in providing comprehensive education processing.

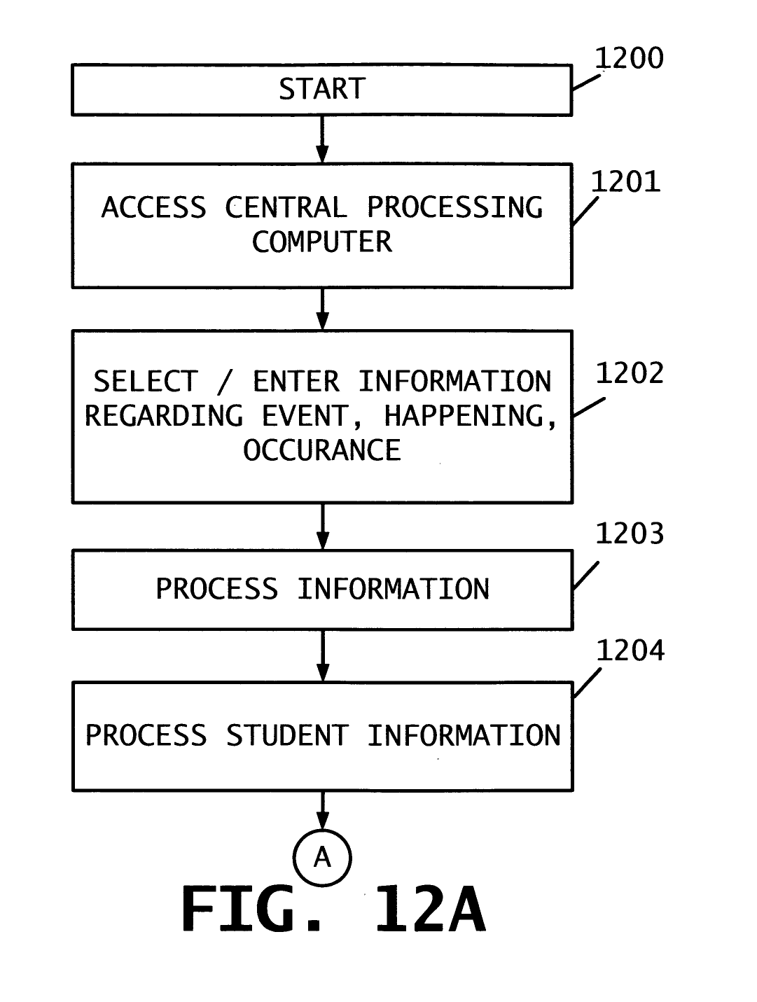

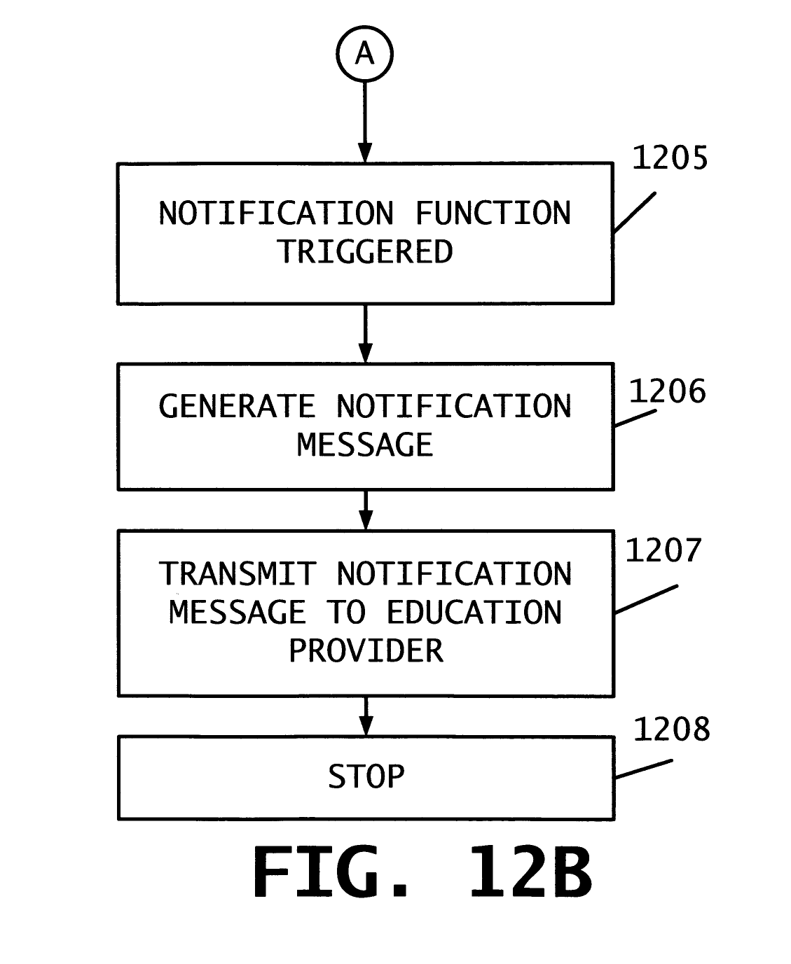

FIGS. 12A and 12B illustrate another preferred embodiment method of utilizing the present invention, in flow diagram form. In the preferred embodiment of FIGS. 12A and 12B, the present invention can provide notification to any respective party, electronically and/or otherwise, in response to the occurrence of an event, happening, and/or occurrence.

While the description of the embodiment of FIGS. 12A and 12B will be directed to notifying an education products and education services providers, and education computing applications providers, and education technical solutions providers or other education provider or education materials provider or education tools provider or education computer-enabled tools provider when a student requires the education provider or education materials provider or education tools provider or education computer-enabled tools provider's academic lesson and/or service or resource, it is important to note that the embodiment of the FIGS. 12A and 12B can be utilized so as to provide notification services and/or functionality for any defined event, happening, and/or occurrence, and to any of the respective students, users, education provider or education materials provider or education tools provider or education computer-enabled tools providers, payers, and/or intermediaries, described herein.

The operation of the apparatus 100 commences at step 1200. At step 1201, the education provider or education materials provider or education tools provider or education computer-enabled tools provider can access the central processing computer 10. At step 1202, the education provider or education materials provider or education tools provider or education computer-enabled tools provider can select and/or enter the information concerning the notifying event, happening, and/or occurrence, and/or the conditions for notifying the education provider or education materials provider or education tools provider or education computer-enabled tools provider. For example, an educator can request to be notified when a student enters assignment results into a computer-based education application. At step 1203, the central processing computer 10 processes the above information. At step 1204, the central processing computer 10, upon receiving information concerning the student's assignment results to the computer-based education application, will process the student's information.

At step 1205, the central processing computer 10 will identify and/or ascertain that the education provider or education materials provider or education tools provider or education computer-enabled tools provider's condition for notification has been met or has been triggered. Thereafter, at step 1206, the central processing computer will generate an appropriate message to notify the education provider or education materials provider or education tools provider or education computer-enabled tools provider. At step 1207, the central processing computer 10 can transmit the notification message to the education provider or education materials provider or education tools provider or education computer-enabled tools provider's communication device as any one or more of an e-mail, a beeper or pager message, a telephone call, and/or in any other manner. The central processing computer 10 can also transmit multiple notification messages to multiple communication devices such as a computer, a personal digital assistant, a beeper or pager and/or a telephone. Thereafter, operation of the apparatus will cease at step 1208.

In a similar manner, a payer may also request to be notified upon the admission of a student to an educational institution and/or other service or resource facility. A student may also request that certain education provider or education materials provider or education tools provider or education computer-enabled tools providers and/or payers be notified by the present invention of an event, happening, and/or occurrence involving the student. There is no limit to the scenarios and/or alternate embodiments in which the present invention can be utilized in order to provide notification to any of the students, users, education provider or education materials provider or education tools provider or education computer-enabled tools providers, payers, and/or intermediaries, described herein.

In still another preferred embodiment, the present invention can be utilized to facilitate education requests processing. Any of the students, education provider or education materials provider or education tools provider or education computer-enabled tools providers, payers, users, and/or intermediaries, can file requests with the respective party electronically via the present invention. The request forms for each payer and/or other party can be accessed from the respective party's communication device, filled out and submitted electronically by the requesting party. Any and/or all submissions can be electronically dated and/or otherwise marked, the status of the request can be provided to the requesting party at any time and any interested third parties may be notified of any action taken on a request.

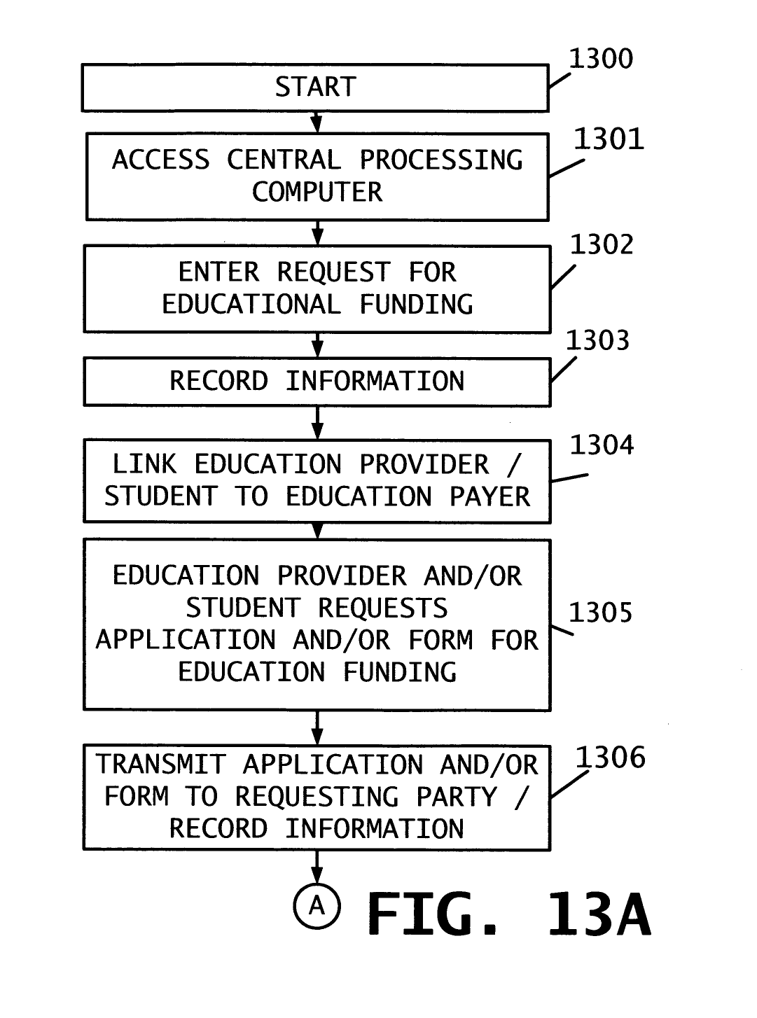

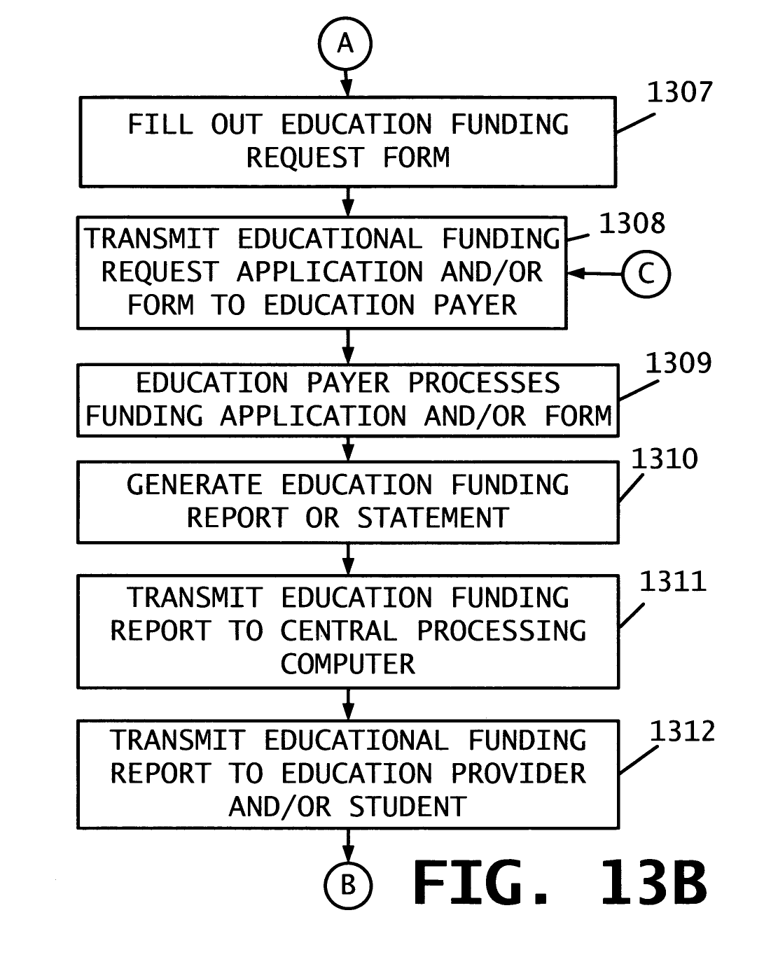

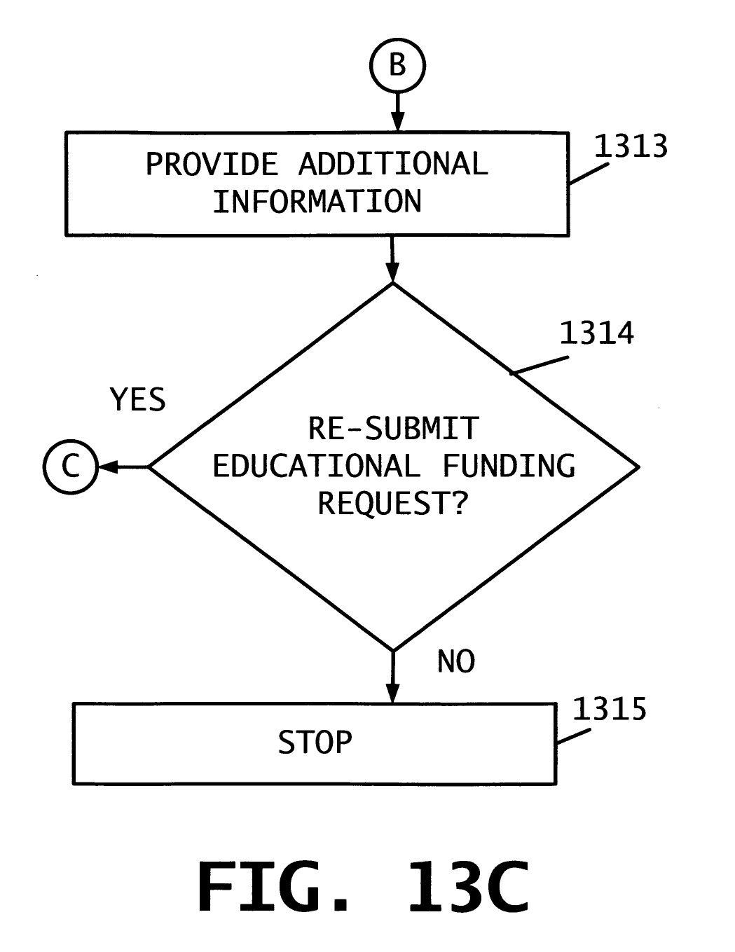

FIGS. 13A, 13B and 13C illustrate a method of utilizing the present invention to perform requests processing services. While it is understood that any appropriate party can file requests with any party described herein, for simplicity, a preferred embodiment where education provider or education materials provider or education tools provider or education computer-enabled tools providers and/or students file requests is described herein. The method, however, can be adapted for use by any party described herein.

With reference to FIGS. 13A, 13B and 13C, operation of the apparatus 100 commences at step 1300. At step 1301, the education provider or education materials provider or education tools provider or education computer-enabled tools provider or student, whichever the case may be, accesses the central processing computer 10 via the respective communication device 20 or 40. At step 1302, the education provider or education materials provider or education tools provider or education computer-enabled tools provider or student enters a request to make a request.

At step 1303, the central processing computer 10 will record any information regarding the request and, thereafter, at step 1304, link the education provider or education materials provider or education tools provider or education computer-enabled tools provider or student directly to the respective payer communication device 30. At step 1305, the education provider or education materials provider or education tools provider or education computer-enabled tools provider or student can request a request form. At 1306, the request form will be transmitted from the payer communication device 30, via the central processing computer 10, which will record the occurrence of same, to the communication device 20 or 40 of the respective education provider or education materials provider or education tools provider or education computer-enabled tools provider or student. The education provider or education materials provider or education tools provider or education computer-enabled tools provider or student can fill out the form on the respective communication device 20 or 40 at step 1307.

At step 1308, the education provider or education materials provider or education tools provider or education computer-enabled tools provider or student transmits the completed form to the payer communication device 30 via the central processing computer 10 which will record the occurrence of same. At step 1309, the payer will process the request and, at step 1310, generate a request report or statement. At step 1311, the request report or statement is transmitted to the central processing computer 10, which can record the occurrence as well as the action taken by the payer (i.e. request approved or denied).

Thereafter, the central processing computer 10 will, at step 1312, transmit the request report or statement to the communication device 20 or 40, respectively, of the education provider or education materials provider or education tools provider or education computer-enabled tools provider or student. Thereafter, at step 1313, the education provider or education materials provider or education tools provider or education computer-enabled tools provider or student can provide the additional information and/or re-submit the request form to the central processing computer. At step 1314, the central processing computer 10 will determine if the education provider or education materials provider or education tools provider or education computer-enabled tools provider or student has provided additional information and/or has decided to resubmit the request.

If, at step 1314, it is determined that additional information has been provided and/or that the request is to be re-submitted, the processing will proceed to step 1308 and the processing of steps 1308 through 1314 will be repeated until a resolution is reached between the parties involved. Thereafter, the operation of the apparatus 100 will cease at step 1315. If at step 1314, it is determined that no new additional information has been submitted and/or that the request is not to be re-submitted then the operation of the apparatus 100 will cease at step 1315.

In this manner, the present invention can facilitate an expedited and/or a paperless request process. Further, records of the transactions, such as, but not limited to request, request form request and/or delivery, request submission, request processing, request report or statement, request re-submission, provision of additional information, and/or any and/or all other transactions, which occur during the request processing instruction or process, can be recorded and maintained at the central processing computer 10 so as to provide for a third party record and/or monitoring of same.

The central processing computer 10, can notify any party described herein, as well as any third parties, regarding any event, happening, occurrence, and/or any aspect of any request submission and/or processing activities. For example, an education provider or education materials provider or education tools provider or education computer-enabled tools provider can be notified at regular interval on a payer's or payers decisions to pay for certain academic lessons and/or instructions. Similarly, a student's guardian and/or employer can be notified regarding request payments made by its group education financially responsible party or financial record keeping party so as to ensure that its employees are being properly serviced and/or provided for. Other information may similarly be provided to any appropriate requesting party described herein and/or any qualified and/or appropriate third party. Notification can be provided to any appropriate party, via any of the communication methods and/or techniques described herein, and can be for, and/or include, any pertinent information.

The apparatus of FIGS. 13A and 13B can also utilize electronic signatures and/or process electronic signatures and/or electronic signature information which can correspond to any of the herein-described parties in performing any of the herein-described processing routines and/or functions.

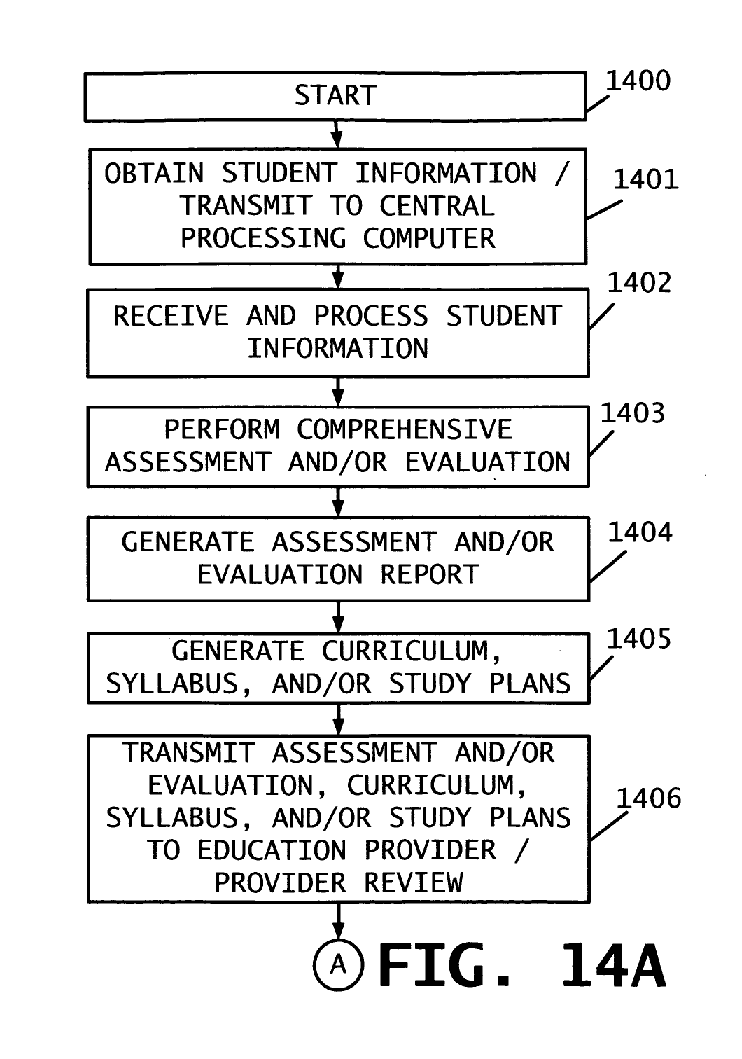

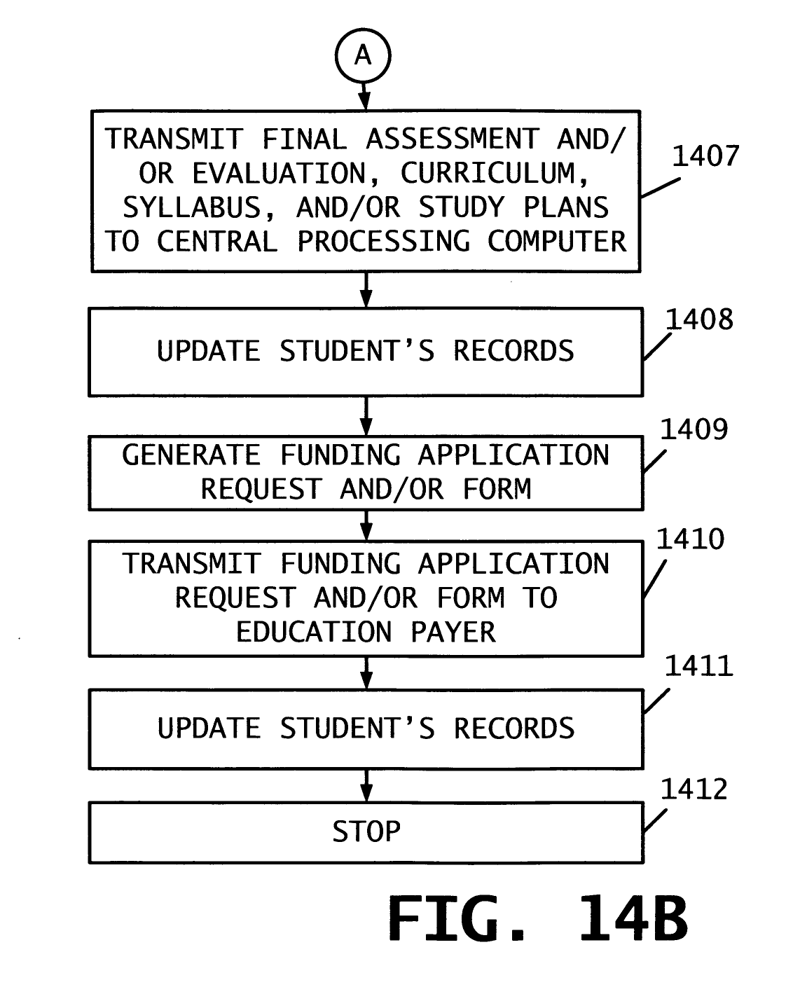

In another preferred embodiment, the present invention can provide for automatic request submission via the central processing computer 10 once a final analysis and academic lesson has been recommended by an education provider or education materials provider or education tools provider or education computer-enabled tools provider and/or upon the occurrence of an examination and/or the administration of an academic lesson. FIGS. 14A and 14B illustrate another preferred embodiment method of utilizing the present invention.

With reference to FIGS. 14A and 14B, operation of the apparatus 100 commences at step 1400. At step 1401, the student's evaluations, if any, and/or examination findings are obtained from the student and transmitted from the education provider or education materials provider or education tools provider or education computer-enabled tools provider communication device 20 to the central processing computer 10. The central processing computer 10 will, at step 1402 receive and process the student evaluations, if any, and/or the examination findings, in conjunction with the student's education or education related history and/or other information, education or education related theories, principles, criteria and/or other education or education related information needed to make an analysis. At step 1403, the central processing computer 10 will perform a comprehensive analytical evaluation of the student's evaluations, if any, and/or the examination findings.

At step 1404, the central processing computer 10 will generate a analytical report which can include an analysis of the student's condition. The analytical report which is generated at step 1404 can, if needed, include a single analysis and/or a list of possible assessments along with their respective probabilities, which may pertain to the student's condition. At step 1405, the central processing computer 10 can then generate, if needed, an academic lesson report which will outline and/or recommend academic lesson for the single analysis and/or for the list of possible assessments. The central processing computer 10, when generating the academic lesson report, can, if needed, process same in conjunction with, and consider possible tutorial interactions and/or academic lesson interactions.

At step 1406, the central processing computer 10 will transmit the analytical report and/or academic lesson report to the education provider or education materials provider or education tools provider or education computer-enabled tools provider's communication device 20 at which point the education or education related education products and education services providers, and education computing applications providers, and education technical solutions providers can obtain the analysis or possible assessments and corresponding academic lesson plans, syllabi, curricula, if any. The education or education related education products and education services providers, and education computing applications providers, and education technical solutions providers can then review the analytical report and/or academic lesson report and choose a final analysis and/or academic lesson plan to administer to the student. At step 1407, the education or education related education products and education services providers, and education computing applications providers, and education technical solutions providers will transmit the final analysis and academic lesson plan, including the recommended academic lesson and/or academic lesson plan, to the central processing computer 10. At step 1408, the central processing computer will then update the student's records in the database 10H so as to include all of the data and information described as being processed and/or generated by the central processing computer 10, including, but not limited to the student's evaluations, the information contained in the analytical report and the academic lesson report, the final analysis and the recommended academic lesson.

Thereafter, at step 1409, the central processing computer 10 will generate a request form which can meet the formal request submission requirements of the student's payer or financing company. At step 1410, the request form will be submitted by the central processing computer 10 to the respective payer computer 30. At step 1411, any and/or all pertinent information regarding the request submission, the student, the education provider or education materials provider or education tools provider or education computer-enabled tools provider visit, and/or any assessments and/or academic lessons considered, the final analysis and/or the recommended academic lesson, can be stored and the student's records will then be updated and be available for the student's next academic lesson and/or analysis.

The operation of the apparatus 100 will then cease at step 1412. In this manner, the present invention can provide for the automatic and/or for the programmed submission of education requests, request forms, requests, benefit requests, etc., upon the conclusion of an education provider or education materials provider or education tools provider or education computer-enabled tools provider's service, consultation, academic lesson, instruction, and/or any other event which triggers education financing under an education financing academic financing and/or a payer's liability to pay for services and/or academic lessons.

In the embodiment of FIGS. 14A and 14B, as well as any and/or all of the other embodiments described herein, the present invention can utilize and/or process electronic signatures in order to effectuate and/or process any of the respective transactions which are described as taking place between, and/or which can transpire involving, any of the respective parties described herein. Applicant hereby incorporates by reference herein the subject matter and teachings of Applied Cryptography, Second Edition, Bruce Schneier, Wiley, 1996.

The present invention can also be utilized, in the manner described above, in connection with requesting education financing, to request education management financing and/or educational instruction financing.

In another preferred embodiment, the apparatus 100 can administer and/or maintain financial accounts for, and/or on behalf of, any of the students, users, education provider or education materials provider or education tools provider or education computer-enabled tools providers, payers, and/or intermediaries, described herein. In this manner, any of the parties described herein as utilizing the services of the apparatus 100, and/or the central processing computer 10, can have all financial transaction managed and/or monitored by the central processing computer 10. In the preferred embodiment, the financial accounts can be conventional savings accounts, checking account, credit accounts, debit accounts, electronic money accounts, digital money accounts, etc., and/or any other appropriate account(s).

In the preferred embodiment, any of the respective parties may select to have the central processing computer 10 administer any financial transactions on their behalf. For example, a payer may deposit a sum of money which can be ear-marked for payment of education provider or education materials provider or education tools provider or education computer-enabled tools provider services. An education provider or education materials provider or education tools provider or education computer-enabled tools provider may open an account and deposit a sum of money to pay any vendor bills. The education provider or education materials provider or education tools provider or education computer-enabled tools provider may also open an account to receive payment from payers and/or students for services rendered. Each time a financial transaction is to occur, such as, for example, the payment from a payer to an education provider or education materials provider or education tools provider or education computer-enabled tools provider resulting from a student's request, the central processing computer 10 will transfer funds (and/or deduct funds) from the payer's account and deposit the funds (and/or add the funds) to the education provider or education materials provider or education tools provider or education computer-enabled tools providers account. Notwithstanding the examples provided above, the central processing computer 10 can effectuate any type of financial transaction(s) for, between, and/or on behalf of, any of the parties described herein. Further, the apparatus 100 and/or the central processing computer 10 can process electronic signatures which can be associated with and/or which can correspond to any of the respective parties to a transaction.

The central processing computer 10, in the preferred embodiment, can maintain detailed records of any and/or all of such transfer and/or transactions and provide periodic account statements to the respective parties maintaining accounts with the central processing computer 10. In this manner, the present invention can provide an apparatus and a method for maintaining financial accounts, effecting financial transactions, and providing accounting and/or other notification services, for, and/or on behalf, any of the parties described herein.

In another preferred embodiment, the apparatus and method of the present can be utilized as an education training simulator for any of the education provider or education materials provider or education tools provider or education computer-enabled tools providers, education provider or education materials provider or education tools provider or education computer-enabled tools providers, education professionals, and/or other education provider or education materials provider or education tools provider or education computer-enabled tools providers described herein. The present invention can also be utilized by any user and/or individual wishing to learn about a certain education field or topic. The present invention can be utilized to provide formal training, supplemental training, informal training, continuing education training, and/or any other training.

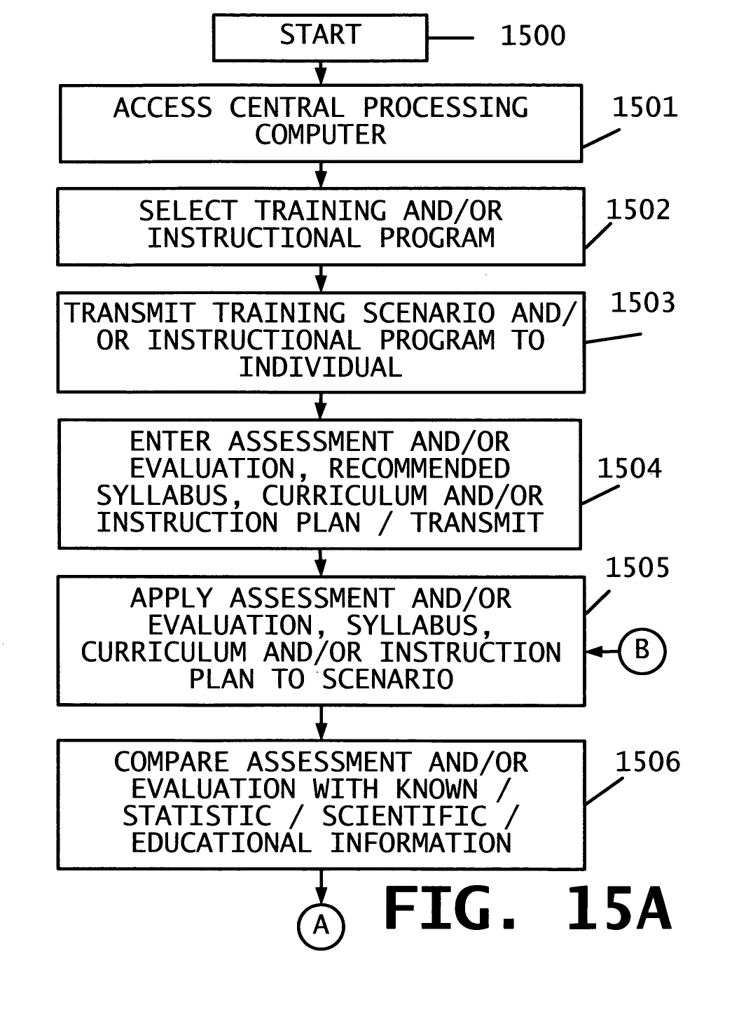

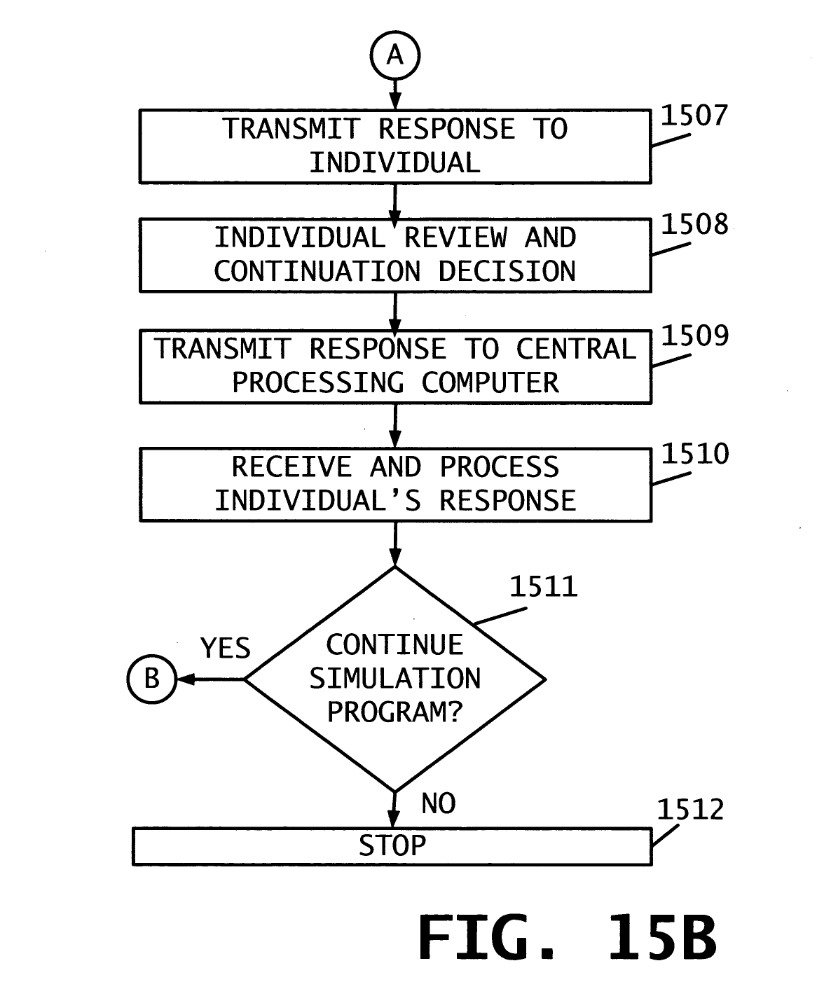

FIGS. 15A and 15B illustrate another preferred embodiment method for utilizing the present invention, in flow diagram form. The operation of the apparatus commences at step 1500. At step 1501, the individual utilizing the training simulator (referred to hereinafter as “the user”) who could be any education provider or education materials provider or education tools provider or education computer-enabled tools provider, student education provider or education materials provider or education tools provider or education computer-enabled tools provider, and/or any other individual and/or party described herein, can access the central processing computer 10 via an appropriate computer or communication device. At step 1502, the user can select the training program which he or she wishes to train from. At step 1503, the central processing computer 10 will transmit the training scenario and/or information, including the evaluations and/or conditions of a hypothetical student. The training scenario can include any one or more of text information, a video tapped file or video clip, audio information, and/or any other multimedia information.

At step 1504, the user can enter his or her analysis and recommended academic lesson and/or academic lessons for the presented scenario and transmit same to the central processing computer 10. At step 1505, the user's analysis and recommended academic lesson can be applied to the scenario. At step 1506, the central processing computer 10 will compare the analysis against any analysis or assessments which are known to be correct and/or against any scientific and/or statistical norms. At step 1506, the central processing computer 10 will apply the recommended academic lesson or academic lessons to the hypothetical student and compute a revised set of evaluations and/or conditions which can result from the applied academic lesson and/or academic lessons. Once again, statistical information can be utilized to arrive at a realistic response to the academic lesson and/or academic lessons. The user's analysis and recommended academic lesson, as well as information regarding the correctness and/or viability of same can be recorded by the central processing computer 10 at step 1506.

At step 1507, the central processing computer 10 will transmit a response to the user's analysis and recommended academic lesson. The response can include the student's response to the recommended academic lesson, and/or an evaluation of the analysis and recommended academic lesson or academic lessons. The response can also include training materials, which can include any one or more of text information, video information, and/or audio information.

At step 1508, the user can review the material and/or information contained in the response and can decide whether he or she wishes to continue the training simulation. At step 1509, the user will transmit a response to the central processing computer 10 which contains an lesson to either continue the simulation, in which case the user's response will also include a revised analysis and recommended academic lesson or academic lessons, or to terminate the training simulation.

At step 1510, the central processing computer 10 will receive and process the user's response provided at step 1509. At step 1511, the central processing computer 10 will determine whether the user desires to continue the simulation or whether the user desires to terminate the simulation. If, at step 1511, it is determined that the user desires to continue the training simulation, the operation of the central processing computer 10 returns to step 1505 and the above-described process will be repeated from step 1505. If, however, it is determined that the user desires to terminate the training simulation the operation of the apparatus 100 will cease at step 1512. User responses, including analytical and academic lesson decisions, and/or performance, can be recorded and/or can be stored and, thereafter the information can be utilized to evaluate the user and/or for comparing the user's progress and/or improvements, as well as aptitude and skills, in the pertinent field of training, and/or the information can be utilized for any other useful purpose.

In this manner the apparatus and method of the present invention can be utilized to provide an interactive education training simulator which can be utilized for training in any and/or all of the fields of education, instruction, and/or in any other education and/or education related field.

Data and/or information collected and/or stored by the apparatus 100, which relates to evaluations and/or conditions, as well as responses to academic lessons, can be utilized in order to present realistic and confidential training scenarios. In this manner, the present invention can be utilized to compile a vast amount of information relating to the various fields of education. The information can then be utilized to provide realistic training for education provider or education materials provider or education tools provider or education computer-enabled tools providers and/or student education provider or education materials provider or education tools provider or education computer-enabled tools providers. In this manner, the present invention can utilize information obtained from other preferred embodiments in order to provide simulated training scenarios.

In another preferred embodiment, the apparatus 100 and method of the present invention can be utilized in order to maintain student education records or files private and/or to safeguard student education records or files, by restricting and/or limiting access to the respective records or files.

The apparatus 100 and/or the central processing computer 10 can process information regarding the identity of, and/or the information which is authorized and/or allowed to be provided to, a requesting individual or entity who or which can be any individual, entity, student, education provider or education materials provider or education tools provider or education computer-enabled tools provider, payer, and/or intermediary, and/or any other individual or entity, who or which may request information regarding a student's or an individual's education records or file. Thereafter, the apparatus 100 and/or the central processing computer 10 can determine whether the respective information requesting individual or entity is authorized or allowed to access, obtain, and/or to change or alter any information contained in a respective student's or individual's education records or file.

The apparatus 100 and/or the central processing computer 10 can utilize and/or process passwords, electronic signatures, and/or any other information and/or encoded and/or encrypted information in determining an individual's or an entity's authorization to access, obtain, and/or change or alter, any information in a respective education record(s) or file(s).

If the apparatus 100 and/or the central processing computer 10 determines that an individual or entity is authorized or allowed to access, obtain, and/or to change or alter, any information contained in a respective student's or individual's education record(s) or file(s), the apparatus 100 and/or the central processing computer 10 will respectively allow access to the information, provide the information, and/or process and store changes, alterations, and/or updates, to the respective education record(s) or file(s). If, however, the apparatus 100 and/or the central processing computer 10 determines that an individual or entity is not authorized or not allowed to access, obtain, and/or to change or alter, any information contained in a respective student's or individual's education record(s) or file(s), the apparatus 100 and/or the central processing computer 10 will prohibit or disallow access to the information.

In another preferred embodiment of the apparatus 100 and method of the present invention, the apparatus 100 can provide notification to students or other individuals when others have accessed, obtained, and/or made changes to, their respective education records or files. The apparatus 100 can also provide notification to education provider or education materials provider or education tools provider or education computer-enabled tools provider's, including but not limited to, the student's or individual's education provider or education materials provider or education tools provider or education computer-enabled tools provider or education provider or education materials provider or education tools provider or education computer-enabled tools providers, and/or education payers or financing education provider or education materials provider or education tools provider or education computer-enabled tools providers, including but not limited to, the student's or individual's education payer(s) or financing education provider or education materials provider or education tools provider or education computer-enabled tools provider(s), when others have accessed, obtained, and/or made changes to, their respective education records or files.

It is envisioned that education records or files can be accessed, obtained, changed, or altered, by any one or more of a student, an individual, a relative of a student, a relative of a an individual, an interested third party, an education provider or education materials provider or education tools provider or education computer-enabled tools provider, an education provider or education materials provider or education tools provider or education computer-enabled tools provider to the student, an education provider or education materials provider or education tools provider or education computer-enabled tools provider to the student or individual, an education payer, an financing education provider or education materials provider or education tools provider or education computer-enabled tools provider, and/or an education payer or financing education provider or education materials provider or education tools provider or education computer-enabled tools provider of the student or individual. In this manner, the apparatus 100 and method of the present invention can maintain and/or safeguard education records or files for any of the students and/or individuals described herein. In the same manner, the apparatus 100 and method of the present invention can also maintain and safeguard records and/or files of, or regarding any of the herein-described education provider or education materials provider or education tools provider or education computer-enabled tools providers and/or education payers.

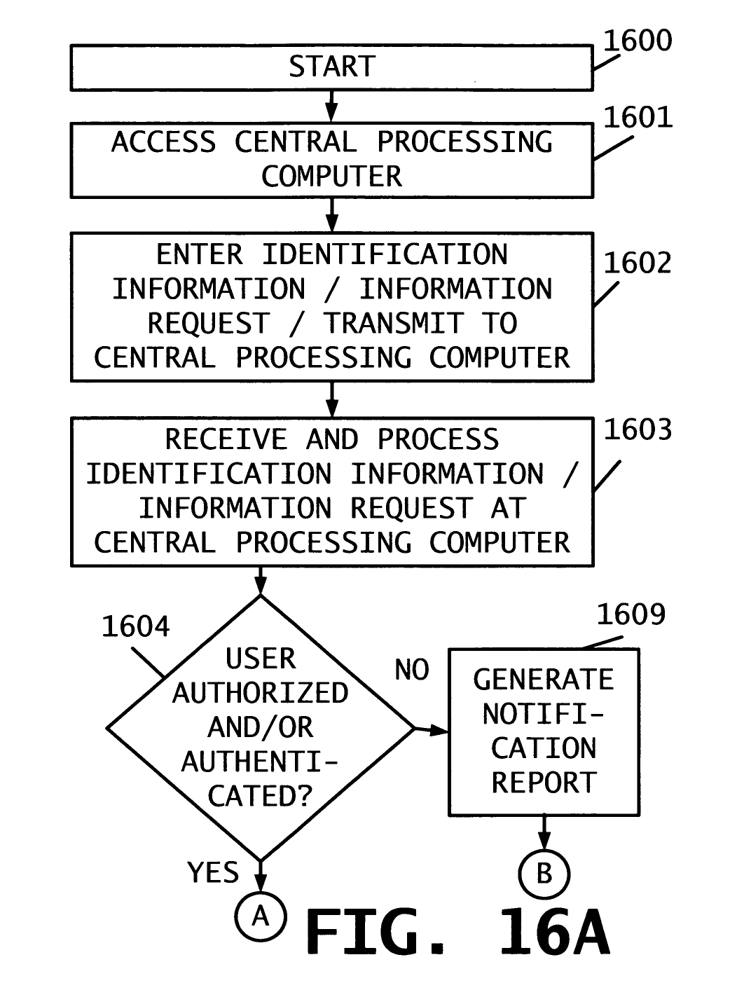

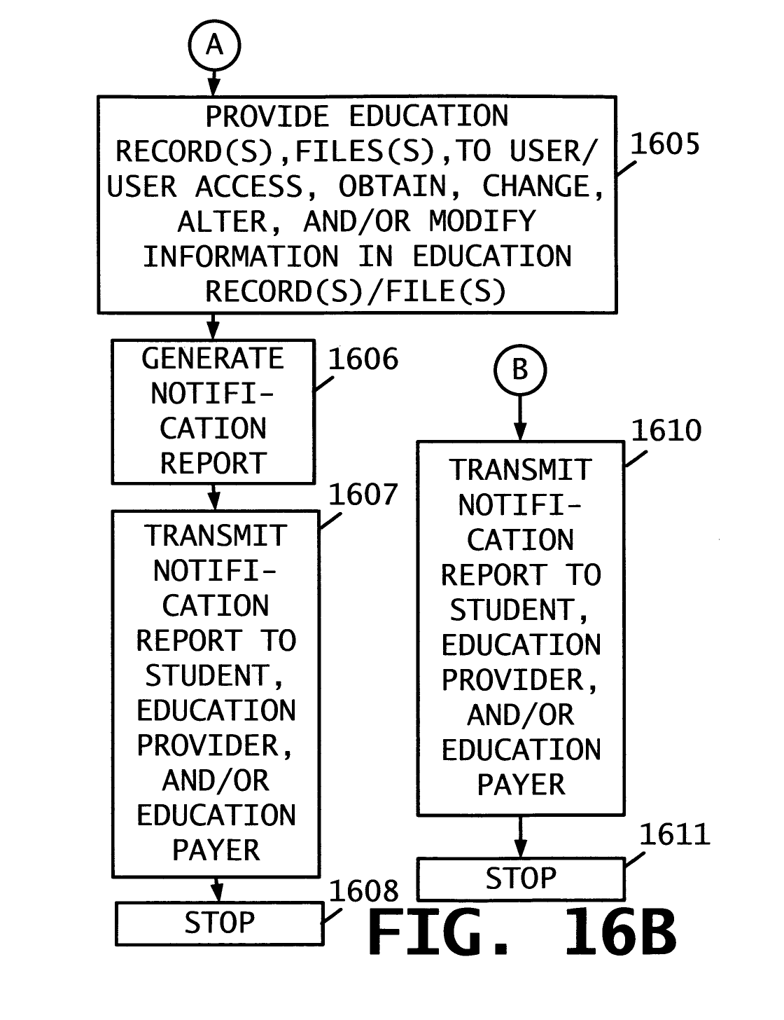

In another preferred embodiment, the apparatus 100 and method of the present invention can provide notification to a student or individual when his or her education record(s) or file(s), or any portion thereof, has been accessed, obtained, changed, altered, updated, and/or other modified, and/or when a request has been made to access, obtain, change, alter, update, and/or otherwise modify, his or her education record(s) or file(s), or any portion thereof. FIGS. 16A and 16B illustrate another preferred embodiment method for utilizing the apparatus 100 of the present invention, in flow diagram form.

With reference to FIGS. 16A and 16B, the operation of the apparatus commences at step 1600. At step 1601, any one or more of an education provider or education materials provider or education tools provider or education computer-enabled tools provider, an education payer, an financing education provider or education materials provider or education tools provider or education computer-enabled tools provider, a student, an individual, a relative of a student or individual, and/or any other third party individual or entity (hereinafter referred to as “user”) can access the central processing computer 10 via a respective computer or communication device and/or via their or its respective computer or communication device.

For example, an education provider or education materials provider or education tools provider or education computer-enabled tools provider can access the central processing computer in order to access, obtain, change, alter, or modify, information contained in a student's education record(s) or file(s) for any appropriate reason, such as, but not limited to, updating a record or file, making an analysis, prescribing an academic lesson, providing an academic lesson plan or program, providing information to other education provider or education materials provider or education tools provider or education computer-enabled tools providers, submitting the financial payment request, financial grant request, financial credit request, financial loan request information, etc., and/or for any other reason.

An education payer or financing education provider or education materials provider or education tools provider or education computer-enabled tools provider can education provider or education materials provider or education tools provider or education computer-enabled tools provider can access the central processing computer in order to access, obtain, change, alter, or modify, information contained in a student's education record(s) or file(s) for any appropriate reason, such as but not limited to, processing a financial obligation payment request, obtaining additional information regarding the student or individual, etc., and/or for any other reason.

A student or individual can access, obtain, change, alter, or modify, information contained in a student's education record(s) or file(s) for any appropriate reason, such as, but not limited to, updating an education record or file, providing information to an education provider or education materials provider or education tools provider or education computer-enabled tools provider, providing information to an education payer or financing education provider or education materials provider or education tools provider or education computer-enabled tools provider, obtaining academic lesson information, obtaining education provider or education materials provider or education tools provider or education computer-enabled tools provider information, obtaining education payer information, obtaining education provider or education materials provider or education tools provider or education computer-enabled tools provider information, obtaining financing education provider or education materials provider or education tools provider or education computer-enabled tools provider information, etc., and/or for any other reason.

A third party individual or entity can also access, obtain, change, alter, or modify, information contained in a student's education record(s) or file(s) for any appropriate reason, such as, but not limited to, updating an education record or file, providing information regarding a student or students, providing information regarding an individual or individuals, providing information to an education provider or education materials provider or education tools provider or education computer-enabled tools provider, providing information to an education payer or financing education provider or education materials provider or education tools provider or education computer-enabled tools provider, obtaining academic lesson information, obtaining education provider or education materials provider or education tools provider or education computer-enabled tools provider information, obtaining education payer information, obtaining education provider or education materials provider or education tools provider or education computer-enabled tools provider information, obtaining financing education provider or education materials provider or education tools provider or education computer-enabled tools provider information, etc., and/or for any other reason.

At step 1602, the user can enter identification information, a password, an electronic signature, a code, and/or any other information which may be needed for accessing the data and/or information stored in the central processing computer 10. The identification information can be entered by the user and/or be provided by the user's computer or communication device. At step 1602, the user can also enter an information request and/or a request to access, obtain, change, alter, or modify, information contained in a student's education record(s) or file(s). At step 1602, the user's identification information and information regarding the user's request can also be transmitted to the central processing computer 10.

At step 1603, the central processing computer 10 will receive and process the user's identification information and information regarding the user's request. At step 1604, the central processing computer 10 will determine whether the user is an authorized user. At step 1604, the central processing computer 10 can also determine whether the user is authorized to access, obtain, change, alter, or modify, the requested student education record(s) or file(s) and/or whether the user is authorized to access, obtain, change, alter, or modify, the requested information contained in a student's education record(s) or file(s). If, at step 1604, the central processing computer 10 determines that the user is an authorized user and/or that the user is authorized to access, obtain, change, alter, or modify, the requested education record(s) or file(s), the operation of the apparatus 100 will proceed to step 1605.

At step 1605, central processing computer 10 will provide the requested information and/or the information in requested education record(s) or file(s) to the user. At step 1605, the user can any one or more of access any information contained in the respective education record(s) or file(s), obtain any information contained in the respective education record(s) or file(s), change any information contained in the respective education record(s) or file(s), alter any information contained in the respective education record(s) or file(s), update any information contained in the respective education record(s) or file(s), and/or modify any information contained in the respective education record(s) or file(s).

For example, an education provider or education materials provider or education tools provider or education computer-enabled tools provider can obtain student information, update a student's record(s) or file(s), submit a financial obligation payment request, recommend an academic lesson for the student, and/or perform any other task on, or involving the information contained in the student's education record(s) or file(s). A student or individual can update his or her own education record(s) or file(s) information, such as by providing education or education related, academic, or education history, evaluations, etc. An education payer or financing education provider or education materials provider or education tools provider or education computer-enabled tools provider can update request information, obtain information for processing and/or analyzing the financial payment request, financial grant request, financial credit request, financial loan requests, and/or perform any other task.

At step 1605, the respective user can obtain, access, change, alter, or modify, any of the information contained in the student's education record(s) or file(s), for which the user is authorized. At step 1605, the respective user can perform any task on, or regarding, the information contained in the student's education record(s) or file(s).

At step 1606, the central processing computer 10 will generate a notification report containing information regarding the user who or which obtained, accessed, changed, altered, or modified, the education record(s) or file(s), user identification information, the time and date the user obtained, accessed, changed, altered, or modified, the education record(s) or file(s), the reason for the user obtaining, accessing, changing, altering, or modifying, the education record(s) or file(s), the nature of any changes, alterations, or modifications, made to the information contained in the education record(s) or file(s), the subject of, and/or the actual, changes, alterations, or modifications, made to the education record(s) or file(s), and/or any other information regarding the user's obtaining, accessing, changing, altering, or modifying, the information contained in the education record(s) or file(s).

At step 1607, the central processing computer 10 will transmit the notification report to the student or individual whose education record(s) or file(s) were accessed by the user. The notification report can be transmitted as an e-mail message, as a beeper message, as a pager message, as a telephone call, as a pre-recorder telephone call message, as an electronic transmission, and/or as any other information transmission or message. The notification report can be transmitted to the student, to the student computer 40, and/or to a student communication device.

At step 1607, the notification report can also be transmitted to the student's education provider or education materials provider or education tools provider or education computer-enabled tools provider or education provider or education materials provider or education tools provider or education computer-enabled tools providers, to the student's education payer or education payers, to the student's financing education provider or education materials provider or education tools provider or education computer-enabled tools provider or financing education provider or education materials provider or education tools provider or education computer-enabled tools providers, and/or to any third party individuals or entities authorized to receive the notification report. The notification report can be transmitted to any of the respective computers or communication devices associated with the respective education provider or education materials provider or education tools provider or education computer-enabled tools provider(s), education payer(s), financing education provider or education materials provider or education tools provider or education computer-enabled tools provider(s), and/or third party individual(s), entity, or entities.

Thereafter, the operation of the apparatus 100 will cease at step 1608.

If, however, at step 1604, it is determined that the user is not an authorized user and/or that the user is not authorized to access, obtain, change, alter, or modify, the requested education record(s) or file(s), or any information contained therein, then the operation of the apparatus 100 will proceed to step 1609.

At step 1609, the central processing computer 10 will generate a notification report containing information regarding the user who or which attempted to obtain, access, change, alter, or modify, the education record(s) or file(s), user identification information, the time and date of the user's attempted access of the education record(s) or file(s), the reason for the user's attempted access of the education record(s) or file(s), and/or any other information regarding the user's attempted access of the education record(s) or file(s).

At step 1610, the central processing computer 10 will transmit the notification report to the student or individual whose education record(s) or file(s) were attempted to be accessed by the user. The notification report can be transmitted as an e-mail message, as a beeper message, as a pager message, a physical letter/mail delivery, as a telephone call, as a pre-recorder telephone call message, as an electronic transmission, and/or as any other information transmission or message. The notification report can be transmitted to the student, to the student computer 40, and/or to a student communication device.

At step 1610, the notification report can also be transmitted to the student's education provider or education materials provider or education tools provider or education computer-enabled tools provider or education provider or education materials provider or education tools provider or education computer-enabled tools providers, to the student's education payer or education payers, to the student's financing education provider or education materials provider or education tools provider or education computer-enabled tools provider or financing education provider or education materials provider or education tools provider or education computer-enabled tools providers, and/or to any third party individuals or entities authorized to receive the notification report. The notification report can be transmitted to any of the respective computers or communication devices associated with the respective education provider or education materials provider or education tools provider or education computer-enabled tools provider(s), education payer(s), financing education provider or education materials provider or education tools provider or education computer-enabled tools provider(s), and/or third party individual(s), entity, or entities.

Any of the notification reports described herein as being provided by the apparatus 100 of FIGS. 16A and 16B can be transmitted to the respective student, individual, education provider or education materials provider or education tools provider or education computer-enabled tools provider, education payer, financing education provider or education materials provider or education tools provider or education computer-enabled tools provider, and/or third party, in real-time, in a time-delayed manner, and/or in any other appropriate manner.

Thereafter, the operation of the apparatus 100 will cease at step 1611.

In another preferred embodiment of FIGS. 16A and 16B, a respective student, individual, education provider or education materials provider or education tools provider or education computer-enabled tools provider, education payer, financing education provider or education materials provider or education tools provider or education computer-enabled tools provider, and/or third party, upon receiving notification that an individual or entity is any one or more of accessing, obtaining, changing, altering, and/or modifying, information contained in an education record or file, can terminate the accessing, obtaining, changing, altering, and/or modifying, information contained in an education record or file, in real-time, such as by transmitting a “terminate” or “deny access” message or signal to the central processing computer 10 via a respective computer or communication device.

In another preferred embodiment, the apparatus 100 of FIGS. 16A and 16B, and in particular, the central processing computer 10, can store information regarding any accessing, obtaining, changing, altering, and/or modifying, of any of the information contained in any of the education records and/or education files by any of the herein-described education provider or education materials provider or education tools provider or education computer-enabled tools providers, education payers, financing education provider or education materials provider or education tools provider or education computer-enabled tools providers, students, individuals and/or third parties.

The stored information can include any one or more of the data, time, reason, purpose, and/or the nature, of the accessing, obtaining, changing, altering, and/or modifying, of any of the information contained in any of the education records and/or education files by any of the herein-described education provider or education materials provider or education tools provider or education computer-enabled tools providers, education payers, financing education provider or education materials provider or education tools provider or education computer-enabled tools providers, students, individuals and/or third parties. The stored information can also include the subject matter of any changes, alterations, and/or modifications, to the education record(s) or file(s).

The central processing computer 10 can generate and/or provide activity reports regarding any accessing, obtaining, changing, altering, and/or modifying, of any of the information contained in any of the education records and/or education files by any of the herein-described education provider or education materials provider or education tools provider or education computer-enabled tools providers, education payers, financing education provider or education materials provider or education tools provider or education computer-enabled tools providers, students, individuals and/or third parties. The central processing computer 10 can generate activity reports upon demand and/or upon request. The central processing computer 10 can also be programmed to generate activity reports periodically, such as daily, weekly, monthly, bi-monthly, quarterly, annually, and/or for any other time period.

The activity reports can include information regarding any number of education records or files for any number of students or individuals.

The central processing computer 10 can transmit the activity reports to the respective education provider or education materials provider or education tools provider or education computer-enabled tools providers, education payers, financing education provider or education materials provider or education tools provider or education computer-enabled tools providers, students, individuals and/or third parties, by transmitting same to a respective computer or communication device associated with the respective education provider or education materials provider or education tools provider or education computer-enabled tools provider(s), education payer(s), financing education provider or education materials provider or education tools provider or education computer-enabled tools provider(s), student(s), individual(s), third party, and/or third parties. The activity report can be transmitted as an e-mail message, as a beeper message, as a pager message, a physical letter/mail delivery, as a telephone call, as a pre-recorded telephone call message, as an electronic transmission, and/or as any other information transmission or message.

Any of the activity reports described herein as being provided by the apparatus 100 of FIGS. 16A and 16B can be transmitted to the respective student, individual, education provider or education materials provider or education tools provider or education computer-enabled tools provider, education payer, financing education provider or education materials provider or education tools provider or education computer-enabled tools provider, and/or third party, in real-time, in a time-delayed manner, and/or in any other appropriate manner.

In another preferred embodiment, the apparatus 100 can be utilized in order to allow students and individuals to restrict and/or limit access to their education records or files. In this manner, the student or individual can restrict access of information contained in his or her education record(s) or file(s) to only certain education provider or education materials provider or education tools provider or education computer-enabled tools providers, education payers, education financing education provider or education materials provider or education tools provider or education computer-enabled tools providers, individuals, and/or entities. In this manner, the student or individual can restrict access to his or her education record information or education file information to his or her education provider or education materials provider or education tools provider or education computer-enabled tools provider(s), to his or her education payer(s), to his or her financing education provider or education materials provider or education tools provider or education computer-enabled tools provider(s), to his or her relatives, family members, spouse, next-of-kin, and/or any other designated individual, individuals, entity, or entities.

The student or individual can also restrict access to, the ability to obtain, the ability to change, alter, or modify, any information contained in his or her education record(s) or file(s) to only certain information, certain portions of information, certain subject matter. For example, a student or individual can restrict an education or education related education products and education services providers, and education computing applications providers, and education technical solutions provider's access to his or her academic records, academic files, behavior/psychological files, etc. A student can restrict an education payer's access to unrelated or irrelevant information. A student or individual can also restrict a third party individual's access to certain information.

The student or individual can restrict access to any of his or her education record(s) or file(s), and/or to any portions or sections of same, by any of the herein-described education provider or education materials provider or education tools provider or education computer-enabled tools providers, education payers, financing education provider or education materials provider or education tools provider or education computer-enabled tools providers, and/or any third party individual or entities, to that extent that said restricted access can be is lawful and/or legal. The student or individual can also restrict access to any of his or her education record(s) or file(s), and/or to any portions or sections of same, by any of the herein-described education provider or education materials provider or education tools provider or education computer-enabled tools providers, education payers, financing education provider or education materials provider or education tools provider or education computer-enabled tools providers, and/or any third party individual or entities, to the extent sufficient or necessary in order to maintain confidentiality, to keep certain information secret or accessible to a select few, and/or to address student privacy concerns.

The student or individual can also limit access to information, by any of the herein-described education provider or education materials provider or education tools provider or education computer-enabled tools providers, education payers, financing education provider or education materials provider or education tools provider or education computer-enabled tools providers, and/or any third party individual or entities, to only certain information or sections of information contained in his or her education record(s) or file(s), and/or to limit access to certain information or sections of information contained in his or her education record(s) or file(s), for use for only specifically designated purposes.

For example, a student or individual can limit an education provider or education materials provider or education tools provider or education computer-enabled tools provider's access to certain education or education related history information only to the extent that said information can be utilized to perform an analysis for a certain need(s), requirement, or evaluation (s), and/or to allow for the submission of a financial obligation payment request, and/or for any other reason. A student or individual can also, for example, limit an education payer's or an financing education provider or education materials provider or education tools provider or education computer-enabled tools provider's access to certain information to the extent of verifying or disproving certain conditions, special considerations, to process a financial obligation payment request submission, and/or for any other reason.

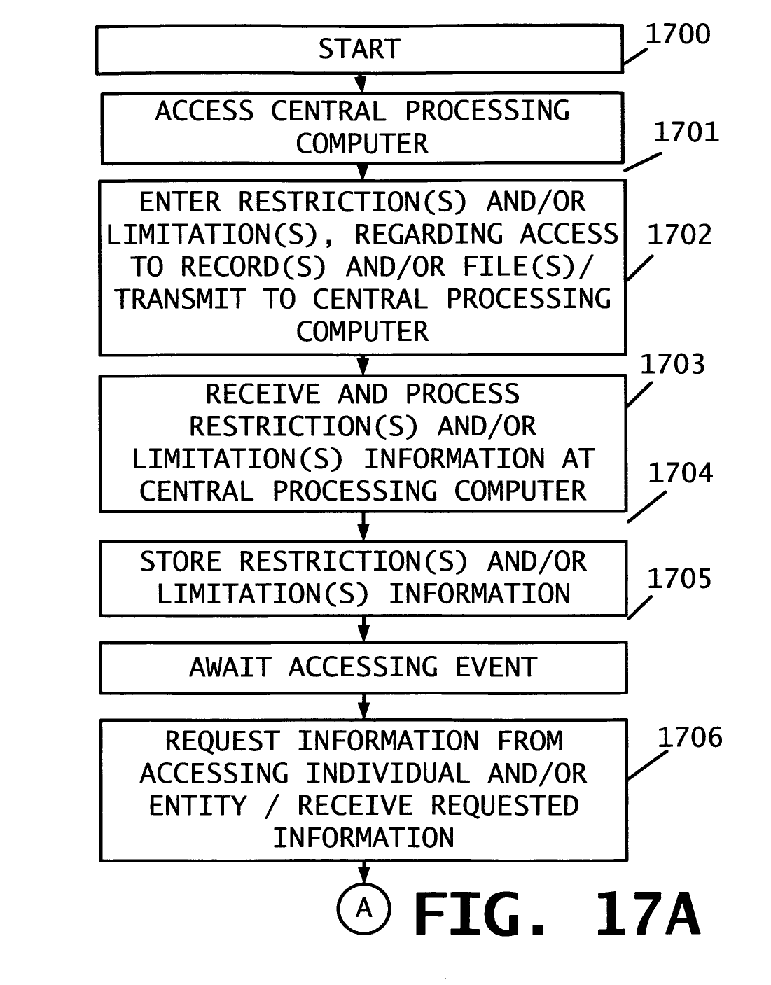

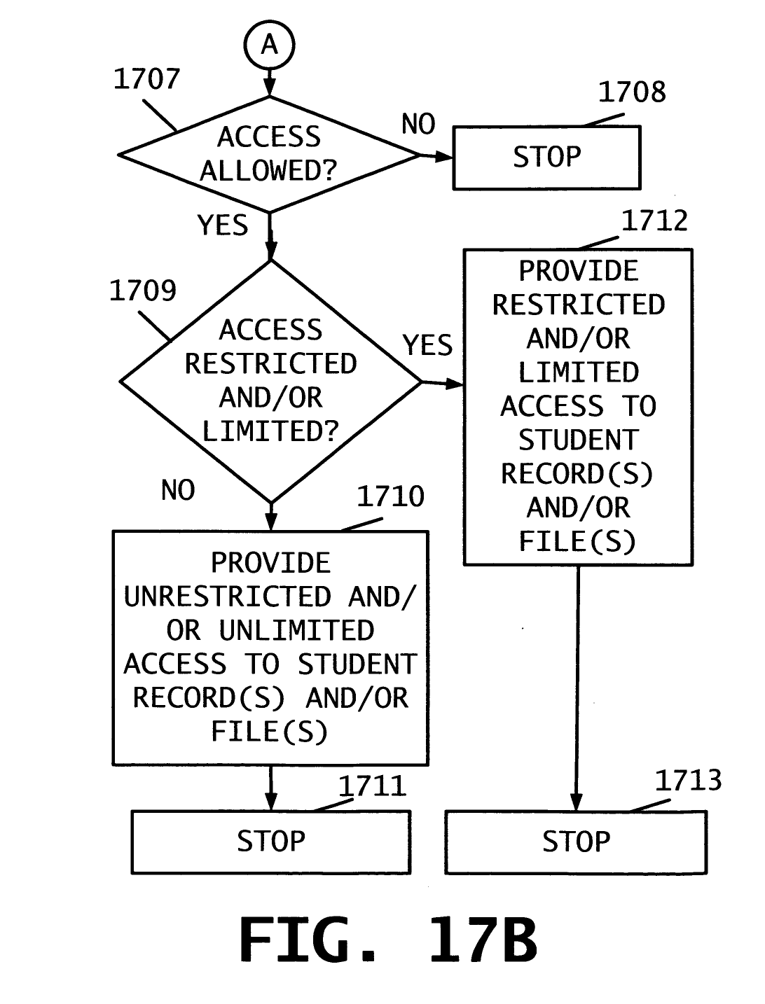

FIGS. 17A and 17B illustrate another preferred embodiment method of utilizing the apparatus 100 of the present invention in flow diagram form. With reference to FIGS. 17A and 17B, the operation of the apparatus 100 commences at step 1700. At step 1701, the student or individual (hereinafter referred to as the “student”) can access the central processing computer 10 via his or her student computer 40. At step 1702, the student can enter information regarding the restrictions and/or limitations on the access to his or her education record(s) or file(s).

At step 1702, the student can enter information regarding any restrictions and/or limitations to the access to his or her education record(s) or file(s) to only a certain education provider or education materials provider or education tools provider or education computer-enabled tools provider(s), a certain type of education provider or education materials provider or education tools provider or education computer-enabled tools provider(s), to a certain education payer(s), a certain type of education payer(s), a certain financing education provider or education materials provider or education tools provider or education computer-enabled tools provider(s), a certain type of financing education provider or education materials provider or education tools provider or education computer-enabled tools provider(s), a certain individual(s), third party, or third parties.

At step 1702, the student can also restrict and/or limit access to his or her education record(s) or file(s), or any information and/or portions of information contained in his or her education record(s) or file(s), for only certain designated purposes (i.e. analysis, second opinions, the financial payment request, financial grant request, financial credit request, financial loan requests submission, the financial payment request, financial grant request, financial credit request, financial loan requests processing, etc.).

The student can also restrict and/or limit access to his or her education record(s) or file(s), or any information and/or portions of information contained in his or her education record(s) or file(s), to certain times, days, dates, or other designated times. The student can also restrict and/or limit access to his or her education record(s) or file(s), or any information and/or portions of information contained in his or her education record(s) or file(s), until such time as certain pre-conditions are met.

For example, the pre-condition can be the establishment of an education products and education services providers, and education computing applications providers, and education technical solutions providers-student relationship, the establishment of an insured-financially responsible party or financial record keeping party relationship, the establishment of a family or next-of-kin relationship, and/or the satisfaction of any condition or pre-condition which can be defined by, or dictated by, any of the herein-described students, education provider or education materials provider or education tools provider or education computer-enabled tools providers, education payers, financing education provider or education materials provider or education tools provider or education computer-enabled tools providers, and/or third parties). The student can also restrict or limit the ability of an education provider or education materials provider or education tools provider or education computer-enabled tools provider, an education payer, an financing education provider or education materials provider or education tools provider or education computer-enabled tools provider, a student, an individual, and/or a third party, to obtain, access, change, alter, or modify, any information contained in the student's education record(s) or file(s).

The student can enter any other restriction or limitations to access to his or her education record(s) or file(s), and/or to any information and/or portions of information contained therein, at step 1702.

At step 1702, the restriction or limitation information can be transmitted to the central processing computer 10. At step 1703, the central processing computer 10 will receive and process the restriction and/or limitation information in conjunction with the student's education record(s) or file(s). At step 1704, the central processing computer 10 will store the restriction or limitation information in the database 10H.

At step 1705, the apparatus 100 will await the accessing of the central processing computer 10 by any individual, education provider or education materials provider or education tools provider or education computer-enabled tools provider, education payer, financing education provider or education materials provider or education tools provider or education computer-enabled tools provider, and/or any third party, who or which desires to access the student's education record(s) or file(s). Upon the attempted accessing of the student's education record(s) or file(s) by any of the herein-described individuals, education provider or education materials provider or education tools provider or education computer-enabled tools providers, education payers, financing education provider or education materials provider or education tools provider or education computer-enabled tools providers, and/or any third parties, the operation of the apparatus 100 will proceed to step 1706. At step 1706, the apparatus 100 and/or the central processing computer 10 can request information from the individual, education provider or education materials provider or education tools provider or education computer-enabled tools provider, education payer, financing education provider or education materials provider or education tools provider or education computer-enabled tools provider, and/or any third party, who or which desires to access the student's education record(s) or file(s).

The requested information can include the name or identity of the individual, education provider or education materials provider or education tools provider or education computer-enabled tools provider, education payer, financing education provider or education materials provider or education tools provider or education computer-enabled tools provider, and/or any third party, the type, nature, or credentials, of the individual, education provider or education materials provider or education tools provider or education computer-enabled tools provider, education payer, financing education provider or education materials provider or education tools provider or education computer-enabled tools provider, and/or third party, the nature or purpose of the requested access of the student's education record(s) or file(s), information regarding the satisfaction and/or the existence of any conditions or pre-conditions to access of the student's education record(s) or file(s) and/or to any information and/or sections of information contained in the education record(s) or file(s).

At step 1706, the central processing computer 10 can receive the individual's, the education provider or education materials provider or education tools provider or education computer-enabled tools provider's, the education payer's, the financing education provider or education materials provider or education tools provider or education computer-enabled tools provider's, and/or the third party's response(s) to the requested information. At step 1707, the central processing computer 10 will determine if the individual's, the education provider or education materials provider or education tools provider or education computer-enabled tools provider's, the education payer's, the financing education provider or education materials provider or education tools provider or education computer-enabled tools provider's, and/or the third party's access is allowed.

If, at step 1707, it is determined that the individual's, the education provider or education materials provider or education tools provider or education computer-enabled tools provider's, the education payer's, the financing education provider or education materials provider or education tools provider or education computer-enabled tools provider's, and/or the third party's access is not allowed the operation of the apparatus 100 will cease at step 1708. If, at step 1707, it is determined that the individual's, the education provider or education materials provider or education tools provider or education computer-enabled tools provider's, the education payer's, the financing education provider or education materials provider or education tools provider or education computer-enabled tools provider's, and/or the third party's access is allowed, the operation of the apparatus 100 will proceed to step 1709.

At step 1709, the central processing computer 10 will determine whether the individual's, the education provider or education materials provider or education tools provider or education computer-enabled tools provider's, the education payer's, the financing education provider or education materials provider or education tools provider or education computer-enabled tools provider's, and/or the third party's access is restricted or limited. If, at step 1709, it is determined that the individual's, the education provider or education materials provider or education tools provider or education computer-enabled tools provider's, the education payer's, the financing education provider or education materials provider or education tools provider or education computer-enabled tools provider's, and/or the third party's access is not restricted or not limited, then the operation of the apparatus 100 will proceed to step 1710. At step 1710 the apparatus 100 and/or the central processing computer 10 will provide the respective individual, education provider or education materials provider or education tools provider or education computer-enabled tools provider, education payer, financing education provider or education materials provider or education tools provider or education computer-enabled tools provider, and/or the third party, with unrestricted and/or with unlimited access to the student's education record(s) or file(s). Thereafter, the operation of the apparatus will cease at step 1711.

If, at step 1709, it is determined that the individual's, the education provider or education materials provider or education tools provider or education computer-enabled tools provider's, the education payer's, the financing education provider or education materials provider or education tools provider or education computer-enabled tools provider's, and/or the third party's access is restricted or is limited, then the operation of the apparatus 100 will proceed to step 1712. At step 1712, the apparatus 100 and/or the central processing computer 10 will provide the respective individual, education provider or education materials provider or education tools provider or education computer-enabled tools provider, education payer, financing education provider or education materials provider or education tools provider or education computer-enabled tools provider, and/or the third party, with the restricted and/or with the limited access to the student's education record(s) or file(s). Thereafter, the operation of the apparatus will cease at step 1713.

In any and/or all of the embodiments described herein, any student, education provider or education materials provider or education tools provider or education computer-enabled tools provider, payer, user, and/or intermediary can access any one or more of the central processing computer(s) 10, the education provider or education materials provider or education tools provider or education computer-enabled tools providers communication devices (20), the payer communication devices 30, the student communication devices 40, and/or the intermediate communication devices 50, via any one or more of the said computers and/or communication devices 10, 20, 30, 40, and/or 50, as well as via any computer and/or communication device. In this manner, any of the herein-described parties can access the present invention from any computer and/or communication device. Public kiosks with links to any of the computers and/or communication devices 10, 20, 30, 40, and/or 50, can also be utilized to access and utilize the present invention and/or any of the computers and/or communication devices described herein.

In any and/or all of the embodiments described herein, access to any and/or all of the data, information, records, files, etc., which is stored in any of the databases 10H, 20H, 30H, 40H, and/or 50H, can be restricted to preserve the security and confidentiality of same. Any of the students, users, education provider or education materials provider or education tools provider or education computer-enabled tools providers, payers, and/or intermediaries, can be provided with identification and/or other cards with any and/or all pertinent data regarding the respective individual and/or party provided on the card.

The identification card, in the preferred embodiment can contain a magnetic strip for storing any and/or all pertinent information, a “smart card” for storing information, and/or a bar code or bar codes for storing identification information as well as any other information described herein as being pertinent to the respective student, user, education provider or education materials provider or education tools provider or education computer-enabled tools provider, payer, and/or intermediary.

Each of the central processing computer(s) 10, the education provider or education materials provider or education tools provider or education computer-enabled tools providers communication devices 20, the payer communication devices 30, the student communication devices 40, and/or the intermediate communication devices 50, as well as any other computer and/or communication device, can include suitable devices for reading, scanning, and/or obtaining information which may be stored on the identification card. In this manner, access to the present invention and the respective use thereof, can be facilitated by the above-described identification card(s).

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective students, users, education provider or education materials provider or education tools provider or education computer-enabled tools providers, payers, and/or intermediaries, so as to act on behalf of the respective party as well as to perform any of processing functions and/or other functions described herein.

The intelligent agent can act on behalf of the respective party in various related interactions and/or other activities which are described as being performed herein and/or which may be incidental and/or related thereto. Therefore, the present invention also provides an agent-based apparatus and method for providing education information and/or education related information.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, and/or any of the communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

The data and/or information, described as being stored in the database 10H and/or in any of the other databases described herein, can be continuously updated so as to store the latest values for the data and/or information and can be stored and be made available for future processing routines.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers and/or communication devices 10, 20, 30, 40, and/or 50, and/or external computers or communication devices, described herein, in real-time, and/or via dynamically linked database management techniques. The above-described updates can also be provided from other information sources via the communication network.

The data and/or information which is stored in the database 10H and/or which may be otherwise utilized with, and/or in conjunction with, the apparatus and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

The present invention provides an apparatus and a method for providing comprehensive information in the education fields and/or education related fields. The present invention also provides valuable services to the various parties who seek, provide, pay for, administer, and/or monitor education services, goods and/or products as well as education related services, goods, and/or products.

The present invention can provide comprehensive and accurate information to any of the parties described herein so as to facilitate an improved education system which can provide up-to-date student, education provider or education materials provider or education tools provider or education computer-enabled tools provider, payer, and/or intermediary, information. The present invention, by facilitating the creation and maintenance of a comprehensive database of information, which can be accessed on a global basis, at any time of day or night, and from any location, can provide students, education provider or education materials provider or education tools provider or education computer-enabled tools providers, payers, and/or intermediaries, with information which can improve education academic lessons, reduce the likelihood of errors in assessments and/or recommended academic lessons, reduce education costs, reduce the likelihood of incorrect and/or fraudulent service or resource, and can provide for an education system which is characterized by an improved quality of service or resource and cost efficiency.

In addition to any and/or all of the preferred embodiments described herein, the present invention can also be utilized in other preferred embodiments so as to incorporate, so as to improve upon, and/or so as to utilize, various teachings of the prior art.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus, comprising: a processor, wherein the processor processes a request to one of, or more than one of, access, obtain, change, alter, and modify, information contained in a student's education record or a student's education file of a student, wherein the processor determines whether an individual or entity is authorized to one of, or more than one of, access, obtain, change, alter, and modify, the information contained in a student's education record or a student's education file, and further wherein the processor generates a notification report containing at least one of information regarding the individual or entity making the request, identification information regarding the individual or entity, and a time and date of the request, and further wherein the notification report contains an actual change, alteration, or modification, sought to be made or made to the information contained in a student's education record or a student's education file; and a transmitter, wherein the transmitter transmits the notification report to a student communication device of the student via, on, or over, a communication network, and further wherein the notification report is transmitted to the student communication device at least one of during, concurrently with, at a same time as, and prior to a completion of, at least one of an accessing, an obtaining, a changing, an altering, and a modifying, of the information contained in a student's education record or a student's education file by the individual or entity, or at least one of during, concurrently with, at a same time as, and prior to a completion of, a processing of the request.

2. A computer-implemented method, comprising: processing, with a processor, a request by a person or an entity to one of, or more than one of, access, obtain, change, alter, and modify, information contained in an individual's or student's education record or an individual's or student's education file of the individual or student or educator or administrator wherein the individual's or student's education record or the individual's or student's education file of the individual or student or educator or administrator contains education information or education related information personal to the individual or student or educator or administrator; generating a message containing at least one of information regarding the person or the entity making the request and identification information regarding the person or the entity making the request, and further wherein the message contains an actual change, alteration, or modification, sought to be made or made to the information contained in an individual's or student's education record or an individual's or student's education file; and transmitting the message to a communication device of the individual or student or educator or administrator via, on, or over, a communication network, wherein the message is transmitted to the communication device of the individual or student or educator or administrator at least one of during, concurrently with, at a same time as, and prior to a completion of, at least one of an accessing, an obtaining, a changing, an altering, and a modifying, of the information contained in an individual's or student's education record or an individual's or student's education file by the person or the entity, or at least one of during, concurrently with, at a same time as, and prior to a completion of, a processing of the request to one of, or more than one of, access, obtain, change, alter, and modify, the information contained in an individual's or student's education record or an individual's or student's education file.

3. The computer-implemented method of claim 2, further comprising: receiving a response to the message, wherein the response to the message is transmitted from the communication device of the individual or student or educator or administrator, and further wherein the response to the message contains information for terminating or denying at least one of an accessing, an obtaining, a changing, an altering, and a modifying, of the information contained in an individual's or student's education record or an individual's or student's education file; and terminating or denying the request to one of, or more than one of, access, obtain, change, alter, and modify, the information contained in an individual's or student's education record or an individual's or student's education file.

4. The computer-implemented method of claim 2, further comprising: receiving information regarding an examination finding or an assignment or an administrative task associated with an examination or assignment, wherein the information regarding an examination finding or an assignment or an administrative task associated with an examination or assignment is transmitted from a computer or communication device associated with an education provider or education materials provider or education tools provider or education computer-enabled tools provider of the individual or student or educator or administrator; at least one of storing and processing the information regarding an examination finding or an assignment or an administrative task associated with an examination or assignment; and updating the information contained in an individual's or student's education record or an individual's or student's education file to include the information regarding an examination finding or an assignment or an administrative task associated with an examination or assignment.

5. The computer-implemented method of claim 4, wherein the information regarding an examination finding or an assignment or an administrative task associated with an examination or assignment contains information obtained with or by at least one of a performance monitor or measurement device, an aptitude assessment, an assignment monitor or measurement device, an examination analysis device or machine, a behavior monitoring or measurement device, a fitness and/or education monitoring machine, a proctoring machine or device, an intelligence measurement machine or device, an grading machine or device, a speech recognition machine or device, a physical monitoring machine or device, a tracking machine or device, a financial assessment device, an application device, a location monitor or measurement device, a progress monitoring or measurement device, a camera device, a video device, an audio device.

6. The computer-implemented method of claim 4, further comprising: performing a analytical evaluation of the individual or student or educator or administrator using the information regarding an examination finding or an assignment or an administrative task associated with an examination or assignment; generating a second message in response to the analytical evaluation, wherein the second message contains an analysis or a list of possible assessments; transmitting the second message to the computer or communication device associated with an education provider or education materials provider or education tools provider or education computer-enabled tools provider of the individual or student or educator or administrator or to a second computer or second communication device associated with the education provider or education materials provider or education tools provider or education computer-enabled tools provider of the individual or student or educator or administrator; and updating the information contained in an individual's or student's education record or an individual's or student's education file to include information contained in the second message.

7. The computer-implemented method of claim 6, further comprising: generating a third message in response to the analytical evaluation, wherein the third message contains information regarding an academic lesson or an education plan corresponding to the analysis or the list of possible assessments; transmitting the third message to the computer or communication device associated with an education provider or education materials provider or education tools provider or education computer-enabled tools provider of the individual or student or educator or administrator or to a second computer or second communication device associated with the education provider or education materials provider or education tools provider or education computer-enabled tools provider of the individual or student or educator or administrator; and updating the information contained in an individual's or student's education record or an individual's or student's education file to include information contained in the third message.

8. The computer-implemented method of claim 2, further comprising: receiving information regarding an academic lesson to be administered to the individual or student or educator or administrator or an instruction to be performed for the individual or student or educator or administrator, wherein the information regarding an academic lesson to be administered to the individual or student or educator or administrator or an instruction to be performed for the individual or student or educator or administrator is transmitted from a computer or communication device located at least one of at an education facility, at a location of an academic lesson, and at a location of an instruction; processing the information regarding an academic lesson to be administered to the individual or student or educator or administrator or an instruction to be performed for the individual or student or educator or administrator using the information contained in an individual's or student's education record or an individual's or student's education file; determining whether or not the academic lesson to be administered to the individual or student or educator or administrator or the instruction to be performed for the individual or student or educator or administrator is correct; generating a second message containing information regarding whether or not the academic lesson to be administered to the individual or student or educator or administrator or the instruction to be performed for the individual or student or educator or administrator is correct, and, if the academic lesson to be administered to the individual or student or educator or administrator or the instruction to be performed for the individual or student or educator or administrator is determined to be not correct, the second message contains information regarding a correct academic lesson or a correct instruction; and transmitting the second message to the computer or communication device located at least one of at an education facility, at a location of an academic lesson, and at a location of an instruction.

9. The computer-implemented method of claim 2, further comprising: determining whether an analysis is appropriate or valid or determining whether an academic lesson or academic lesson plan corresponding to an analysis is appropriate or valid; generating a second message containing information regarding whether an analysis is appropriate or valid or whether an academic lesson or academic lesson plan corresponding to an analysis is appropriate or valid; and transmitting the second message to a computer or communication device associated with an education financially responsible party and/or education financing guarantor and/or education financing government entity and/or education financing non-government entity or financial record keeping party or an education payer of the individual or student or educator or administrator.

10. The computer-implemented method of claim 2, wherein the communication device of the individual or student or educator or administrator is a wireless device, and further wherein the message is transmitted to the communication device of the individual or student or educator or administrator via, on, or over, at least one of the Internet, the World Wide Web, and a wireless communication network.

11. The computer-implemented method of claim 2, further comprising: transmitting the message to a computer or communication device associated with an education provider or education materials provider or education tools provider or education computer-enabled tools provider of the individual or student or educator or administrator.

12. The computer-implemented method of claim 2, further comprising: transmitting the message to a computer or communication device associated with an education financially responsible party and/or education financing guarantor and/or education financing government entity and/or education financing non-government entity or financial record keeping party or an education payer of the individual or student or educator or administrator.

13. The computer-implemented method of claim 2, further comprising: generating a second message containing information regarding an occurrence of an admitting of the individual or student or educator or administrator to an educational institution or an education facility or containing information regarding an analysis regarding the individual or student or educator or administrator; and transmitting the second message to a computer or communication device associated with an education provider or education materials provider or education tools provider or education computer-enabled tools provider of the individual or student or educator or administrator.

14. The computer-implemented method of claim 2, further comprising: generating a second message containing information regarding an occurrence of an admitting of the individual or student or educator or administrator to an educational institution or an education facility or containing information regarding an analysis regarding the individual or student or educator or administrator; and transmitting the second message to a computer or communication device associated with an education financially responsible party and/or education financing guarantor and/or education financing government entity and/or education financing non-government entity or financial record keeping party or an education payer of the individual or student or educator or administrator.

15. The computer-implemented method of claim 2, further comprising: generating a second message containing information regarding a financial obligation payment request for submission to an education financially responsible party and/or education financing guarantor and/or education financing government entity and/or education financing non-government entity or financial record keeping party or an education payer of the individual or student or educator or administrator, wherein the second message is automatically generated in response to an updating of the information contained in an individual's or student's education record or an individual's or student's education file; and transmitting the second message to a computer or communication device associated with an education financially responsible party and/or education financing guarantor and/or education financing government entity and/or education financing non-government entity or financial record keeping party or an education payer of the individual or student or educator or administrator.

16. The computer-implemented method of claim 2, wherein the message contains at least one of information regarding the person or the entity making the request, a time and date of the request, a reason for the request, and at least one of information regarding a nature of a change, alteration, or modification, sought to be made or made to the information contained in an individual's or student's education record or an individual's or student's education file and information regarding a subject of a change, alteration, or modification, sought to be made or made to the information contained in an individual's or student's education record or an individual's or student's education file.

17. The computer-implemented method of claim 2, further comprising: receiving and storing information for updating the information contained in an individual's or student's education record or an individual's or student's education file, wherein the information for updating the information contained in an individual's or student's education record or an individual's or student's education file is transmitted from the communication device of the individual or student or educator or administrator or transmitted from a second communication device of or used by the individual or student or educator or administrator.

18. The computer-implemented method of claim 2, further comprising: receiving and storing information for updating the information contained in an individual's or student's education record or an individual's or student's education file, wherein the information for updating the information contained in an individual's or student's education record or an individual's or student's education file is transmitted from a communication device or computer associated with an education provider or education materials provider or education tools provider or education computer-enabled tools provider of the individual or student or educator or administrator; and updating the information contained in an individual's or student's education record or an individual's or student's education file.

19. The computer-implemented method of claim 2, further comprising: generating an activity report containing information regarding at least one of an accessing, an obtaining, a changing, an altering, and a modifying, of the information contained in an individual's or student's education record or an individual's or student's education file, during a time period, wherein the activity report is generated automatically or in response to a request to receive an activity report; and transmitting the activity report to one of, or more than one of, the communication device of the individual or student or educator or administrator, a computer or second communication device associated with the individual or student or educator or administrator, a computer or communication device associated with an education provider or education materials provider or education tools provider or education computer-enabled tools provider of the individual or student or educator or administrator, and a computer or communication device associated with an education financially responsible party and/or education financing guarantor and/or education financing government entity and/or education financing non-government entity or financial record keeping party or an education payer of the individual or student or educator or administrator.

20. A computer-implemented method, comprising: receiving information regarding a restriction or limitation regarding an ability of a person or an entity to one of, or more than one of, access, obtain, change, alter, and modify, information contained in an individual's or student's education record or an individual's or student's education file, wherein the individual's or student's education record or the individual's or student's education file contains education information or education related information personal to the individual or student or educator or administrator, wherein the restriction or limitation contains information regarding at least one of an education provider or education materials provider or education tools provider or education computer-enabled tools provider, an education payer, an education financially responsible party and/or education financing guarantor and/or education financing government entity and/or education financing non-government entity or financial record keeping party, and an authorized entity, and information regarding a designated purpose for allowing each of the at least one of an education provider or education materials provider or education tools provider or education computer-enabled tools provider, an education payer, an education financially responsible party and/or education financing guarantor and/or education financing government entity and/or education financing non-government entity or financial record keeping party, and an authorized entity, to one of, or more than one of, access, obtain, change, alter, and modify, the information contained in an individual's or student's education record or an individual's or student's education file, wherein the designated purpose is at least one of to perform an analysis, to perform an analysis for a certain need, requirement, or evaluation, to provide an independent assessment, to verify or disprove a previous assessment or examination result, to submit a financial obligation payment request, and to process a financial obligation payment request; storing the information regarding a restriction or limitation regarding an ability of a person or an entity to one of, or more than one of, access, obtain, change, alter, and modify, the information contained in an individual's or student's education record or an individual's or student's education file; processing, with a processor, a request by a person or an entity to one of, or more than one of, access, obtain, change, alter, and modify, the information contained in an individual's or student's education record or an individual's or student's education file; determining, using the information regarding the restriction or limitation, whether the person or the entity is allowed or authorized to one of, or more than one of, access, obtain, change, alter, and modify, the information contained in an individual's or student's education record or an individual's or student's education file; generating a message containing at least one of information regarding the person or the entity making the request, and identification information regarding the person or the entity making the request, and further wherein the message contains an actual change, alteration, or modification, made to the information contained in an individual's or student's education record or an individual's or student's education file; and transmitting the message to a communication device of the individual or student or educator or administrator via, on, or over, a communication network, wherein the message is transmitted to the communication device of the individual or student or educator or administrator at least one of during, concurrently with, at a same time as, and prior to a completion of, an at least one of an accessing, an obtaining, a changing, an altering, and a modifying, of the information contained in an individual's or student's education record or an individual's or student's education file by the person or the entity, or at least one of during, concurrently with, at a same time as, and prior to a completion of, a processing of the request to one of, or more than one of, access, obtain, change, alter, and modify, the information contained in an individual's or student's education record or an individual's or student's education file.

21. The computer-implemented method of claim 2, further comprising: storing information regarding a schedule of an education provider or education materials provider or education tools provider or education computer-enabled tools provider; receiving information regarding an appointment made by the individual or student or educator or administrator with the education provider or education materials provider or education tools provider or education computer-enabled tools provider; and updating the information regarding a schedule of the education provider or education materials provider or education tools provider or education computer-enabled tools provider to include the information regarding an appointment made by the individual or student or educator or administrator with the education provider or education materials provider or education tools provider or education computer-enabled tools provider.

22. The computer-implemented method of claim 21, further comprising: transmitting a second message to the communication device of the individual or student or educator or administrator, wherein the second message contains information confirming the appointment made by the individual or student or educator or administrator with the education provider or education materials provider or education tools provider or education computer-enabled tools provider or containing information reminding the individual or student or educator or administrator of the appointment made by the individual or student or educator or administrator with the education provider or education materials provider or education tools provider or education computer-enabled tools provider.

23. The computer-implemented method of claim 2, further comprising: storing information regarding a schedule of an education provider or education materials provider or education tools provider or education computer-enabled tools provider; receiving information regarding an appointment made by a second individual or second student or second educator or second administrator or guardian with the education provider or education materials provider or education tools provider or education computer-enabled tools provider; and updating the information regarding a schedule of the education provider or education materials provider or education tools provider or education computer-enabled tools provider to include the information regarding an appointment made by the second individual or second student or second educator or second administrator or guardian with the education provider or education materials provider or education tools provider or education computer-enabled tools provider.

24. The computer-implemented method of claim 2, further comprising: receiving a request from the individual or student or educator or administrator or from a second individual or second student or second educator or second administrator or guardian to locate an education provider or education materials provider or education tools provider or education computer-enabled tools provider or an education facility for the individual or student or educator or administrator or for the second individual or second student or second educator or second administrator or guardian; identifying an education provider or education materials provider or education tools provider or education computer-enabled tools provider or an education facility in response to the request to locate an education provider or education materials provider or education tools provider or education computer-enabled tools provider or an education facility for the individual or student or educator or administrator or for the second individual or second student or second educator or second administrator or guardian; generating a second message containing information regarding an education provider or education materials provider or education tools provider or education computer-enabled tools provider or an education facility responsive to the request to locate an education provider or education materials provider or education tools provider or education computer-enabled tools provider or an education facility for the individual or student or educator or administrator or for the second individual or second student or second educator or second administrator or guardian; and transmitting the second message to the communication device of the individual or student or educator or administrator or to a second communication device of the individual or student or educator or administrator or of the second individual or second student or second educator or second administrator or guardian.

25. The computer-implemented method of claim 2, further comprising: receiving a request to locate an academic supply, academic text, educational information, educational data, educational video, educational audio, educational images, tutorial resources; generating a second message containing information regarding a located academic supply, academic text, educational information, educational data, educational video, educational audio, educational images, tutorial resources, in response to the request to locate an academic supply, academic text, educational information, educational data, educational video, educational audio, educational images, tutorial resources; and transmitting the second message to the communication device of the individual or student or educator or administrator or to a second communication device of the individual or student or educator or administrator or of a second individual or second student or second educator or second administrator or guardian.

26. The computer-implemented method of claim 2, further comprising: receiving a request to locate an education financially responsible party and/or education financing guarantor and/or education financing government entity and/or education financing non-government entity or financial record keeping party or an education payer; generating a second message containing information regarding a located education financially responsible party or financial record keeping party or education payer in response to the request to locate an education financially responsible party and/or education financing guarantor and/or education financing government entity and/or education financing non-government entity or financial record keeping party or an education payer; and transmitting the second message to the communication device of the individual or student or educator or administrator or to a second communication device of the individual or student or educator or administrator or of a second individual or second student or second educator or second administrator or guardian.

27. The computer-implemented method of claim 2, further comprising: receiving a response to the message, wherein the response to the message is transmitted from the communication device of the individual or student or educator or administrator, and further wherein the response to the message contains information for allowing the at least one of an accessing, an obtaining, a changing, an altering, and a modifying, of information contained in the individual's or student's education record or the individual's or student's education file; allowing the request to one of, or more than one of, access, obtain, change, alter, and modify, the information contained in an individual's or student's education record or an individual's or student's education file; and updating the information contained in the individual's or student's education record or the individual's or student's education file with the information regarding the individual or student or educator or administrator.

28. The computer-implemented method of claim 2, further comprising: receiving information regarding the individual or student or educator or administrator or regarding a second individual or second student or second educator or second administrator or guardian, wherein the information regarding the individual or student or educator or administrator or regarding the second individual or second student or second educator or second administrator or guardian is transmitted from a computer or communication device associated with or used by an education provider or education materials provider or education tools provider or education computer-enabled tools provider of the individual or student or educator or administrator or of the second individual or second student or second educator or second administrator or guardian, and further wherein the information regarding the individual or student or educator or administrator or regarding the second individual or second student or second educator or second administrator or guardian contains information regarding at least one of an assignment or an administrative task associated with an examination or assignment, an examination finding, an analysis, an academic lesson, an administration of an academic lesson, and an instruction; at least one of storing the information regarding the individual or student or educator or administrator or regarding the second individual or second student or second educator or second administrator or guardian and updating the individual's or student's education record or the individual's or student's education file or updating an education record or an education file of, for, or associated with, the second individual or second student or second educator or second administrator or guardian; generating a financial obligation payment request in response to the storing of the information regarding the individual or student or educator or administrator or regarding the second individual or second student or second educator or second administrator or guardian or in response to the updating of the individual's or student's education record or the individual's or student's education file or the updating of the education record or the education file of, for, or associated with, the second individual or second student or second educator or second administrator or guardian, wherein the financial payment request, financial grant request, financial credit request, financial loan request is suitable for being automatically submitted to an education financially responsible party and/or education financing guarantor and/or education financing government entity and/or education financing non-government entity or financial record keeping party or an education payer associated with the individual or student or educator or administrator or associated with the second individual or second student or second educator or second administrator or guardian or is suitable for being automatically transmitted to a computer or communication device associated with an education financially responsible party and/or education financing guarantor and/or education financing government entity and/or education financing non-government entity or financial record keeping party or an education payer associated with the individual or student or educator or administrator or associated with the second individual or second student or second educator or second administrator or guardian; and transmitting the financial payment request, financial grant request, financial credit request, financial loan request to the computer or communication device associated with the education financially responsible party or financial record keeping party or the education payer associated with the individual or student or educator or administrator or associated with the second individual or second student or second educator or second administrator or guardian.

29. The computer-implemented method of claim 28, further comprising: updating the individual's or student's education record or the individual's or student's education file, or updating an education record or an education file of, for, or associated with, the second individual or second student or second educator or second administrator or guardian, to include information regarding the transmitting of the financial payment request, financial grant request, financial credit request, financial loan request to the computer or communication device associated with the education financially responsible party or financial record keeping party or the education payer associated with the individual or student or educator or administrator or associated with the second individual or second student or second educator or second administrator or guardian.

30. The computer-implemented method of claim 2, further comprising: storing information regarding at least one of an assignment or an administrative task associated with an examination or assignment, an examination finding, an analysis, an academic lesson, an administration of an academic lesson, and an instruction, regarding the individual or student or educator or administrator or regarding a second individual or second student or second educator or second administrator or guardian; generating a second message containing at least one of information regarding an analysis, information regarding a list of possible assessments, and information regarding an academic lesson; and transmitting the second message to a computer or communication device associated with an education provider or education materials provider or education tools provider or education computer-enabled tools provider of the individual or student or educator or administrator or of a second individual or second student or second educator or second administrator or guardian, to the communication device of the individual or student or educator or administrator, or to a second communication device of the individual or student or educator or administrator or of the second individual or second student or second educator or second administrator or guardian.

31. The computer-implemented method of claim 2, further comprising: generating a second message containing information regarding a recommended academic lesson for the individual or student or educator or administrator of for a second individual or student or educator or administrator; and transmitting the second message to a computer or communication device associated with an education provider or education materials provider or education tools provider or education computer-enabled tools provider of the individual or student or educator or administrator or of the second individual or second student or second educator or second administrator or guardian.

32. The computer-implemented method of claim 2, further comprising: updating the individual's or student's education record or the individual's or student's education file with information regarding an analysis, a curriculum, syllabus, program of study, or an arranged academic lesson, or updating an education record or an education file of, for, or associated with, a second individual or second student or second educator or second administrator or guardian with information regarding an analysis, a curriculum, syllabus, program of study, or an arranged academic lesson.

33. The computer-implemented method of claim 2, further comprising: receiving information regarding an academic lesson to be administered to the individual or student or educator or administrator or to be administered to a second individual or second student or second educator or second administrator or guardian or information regarding an instruction to be performed for the individual or student or educator or administrator or an instruction to be performed for a second individual or second student or second educator or second administrator or guardian; processing the information regarding an academic lesson to be administered to the individual or student or educator or administrator or to be administered to the second individual or second student or second educator or second administrator or guardian or the information regarding an instruction to be performed for the individual or student or educator or administrator or an instruction to be performed for the second individual or second student or second educator or second administrator or guardian; generating a second message containing information regarding whether the academic lesson to be administered to the individual or student or educator or administrator or to be administered to the second individual or second student or second educator or second administrator or guardian, or whether the instruction to be performed for the individual or student or educator or administrator or the instruction to be performed for the second individual or second student or second educator or second administrator or guardian, is correct or incorrect; and transmitting the second message to a computer or communication device associated with or used by an education provider or education materials provider or education tools provider or education computer-enabled tools provider or an education facility.

34. The computer-implemented method of claim 2, further comprising: receiving a request to evaluate at least one of an analysis and an academic lesson regarding the individual or student or educator or administrator or regarding a second individual or second student or second educator or second administrator or guardian; processing the request; generating a second message in response to the request, wherein the second message contains information regarding whether or not the at least one of an analysis and an academic lesson regarding the individual or student or educator or administrator or regarding a second individual or second student or second educator or second administrator or guardian is appropriate or in-line with a current standard; and transmitting the second message to a computer or communication device associated with or used by an education financially responsible party and/or education financing guarantor and/or education financing government entity and/or education financing non-government entity or financial record keeping party or an education payer of the individual or student or educator or administrator, an education financially responsible party and/or education financing guarantor and/or education financing government entity and/or education financing non-government entity or financial record keeping party or an education payer of the second individual or second student or second educator or second administrator or guardian, the individual or student or educator or administrator, the second individual or second student or second educator or second administrator or guardian, an education provider or education materials provider or education tools provider or education computer-enabled tools provider of the individual or student or educator or administrator, or an education provider or education materials provider or education tools provider or education computer-enabled tools provider of the second individual or second student or second educator or second administrator or guardian.

35. The computer-implemented method of claim 2, further comprising: generating a second message containing information regarding an admitting of the individual or student or educator or administrator or an admitting of a second individual or second student or second educator or second administrator or guardian to an educational institution or to an education facility or containing information regarding an analysis regarding the individual or student or educator or administrator or regarding a second individual or second student or second educator or second administrator or guardian; and transmitting the second message to a computer or communication device associated with or used by an education provider or education materials provider or education tools provider or education computer-enabled tools provider, an education financially responsible party and/or education financing guarantor and/or education financing government entity and/or education financing non-government entity or financial record keeping party, or an education payer.

36. The computer-implemented method of claim 2, further comprising: generating a second message containing information that an education provider or education materials provider or education tools provider or education computer-enabled tools provider is available to perform an academic lesson or an instruction; and transmitting the second message to the communication device of the individual or student or educator or administrator or to a second communication device associated with or used by the individual or student or educator or administrator or associated with or used by a second individual or second student or second educator or second administrator or guardian.

37. The computer-implemented method of claim 2, further comprising: receiving and storing information regarding a restriction or limitation regarding an ability of the person or the entity, or regarding an ability of a second person or a second entity, to access the information contained in an individual's or student's education record or an individual's or student's education file, wherein the information regarding a restriction or limitation is transmitted from the communication device or is transmitted from a second communication device of or used by the individual or student or educator or administrator; and determining, using the information regarding a restriction or limitation, whether the person or the entity is allowed or authorized to access the information contained in an individual's or student's education record or an individual's or student's education file.

38. The computer-implemented method of claim 37, wherein the information regarding a restriction or limitation contains information regarding at least one of an education provider or education materials provider or education tools provider or education computer-enabled tools provider, an education payer, an education financially responsible party and/or education financing guarantor and/or education financing government entity and/or education financing non-government entity or financial record keeping party, and an authorized entity, and information regarding a designated purpose for allowing each of the at least one of an education provider or education materials provider or education tools provider or education computer-enabled tools provider, an education payer, an education financially responsible party and/or education financing guarantor and/or education financing government entity and/or education financing non-government entity or financial record keeping party, and an authorized entity, to access the information contained in an individual's or student's education record or an individual's or student's education file, wherein the designated purpose is at least one of to perform an analysis, to perform an analysis for a certain need, requirement, or evaluation, to provide an independent assessment, to verify or disprove a previous assessment or examination result, to submit a financial obligation payment request, and to process a financial obligation payment request.

39. The computer-implemented method of claim 37, wherein the information regarding a restriction or limitation contains information for restricting or limiting access by the person or the entity, or for restricting or limiting access by a second person or a second entity, to a portion or portions of, or to a section or sections of, the information contained in an individual's or student's education record or an individual's or student's education file.

40. The computer-implemented method of claim 2, further comprising: storing information regarding a restriction or limitation regarding an ability of the person or the entity, or regarding an ability of a second person or a second entity, to access the information contained in an individual's or student's education record or an individual's or student's education file; and determining, using the information regarding a restriction or limitation, whether the person or the entity is allowed or authorized to access the information contained in an individual's or student's education record or an individual's or student's education file.
